(19) United States
(12) Patent Application Publication
(10) Pub. No.: US 2016/0013973 A1
(43) Pub. Date: Jan. 14, 2016

(54) INFORMATION PROCESSING SYSTEM, CONTROL METHOD, AND COMPUTER-READABLE RECORDING MEDIUM

(71) Applicant: FUJITSU LIMITED, Kawasaki-shi (JP)

(72) Inventor: Koichi Onoue, Kawasaki (JP)

(21) Appl. No.: 14/724,866

(22) Filed: May 29, 2015

(30) Foreign Application Priority Data
Jul. 8, 2014 (JP) 2014-140746

(51) Int. Cl. H04L 12/24; H04L 12/931; H04L 12/713

(52) U.S. Cl. CPC H04L 41/0803; H04L 45/586; H04L 49/356; H04L 49/354

(57) ABSTRACT

An information processing system includes a control apparatus including a storage unit that stores an entry where virtual object identification information, movement source apparatus identification information, and movement destination apparatus identification information are associated with each other, and a movement information generating unit that allows the storage unit to store a target entry when it is determined, based on a predetermined evaluation value of an amount of communication between a first information processing apparatus and a second information processing apparatus among the plurality of information processing apparatuses, that a virtual object operating on a third information processing apparatus is moved to a fourth information processing apparatus, and that the virtual object operating on the fourth information processing apparatus is moved to a fifth information processing apparatus, the target entry having virtual object identification information, movement source apparatus identification information, and movement destination apparatus identification information associated with each other.

### CROSS-REFERENCE TO RELATED APPLICATION

This application is based upon and claims the benefit of priority of the prior Japanese Patent Application No. 2014-140746, filed on Jul. 8, 2014, the entire contents of which are incorporated herein by reference.

### FIELD

The embodiment discussed herein is related to a resource control technique for an information processing system, a control method, and a computer-readable recording medium.

### BACKGROUND

When a plurality of virtual machines, etc., of a plurality of tenants (customer system) are activated and operated on a plurality of physical machines in an information processing system such as a data center, if there is imbalance on the load of a network connecting physical machines, a desired throughput is not able to be obtained.

For example, an information processing system such as that illustrated in FIG. 1 is assumed. The information processing system of FIG. 1 includes three upper switches SSwitch1 to SSwitch3; three lower switches LSwitch1 to LSwitch3; physical machines AServer1 and AServer3 on which virtual routers Virtual routers 1 and 2 run; and physical machines VServer1 to VServer6 on which virtual machines VM1 to VM6 run.

In the example of FIG. 1, the VM1 communicates with the VM3 through the LSwitch1, the SSwitch1, the Virtual router1, the SSwitch1, and the LSwitch2. In addition, the VM2 communicates with the VM4 through the LSwitch1, the SSwitch1, and the LSwitch2. Furthermore, the VM5 communicates with the VM6 through the LSwitch2, the SSwitch3, the Virtual router2, the SSwitch3, and the LSwitch3.

In such a case, taking a look at the LSwitch1, while the output traffic of a link to the SSwitch1 is “5”, pieces of output traffic of links to the SSwitch2 and the SSwitch3 are “0”. Thus, the output traffic of the link to the SSwitch1 is large, which may increase latency.

Hence, in conventional art, a network controller connected to the SSwitch1 may individually change a communication path between VMs in cooperation with an upper switch and a lower switch. For example, the communication path between the VM2 and the VM4 is changed from a communication path through the LSwitch1, the SSwitch1, and the LSwitch2 to, as illustrated in FIG. 2, a communication path through the LSwitch1, the SSwitch2, and the LSwitch2. By this, the output traffic of the link from the LSwitch1 to the SSwitch2 increases to “3” and thus the output traffic of the link from the LSwitch1 to the SSwitch1 is reduced to “2”.

By thus individually changing a communication path between VMs as in conventional art, the leveling out of output traffic may become possible.

However, such a technique may not function in a case such as that illustrated below. As illustrated in FIG. 3, pieces of output traffic to a Virtual router2 and a Virtual router3 overlap on a link from an SSwitch3 to a physical machine AServer3. This output traffic overlapping may not be able to be avoided whatever change is made in a communication path between an upper switch and a lower switch.

Likewise, as illustrated in FIG. 4, since there is no alternative to a link between an LSwitch and a VServer, the output traffic of an LSwitch1 from a VM3 to a VM2 through the LSwitch1 overlaps the output traffic of the LSwitch1 from a VM4 to a VM1 through the LSwitch1, increasing latency. Even so, the overlapping may not be able to be avoided.

Patent Document 1: Japanese Laid-open Patent Publication No. 2012-94119

Patent Document 2: Japanese National Publication of International Patent Application No. 2012-511292

Patent Document 3: Japanese Laid-open Patent Publication No. 2013-179456

Patent Document 4: Japanese National Publication of International Patent Application No. 2014-506342

Patent Document 5: Japanese Laid-open Patent Publication No. 2010-117760

Patent Document 6: Japanese Laid-open Patent Publication No. 08-152903

Patent Document 7: Japanese Laid-open Patent Publication No. 2006-244479

### SUMMARY

According to an aspect of an embodiment, an information processing system includes a plurality of information processing apparatuses connected to each other through a plurality of switch apparatuses, the information processing system including a control apparatus connected to any one of the plurality of switch apparatuses, wherein the control apparatus includes a storage unit that stores an entry where virtual object identification information, movement source apparatus identification information, and movement destination apparatus identification information are associated with each other, the virtual object identification information identifying a virtual object that is a movement target and operates on any one of the plurality of information processing apparatuses, the movement source apparatus identification information identifying an information processing apparatus that is a movement source among the plurality of information processing apparatuses, and the movement destination apparatus identification information identifying an information processing apparatus that is a movement destination among the plurality of information processing apparatuses, and a movement information generating unit that allows the storage unit to store a target entry when it is determined, based on a predetermined evaluation value of an amount of communication between a first information processing apparatus and a second information processing apparatus among the plurality of information processing apparatuses, that a virtual object operating on a third information processing apparatus is moved to a fourth information processing apparatus, and that the virtual object operating on the fourth information processing apparatus is moved to a fifth information processing apparatus, the target entry having virtual object identification information, movement source apparatus identification information, and movement destination apparatus identification information associated with each other, the virtual object identification information identifying the virtual object, the movement source apparatus identification information identifying the third information processing apparatus, and the movement destination apparatus identification information identifying the fifth information processing apparatus.

### BRIEF DESCRIPTION OF DRAWINGS

FIG. 1 is diagram for describing conventional art;

FIG. 2 is diagram for describing conventional art;

FIG. 3 is diagram for describing conventional art;

FIG. 4 is diagram for describing conventional art;

FIG. 5 is a diagram illustrating an information processing system according to an embodiment;

FIG. 6 is a diagram illustrating a summary of the functions of a resource controller;

FIG. 7 is a functional block diagram of the resource controller;

FIG. 8 is a diagram illustrating an example of data stored in a collected-data storage unit;

FIG. 9 is a diagram illustrating an example of data stored in the collected-data storage unit;

FIG. 10 is a diagram illustrating a processing flow according to the embodiment;

FIG. 11 is a diagram illustrating an example of calculation of an evaluation value;

FIG. 12 is a diagram illustrating an example of calculation of an evaluation value;

FIG. 13 is a diagram illustrating an example of calculation of an evaluation value;

FIG. 14 is a diagram illustrating an example of calculation of evaluation values of Virtual objects, etc.;

FIG. 15 is a diagram illustrating an example of calculation of evaluation values of Virtual objects, etc.;

FIG. 16 is a diagram illustrating an example of calculation of evaluation values of Virtual objects, etc.;

FIG. 17 is a diagram illustrating an example of calculation of evaluation values of Virtual objects, etc.;

FIG. 18 is a diagram illustrating an example of calculation of evaluation values of Virtual objects, etc.;

FIG. 19 is a diagram illustrating an example of calculation of evaluation values of Virtual objects, etc.;

FIG. 20 is a diagram illustrating an example of calculation of evaluation values of Virtual objects, etc.;

FIG. 21 is a schematic diagram illustrating a relationship between physical links and movement targets;

FIG. 22 is a diagram illustrating a processing flow according to the embodiment;

FIG. 23 is a diagram illustrating a processing flow according to the embodiment;

FIG. 24 is a diagram illustrating a processing flow according to the embodiment;

FIG. 25 is a diagram for describing the setting of a VLAN ID;

FIG. 26 is a diagram for describing the movement of a Virtual router;

FIG. 27 is a diagram for describing the movement of a Virtual router;

FIG. 28 is a diagram for describing the movement of a Virtual router;

FIG. 29 is a diagram for describing the movement of a Virtual router;

FIG. 30 is a diagram for describing the movement of a Virtual router;

FIG. 31 is a diagram for describing the movement of a Virtual router;

FIG. 32 is a diagram for describing the movement of a VM;

FIG. 33 is a diagram for describing the movement of a VM;

FIG. 34 is a diagram for describing the movement of a VM;

FIG. 35 is a diagram for describing the movement of a VM;

FIG. 36 is a diagram for describing the movement of a VM;

FIG. 37 is a diagram for describing the movement of a VM;

FIG. 38 is a diagram for describing the movement of a VM;

FIG. 39 is a diagram for describing the movement of a VM;

FIG. 40 is a diagram for describing the movement of an L2-tree;

FIG. 41 is a diagram for describing the movement of an L2-tree;

FIG. 42 is a diagram for describing the movement of an L2-tree;

FIG. 43 is a diagram for describing the movement of an L2-tree;

FIG. 44 is a diagram for describing the movement of an L2-tree;

FIG. 45 is a diagram for describing the movement of an L2-tree;

FIG. 46 is a diagram for traffic influenced by movement;

FIG. 47 is a diagram for describing a change in flow for the case of moving a VM between VServers connected to the same LSwitch;

FIG. 48 is a diagram for describing a change in flow for the case of moving a VM between VServers connected to the same LSwitch;

FIG. 49 is a diagram for describing a change in flow for the case of moving a VM between VServers connected to the same LSwitch;

FIG. 50 is a diagram for describing a change in flow for the case of moving a VM between VServers connected to the same LSwitch;

FIG. 51 is a diagram for describing a change in flow for the case of moving a VM between VServers connected to the same LSwitch;

FIG. 52 is a diagram for describing a change in flow for the case of moving a VM between VServers connected to the same LSwitch;

FIG. 53 is a diagram for describing a change in flow for the case of moving a VM between VServers connected to the same LSwitch;

FIG. 54 is a diagram for describing a change in flow for the case of moving a VM between VServers connected to the same LSwitch;

FIG. 55 is a diagram for describing a change in flow for the case of moving a VM between VServers connected to the same LSwitch;

FIG. 56 is a diagram for describing a change in flow for the case of moving a VM between VServers connected to different LSwitches;

FIG. 57 is a diagram for describing a change in flow for the case of moving a VM between VServers connected to different LSwitches;

FIG. 58 is a diagram for describing a change in flow for the case of moving a VM between VServers connected to different LSwitches;

FIG. 59 is a diagram for describing a change in flow for the case of moving a VM between VServers connected to different LSwitches;

FIG. 60 is a diagram for describing a change in flow for the case of moving a VM between VServers connected to different LSwitches;

FIG. 61 is a diagram for describing a change in flow for the case of moving a VM between VServers connected to different LSwitches;

FIG. 62 is a diagram for describing a change in flow for the case of moving a VM between VServers connected to different LSwitches;

FIG. 63 is a diagram for describing a change in flow for the case of moving a VM between VServers connected to different LSwitches;

FIG. 64 is a diagram for describing a change in flow for the case of moving a VM between VServers connected to different LSwitches;

FIG. 65 is a diagram for describing a change in flow for the case of moving a VM between VServers connected to different LSwitches;

FIG. 66 is a diagram for describing a change in flow for the case of moving a VM between VServers connected to different LSwitches;

FIG. 67 is a diagram for describing a change in flow for the case of moving a VM between VServers connected to different LSwitches;

FIG. 68 is a diagram for describing a change in flow for the case of moving a VM between VServers connected to different LSwitches;

FIG. 69 is a diagram for describing a change in flow for the case of moving a VM between VServers connected to different LSwitches;

FIG. 70 is a diagram for describing a change in flow for the case of moving a VM between VServers connected to different LSwitches;

FIG. 71 is a diagram for describing a change in flow for the case of moving a VM between VServers connected to different LSwitches;

FIG. 72 is a diagram for describing a change in flow for the case of moving a VM between VServers connected to different LSwitches;

FIG. 73 is a diagram for describing a device for reducing the amount of computation;

FIG. 74 is a diagram for describing a device for reducing the amount of computation;

FIG. 75 is a diagram for describing a device for reducing the amount of computation;

FIG. 76 is a diagram for describing a device for reducing the amount of computation;

FIG. 77 is a functional block diagram of a computer;

FIG. 78 is a diagram for describing a first example in which a movement target list includes a plurality of identical movement targets;

FIG. 79 is a diagram for describing a first example in which a movement target list includes a plurality of identical movement targets;

FIG. 80 is a diagram for describing a first example in which a movement target list includes a plurality of identical movement targets;

FIG. 81 is a diagram for describing a second example in which a movement target list includes a plurality of identical movement targets;

FIG. 82 is a diagram for describing a second example in which a movement target list includes a plurality of identical movement targets;

FIG. 83 is a diagram for describing a second example in which a movement target list includes a plurality of identical movement targets;

FIG. 84 is a diagram illustrating a processing flow of a process of avoiding inclusion of identical movement targets in a movement target list;

FIG. 85 is a diagram illustrating a processing flow of a process of avoiding inclusion of identical movement targets in a movement target list;

FIG. 86 is a diagram illustrating the results of avoiding inclusion of identical movement targets in a movement target list in the first example;

FIG. 87 is a diagram illustrating the results of avoiding inclusion of identical movement targets in a movement target list in the second example;

FIG. 88 is a diagram illustrating a processing flow of a process of avoiding the occurrence of wasted movement upon adding a new entry to a movement target list;

FIG. 89 is a diagram illustrating a processing flow of a process of avoiding the occurrence of wasted movement upon adding a new entry to a movement target list;

FIG. 90 is a diagram illustrating movement target lists before and after update in the first example;

FIG. 91 is a diagram illustrating the results of avoiding inclusion of identical movement targets in a movement target list in the first example;

FIG. 92 is a diagram illustrating movement target lists before and after update in the second example; and

FIG. 93 is a diagram illustrating the results of avoiding inclusion of identical movement targets in a movement target list in the second example.

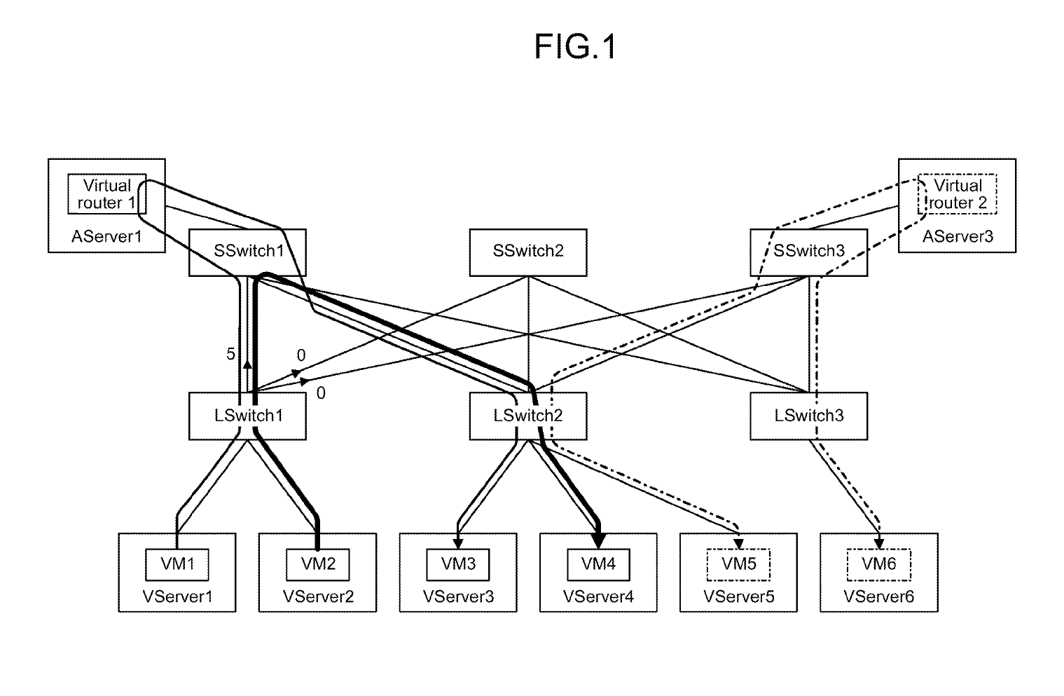

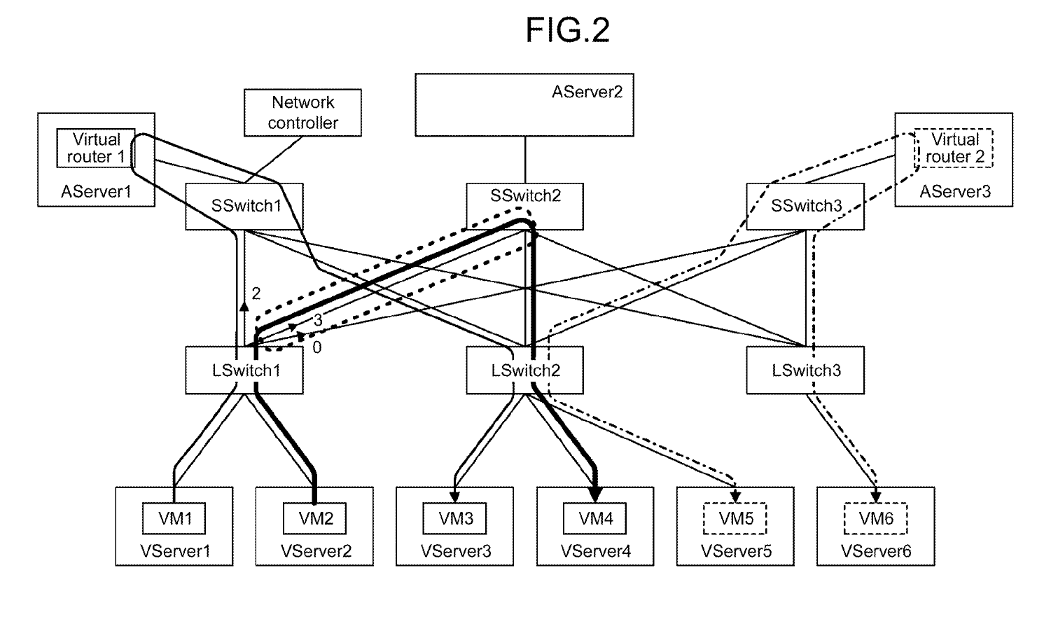

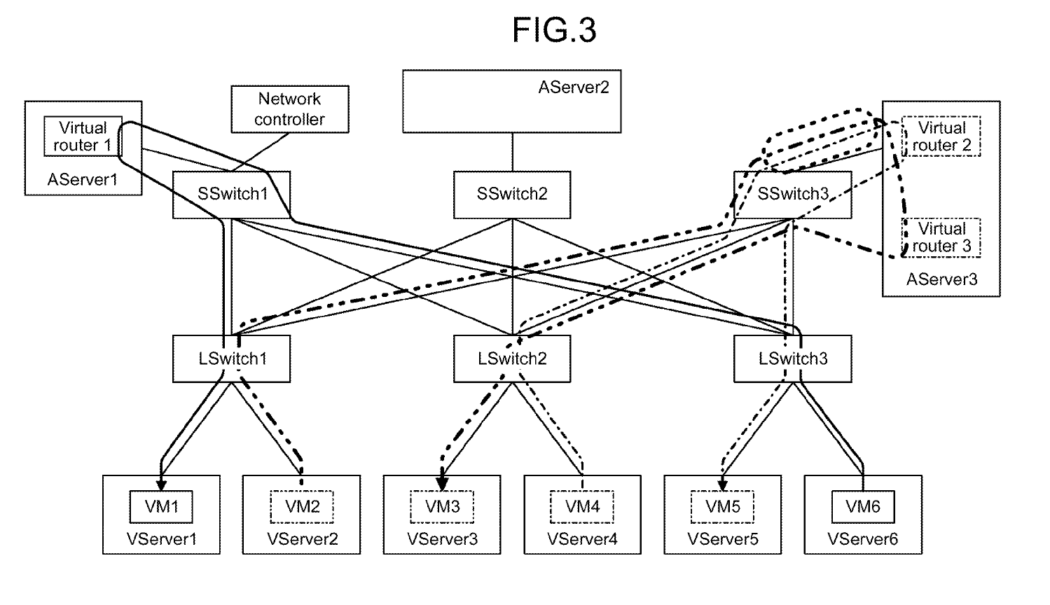

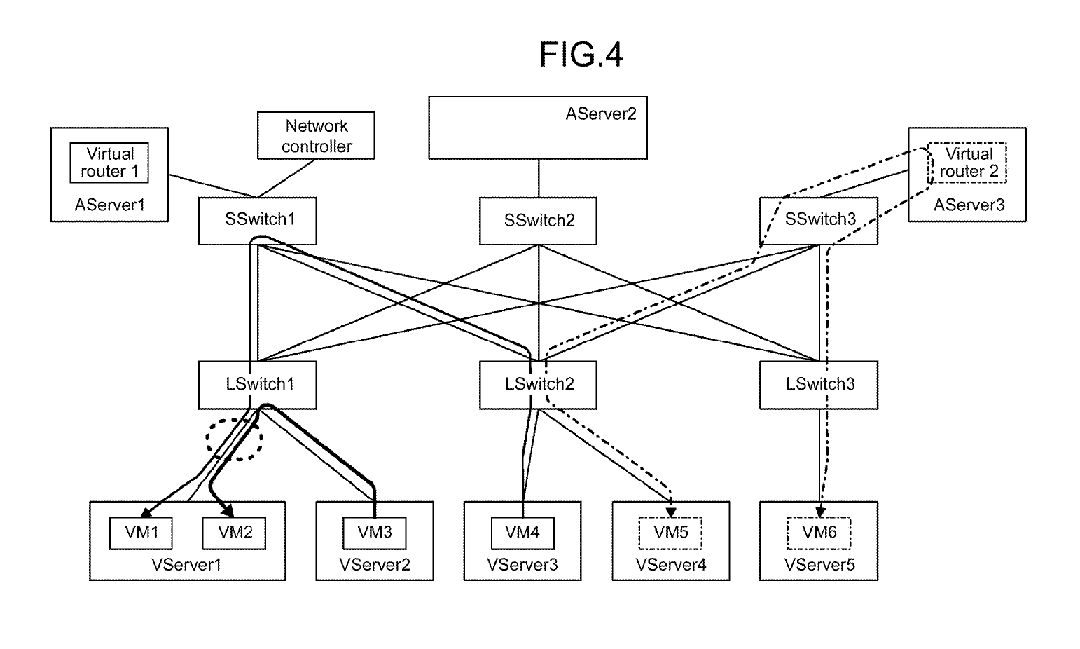

### DESCRIPTION OF EMBODIMENTS

### Comparative Example

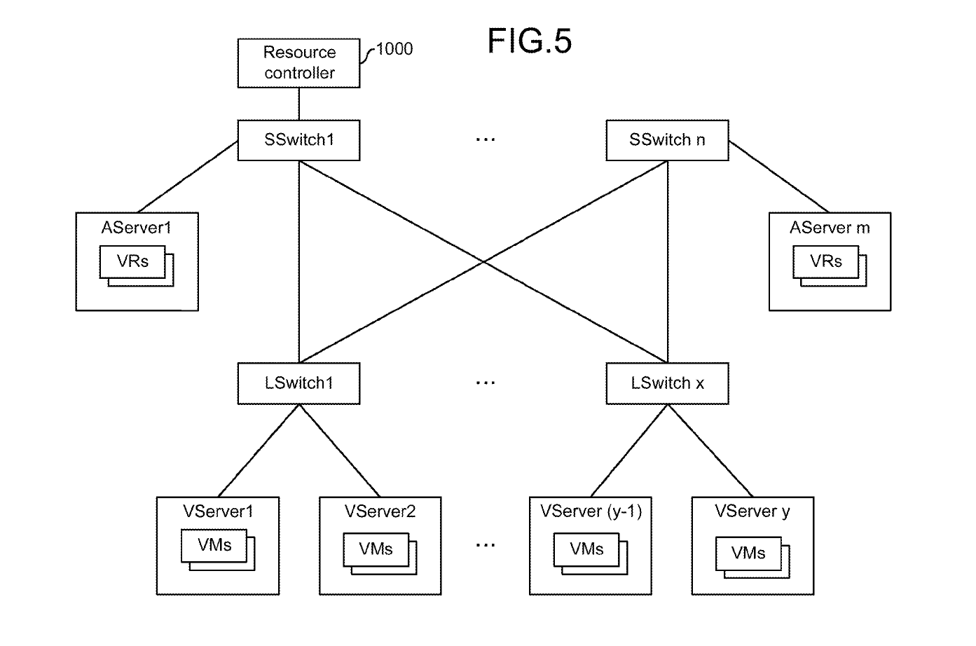

An example of a system assumed in the present embodiment is illustrated in FIG. 5. As illustrated in the example of FIG. 5, the system includes upper switches SSwitch1 to SSwitch n (also called Spine Switches); lower switches LSwitch1 to LSwitch x (also called Leaf Switches); physical machines VServer1 to VServer y that can allow virtual machines VMs to be disposed and moved; physical machines AServer1 to AServer m (also called Appliance Servers) that can allow Virtual routers (hereinafter, also referred to as VRs) to be disposed and moved; and a resource controller 1000 that performs main processes of the present embodiment.

Each physical machine VServer is connected to any one of the LSwitches. Each lower switch LSwitch is connected to any two or more of the upper switches SSwitches. Preferably, the lower switch LSwitch is connected to each SSwitch to which an AServer is connected.

Each AServer is connected to any one of the SSwitches. Note that the resource controller 1000 is also connected to any one of the SSwitches.

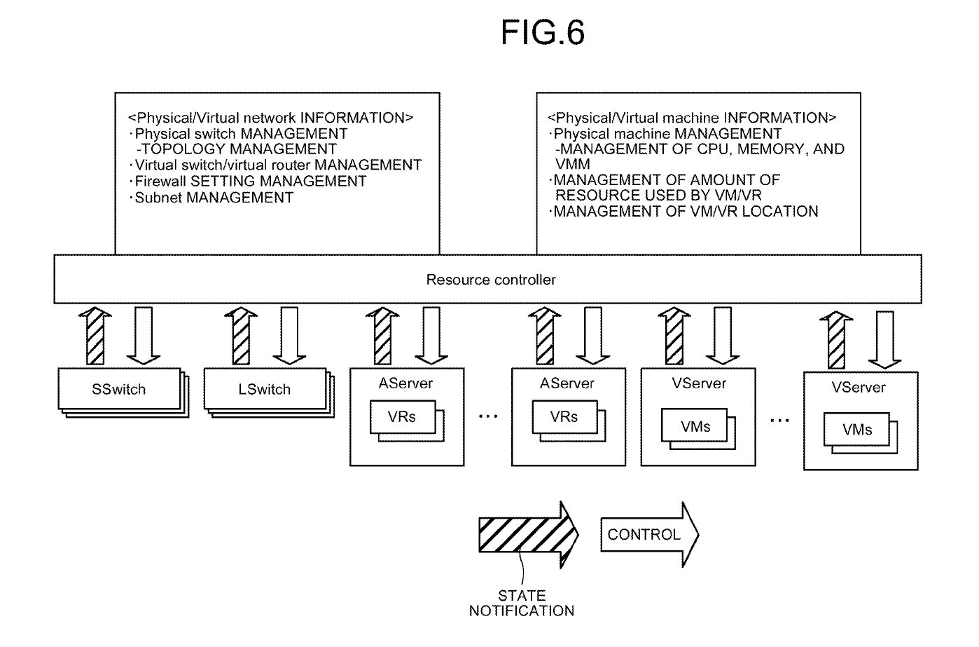

FIG. 6 illustrates a summary of the functions of the resource controller 1000. The resource controller 1000 collects various types of information from the SSwitches, the LSwitches, AServers, and the VServers and performs control on those physical machines, the VRs on the AServers, the VMs on the VServers, etc.

To perform the control, in relation to physical/virtual network information, the resource controller 1000 performs physical switch management including topology management, virtual switch and virtual router management, firewall management, subnet management, etc. In the present embodiment, a communication path within a subnet of each tenant is called an “L2-tree”.

In addition, in relation to physical/virtual machine information, the resource controller 1000 performs physical machine management, management of the amount of resource used by the virtual machines (VMs) and the virtual routers, management of VM and VR locations, etc. Note that the physical machine management includes management of a Central Processing Unit (CPU), a memory, a Virtual Machine Manager (VMM), etc. The VMs and the VRs are hereinafter collectively referred to as Virtual objects. The physical switches, the physical machines, and the switches are collectively referred to as physical machines or Physical machines (PM).

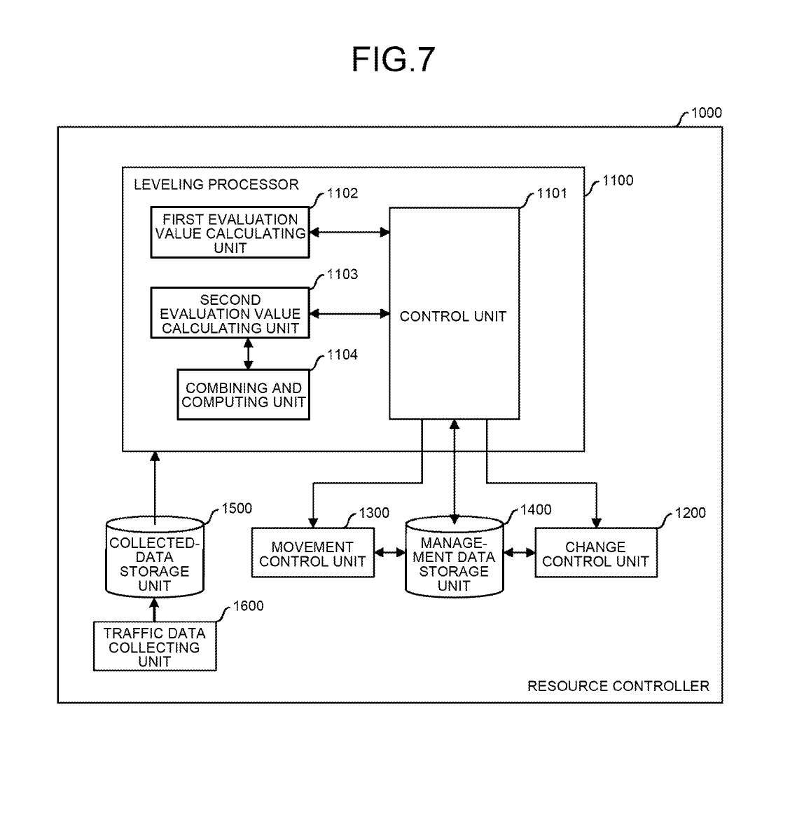

Specifically, the resource controller 1000 has a configuration such as that illustrated in FIG. 7 in relation to the present embodiment. The resource controller 1000 includes a leveling processor 1100 that performs main processes of the present embodiment; a change control unit 1200 that changes an L2-tree; a movement control unit 1300 that controls the movement of a Virtual object; a management data storage unit 1400; a collected-data storage unit 1500; and a traffic data collecting unit 1600.

The leveling processor 1100 includes a control unit 1101, a first evaluation value calculating unit 1102, a second evaluation value calculating unit 1103, and a combining and computing unit 1104. The control unit 1101 controls the processes of the first evaluation value calculating unit 1102, the second evaluation value calculating unit 1103, etc., and provides instructions to the movement control unit 1300 and the change control unit 1200.

The first evaluation value calculating unit 1102 calculates an evaluation value based on the output traffic of each physical apparatus. The combining and computing unit 1104 performs the process of combining together pieces of output traffic of a physical apparatus in a predetermined unit, focusing on the physical apparatus selected based on the evaluation values calculated by the first evaluation value calculating unit 1102. The second evaluation value calculating unit 1103 calculates evaluation values of physical apparatuses for the case of supposedly moving a movement target or a change target (a VM, a VR, or an L2-tree) that is selected using the processing results of the combining and computing unit 1104.

The management data storage unit 1400 stores physical and virtual network information and physical machine and virtual machine information. More specifically, the management data storage unit 1400 stores, as information related to the present embodiment, VM and VR disposition location data, association data between L2-trees and Virtual Local Area Network (VLAN) IDs, association data between tenant IDs and the VLAN IDs, association data between the L2-trees and AServers through which the L2-trees pass through, the IDs of VMs belonging to each subnet, and subnets that route each VR.

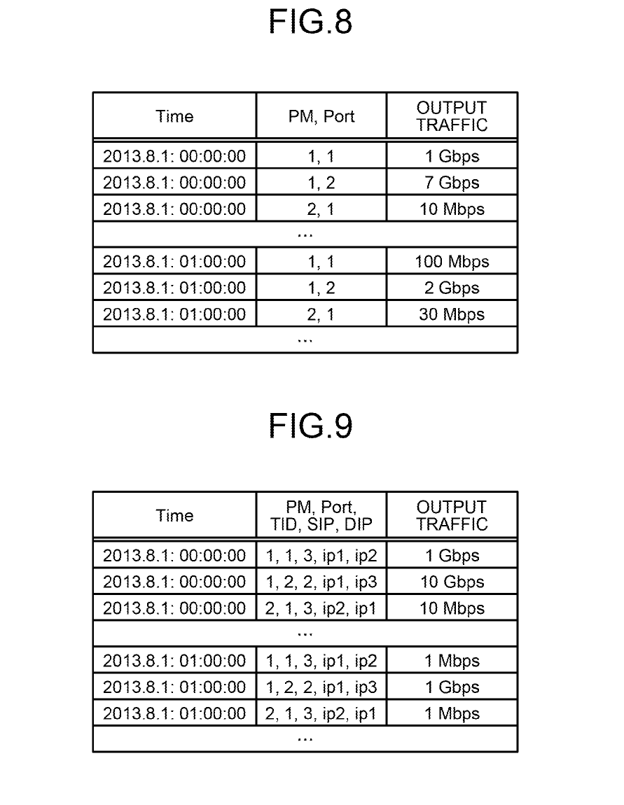

The traffic data collecting unit 1600 collects data on each traffic from each physical apparatus, and stores the data in the collected-data storage unit 1500. The collected-data storage unit 1500 stores data such as that illustrated in FIGS. 8 and 9, for example.

FIG. 8 illustrates an example of data on the traffic of each physical port. Although here an example of storing data every hour, for example, is illustrated, the intervals are any such as every day. In the example of FIG. 8, time, a combination of the ID of a PM and a port number, and output traffic are registered. For the port number, when the PM is a physical switch, the port number of a physical port of the physical switch is set. However, in the case of a VServer and an AServer, a port number is not set or a fixed port number is always set. The output traffic is a link usage rate, an average communication speed, the amount of data, the number of packets, or the like. In FIG. 8, communication speed is illustrated.

In addition, FIG. 9 illustrates data on traffic per flow. Although here an example of storing data every hour, for example, is illustrated, the intervals are any such as every day. In the example of FIG. 9, time, a combination of the ID of a PM, a port number, a tenant ID (TID), a Source IP address (SIP), and a Destination IP address (DIP), and output traffic are registered. By a combination of the ID of a PM, a port number, a tenant ID (TID), a Source IP address (SIP), and aDestination IP address (DIP), an individual flow from a source VM to a destination VM is identified.

The first evaluation value calculating unit 1102 performs a process using mainly data on the traffic of physical ports such as that illustrated in FIG. 8. The combining and computing unit 1104 performs a process using mainly traffic data for each flow such as that illustrated in FIG. 9. The second evaluation value calculating unit 1103 performs a process using data such as that illustrated in FIGS. 8 and 9.

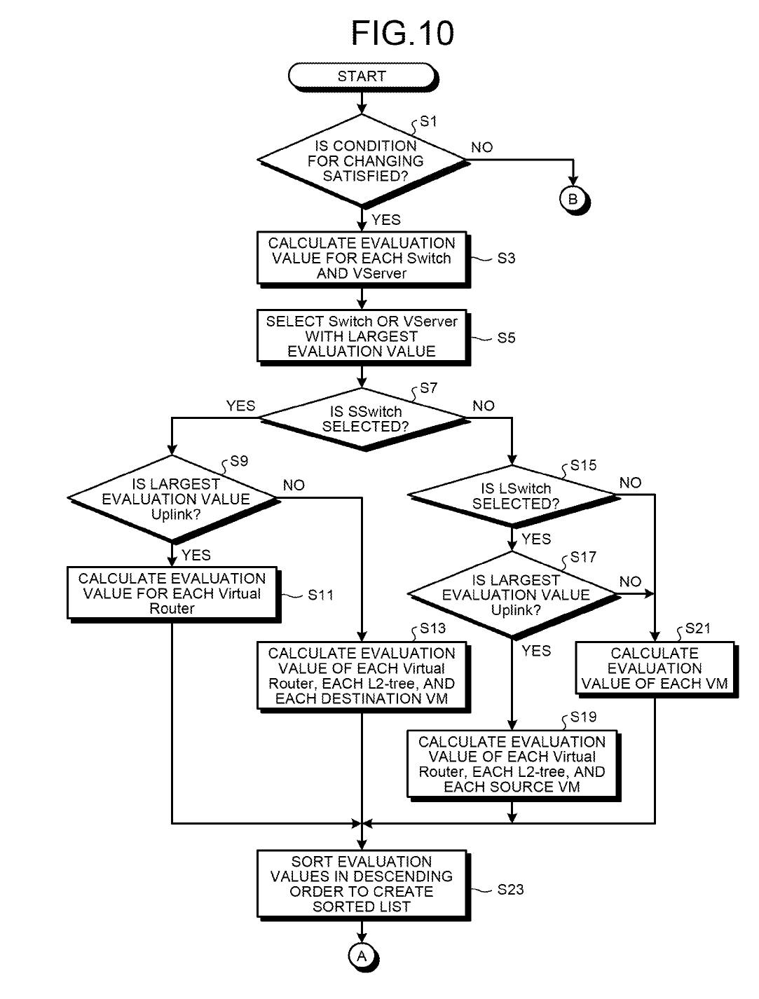

Next, a summary of the processing contents of the resource controller 1000 will be described using FIGS. 10 to 25.

First, the control unit 1101 of the leveling processor 1100 determines whether to satisfy a condition for changing a disposition destination of a VM or a VR, or an L2-tree (FIG. 10: step S1). For example, the control unit 1101 determines whether to satisfy a condition that a network is congested (e.g., output traffic greater than or equal to a threshold value is detected in any physical link) or a condition that the difference between the largest and smallest values of the evaluation values of the VServers, the SSwitches, and the LSwitches obtained by performing step S3 first which will be described in the following is greater than or equal to a threshold value.

If the condition at step S1 is not satisfied, the process ends through a terminal B. Namely, this process ends at this timing. Note that this process may be performed periodically such as every day or every hour, or may be performed in response to an instruction by an administrator, etc.

On the other hand, if the condition at step S1 is satisfied, the control unit 1101 instructs the first evaluation value calculating unit 1102 to calculate an evaluation value of each of the physical switches Switches (SSwitches and LSwitches) and the VServers, from the data stored in the collected-data storage unit 1500 (step S3). The evaluation value is the average value or largest value of the output traffic of each physical apparatus other than the AServers.

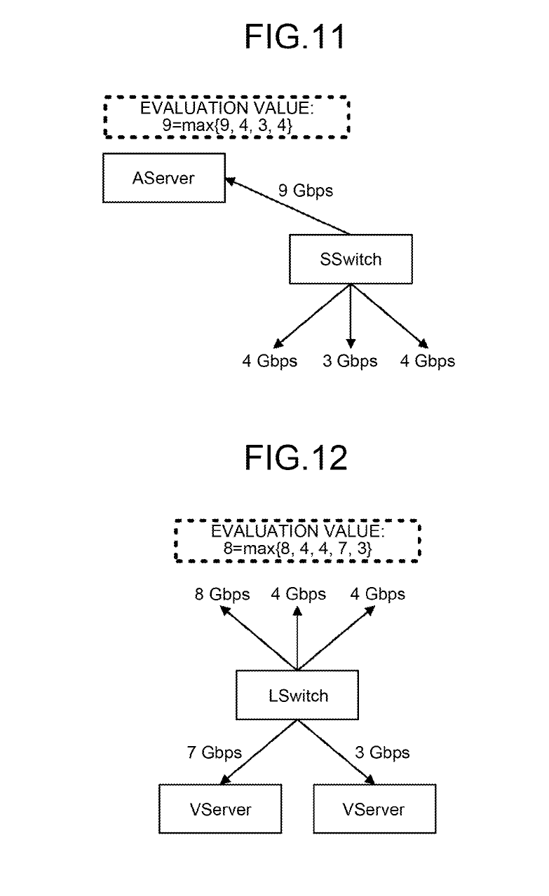

The evaluation value of an SSwitch will be described using FIG. 11. For example, it is assumed that the output traffic of an uplink to an AServer is 9 Gbps, the output traffic of a first downlink is 4 Gbps, the output traffic of a second downlink is 3 Gbps, and the output traffic of a third downlink is 4 Gbps. In this case, when the evaluation value is defined as the largest value of these pieces of output traffic, “9” is calculated.

In addition, the evaluation value of an LSwitch will be described using FIG. 12. For example, it is assumed that the output traffic of a downlink to a first VServer is 7 Gbps, the output traffic of a downlink to a second VServer is 3 Gbps, the output traffic of an uplink to a first SSwitch is 8 Gbps, the output traffic of an uplink to a second SSwitch is 4 Gbps, and the output traffic of an uplink to a third SSwitch is 4 Gbps. In this case, when the evaluation value is defined as the largest value of these pieces of output traffic, “8” is calculated.

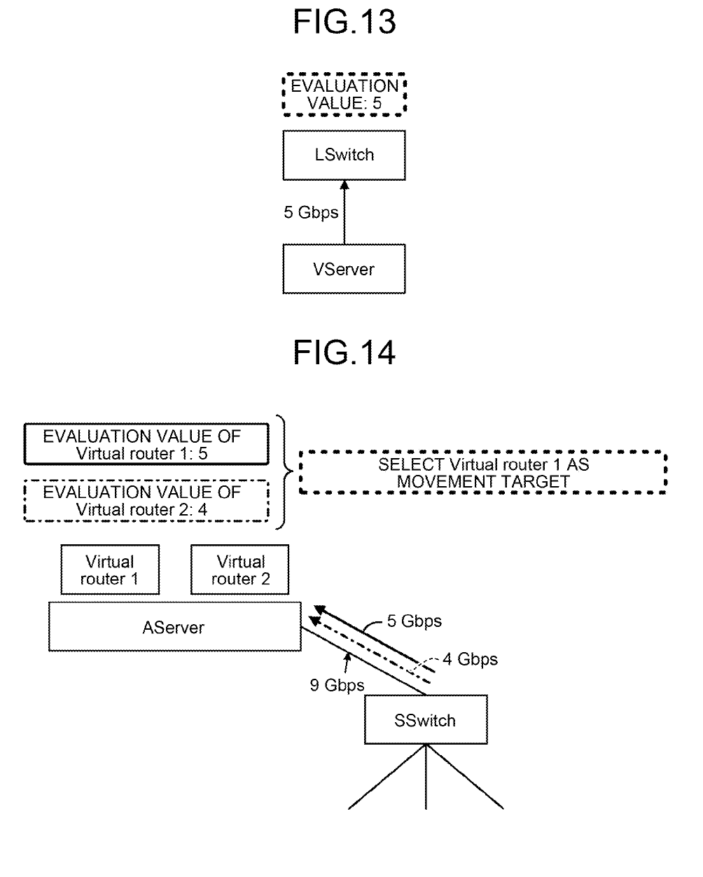

Furthermore, the evaluation value of a VServer will be described using FIG. 13. For example, it is assumed that the output traffic of an uplink to an LSwitch is 5 Gbps. In this case, when the evaluation value is defined as the largest value of these pieces of output traffic, “5” is calculated.

The first evaluation value calculating unit 1102 selects a physical apparatus (a physical apparatus other than the AServers) with the largest evaluation value (step S5). As such, a physical apparatus to be subjected to a flow combining process can be narrowed down by a simple process.

Then, if an SSwitch is selected at step S5 (step S7: Yes route), the first evaluation value calculating unit 1102 determines whether the physical port of the selected SSwitch with the largest evaluation value is an uplink port (step S9). If the condition at step S9 is satisfied, the first evaluation value calculating unit 1102 outputs the ID of the SSwitch selected at step S5 and the fact that it is an uplink, to the control unit 1101. Then, the control unit 1101 instructs the second evaluation value calculating unit 1103 to calculate evaluation values, by specifying the ID of the SSwitch selected at step S5, the ID of a Virtual router activated on an AServer connected to the SSwitch, etc.

In response to the instruction from the control unit 1101, the second evaluation value calculating unit 1103 calculates an evaluation value for each Virtual router in cooperation with the combining and computing unit 1104 (step S11). Then, processing transitions to step S23.

For example, when, as illustrated in FIG. 14, the evaluation value of an uplink (physical link) of an SSwitch is “9” and thus the SSwitch is selected at step S5, the combining and computing unit 1104 combines together pieces of output traffic from a Virtual router1 and combines together pieces of output traffic from a Virtual router2. Specifically, the combining and computing unit 1104 combines together pieces of traffic between a VM belonging to a first subnet routed by the Virtual router1 and a VM belonging to a second subnet routed by the Virtual router1, and combines together pieces of traffic between a VM belonging to a third subnet routed by the Virtual router2 and a VM belonging to a fourth subnet routed by the Virtual router2.

Accordingly, as illustrated in FIG. 14, the pieces of output traffic from the Virtual router1 are combined into 5 Gbps and the pieces of output traffic from the Virtual router2 are combined into 4 Gbps. From the combining results, the second evaluation value calculating unit 1103 then calculates the evaluation value of the Virtual router1 as “5” and the evaluation value of the Virtual router2 as “4”.

On the other hand, if the condition at step S9 is not satisfied, the first evaluation value calculating unit 1102 outputs the ID of the SSwitch selected at step S5 and the fact that it is a downlink, to the control unit 1101. Then, the control unit 1101 instructs the second evaluation value calculating unit 1103 to calculate evaluation values, by specifying the ID of the SSwitch selected at step S5, data on an L2-tree with which the SSwitch is associated, the ID (e.g., an IP address) of a Virtual router activated on an AServer connected to the SSwitch, the ID (e.g., an IP address) of each VM, etc.

In response to the instruction from the control unit 1101, the second evaluation value calculating unit 1103 calculates an evaluation value of each Virtual router, each L2-tree, and each destination VM in cooperation with the combining and computing unit 1104 (step S13). Then, processing transitions to step S23.

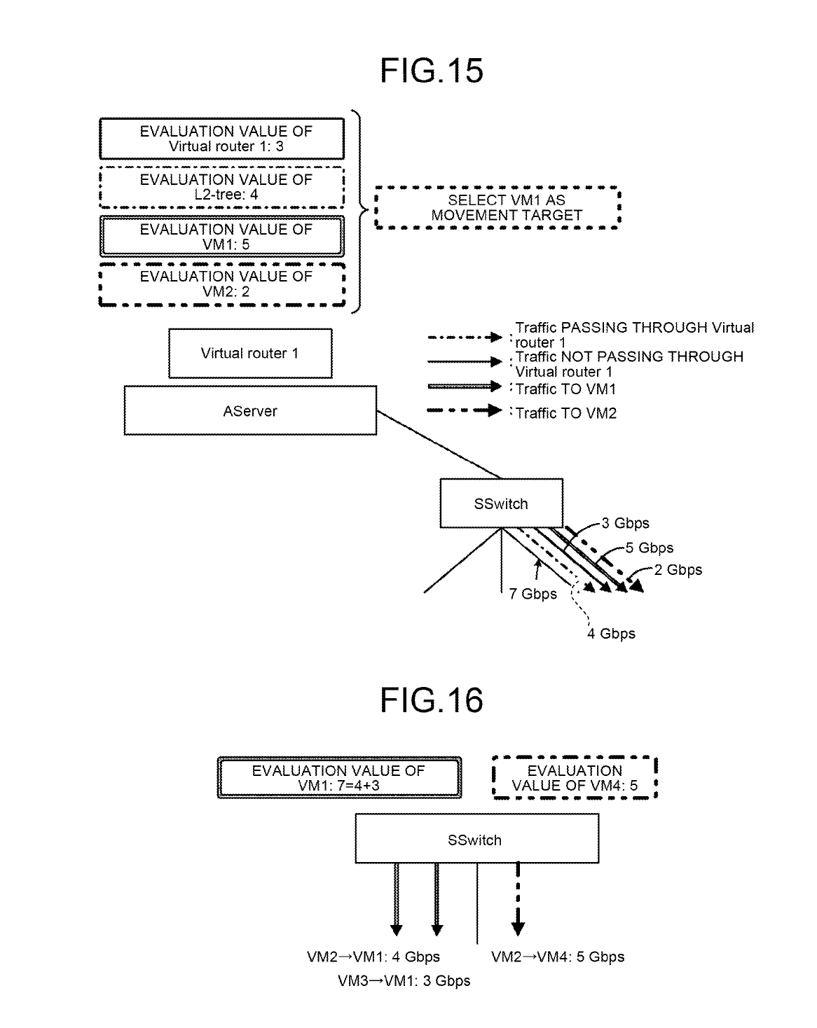

For example, as illustrated in FIG. 15, when the evaluation value of one downlink of an SSwitch is 7 Gbps and thus the SSwitch is selected at step S5, the combining and computing unit 1104 combines together pieces of output traffic to a VM1 and combines together pieces of output traffic to a VM2. In addition, as another aspect, the combining and computing unit 1104 combines together pieces of output traffic that pass through a Virtual router1 activated on an AServer connected to the SSwitch (output traffic of inter-subnet communication) and combines together pieces of output traffic that do not pass through the Virtual router1 (output traffic of intra-subnet communication).

Namely, a relationship holds where the output traffic of a physical link=output traffic passing through a Virtual router+output traffic for each L2-tree=the sum total of pieces of output traffic of a destination VM.

In the example of FIG. 15, the pieces of output traffic to the VM1 are combined into 5 Gbps and the pieces of output traffic to the VM2 are combined into 2 Gbps. In addition, the pieces of output traffic passing through the Virtual router1 are combined into 3 Gbps and the pieces of output traffic not passing through the Virtual router1 are combined into 4 Gbps. From the combining results, the combining and computing unit 1104 calculates the evaluation value of the VM1 as “5”, the evaluation value of the VM2 as “2”, the evaluation value of the Virtual router1 as “3”, and the evaluation value of an L2-tree (subnet) associated with the SSwitch as “4”. Here, it is assumed that there is one subnet.

Note that when, as illustrated in FIG. 16, an SSwitch is not connected to an AServer and thus there is no output traffic passing through a Virtual router and accordingly a downlink of the SSwitch is focused, pieces of output traffic are combined together for each destination VM. In the example of FIG. 16, the output traffic to the VM1 is the sum of output traffic from the VM2 and output traffic from the VM3. On the other hand, the output traffic to the VM4 is the same as the output traffic from the VM2. Even if a source VM is supposedly selected in a later process, the output traffic of the downlink of the SSwitch does not change, and thus, a destination VM is focused.

If the physical apparatus selected at step S5 is not an SSwitch (step S7: No route) but an LSwitch is selected (step S15: Yes route), the first evaluation value calculating unit 1102 determines whether the physical port of the selected LSwitch with the largest evaluation value is an uplink port (step S17). If the condition at step S17 is satisfied, the first evaluation value calculating unit 1102 outputs the ID of the LSwitch selected at step S5 and the fact that it is an uplink, to the control unit 1101. Then, the control unit 1101 instructs the second evaluation value calculating unit 1103 to calculate evaluation values, by specifying the ID of the LSwitch selected at step S5, the ID of each Virtual router, the ID of each VM, etc.

In response to the instruction from the control unit 1101, the second evaluation value calculating unit 1103 calculates an evaluation value of each Virtual router, each L2-tree, and each source VM in cooperation with the combining and computing unit 1104 (step S19). Then, processing transitions to step S23.

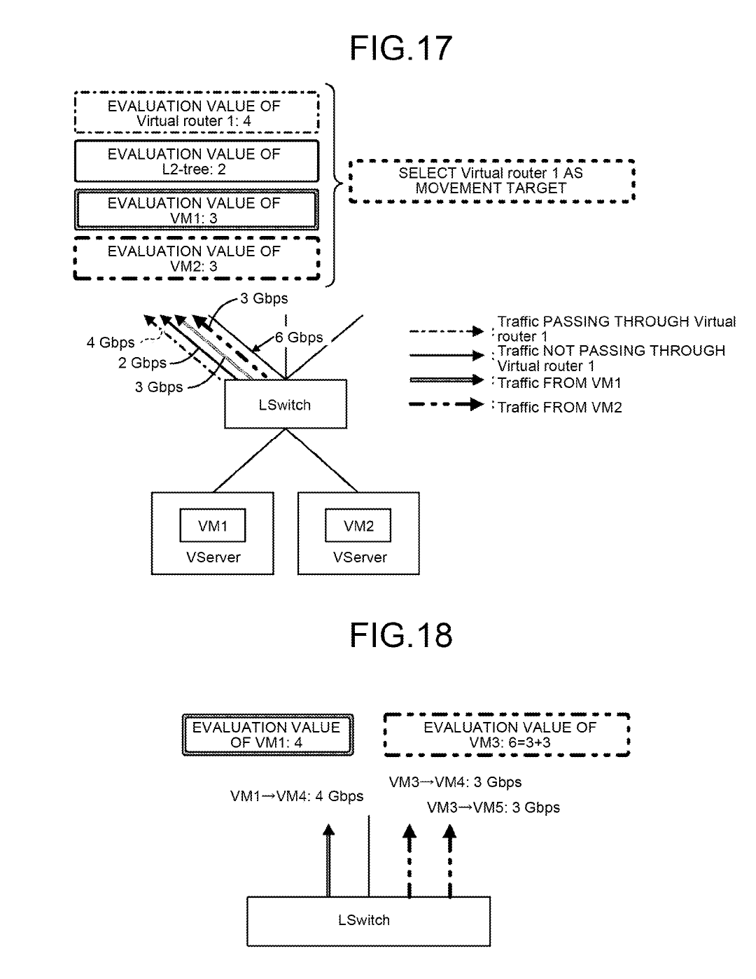

For example, when, as illustrated in FIG. 17, the evaluation value of one uplink of an LSwitch is 6 Gbps and thus the LSwitch is selected at step S5, the combining and computing unit 1104 combines together pieces of output traffic from the VM1 and combines together pieces of output traffic from the VM2. In addition, as another aspect, the combining and computing unit 1104 combines together pieces of output traffic that pass through the Virtual router1 (output traffic of inter-subnet communication) and combines together pieces of output traffic that do not pass through the Virtual router1 (output traffic of intra-subnet communication).

Here, too, a relationship holds where the output traffic of a physical link=output traffic passing through a Virtual router+output traffic for each L2-tree=the sum total of pieces of output traffic of a source VM.

In the example of FIG. 17, the pieces of output traffic from the VM1 are combined into 3 Gbps and the pieces of output traffic from the VM2 are combined into 3 Gbps. In addition, the pieces of output traffic passing through the Virtual router1 are combined into 4 Gbps and the pieces of output traffic not passing through the Virtual router1 are combined into 2 Gbps. From the combining results, the combining and computing unit 1104 calculates the evaluation value of the VM1 as “3”, the evaluation value of the VM2 as “3”, the evaluation value of the Virtual router1 as “4”, and the evaluation value of an L2-tree (subnet) associated with the LSwitch as “2”. Here, it is assumed that there is one subnet.

Note that when there is no output traffic passing through a Virtual router and thus an uplink of an LSwitch is focused, pieces of output traffic are combined together for each source VM. In the example of FIG. 18, the output traffic from the VM1 is the same as the output traffic to the VM4. On the other hand, the output traffic from the VM3 is the sum of output traffic to the VM4 and output traffic to the VM5. Even if a destination VM is selected in a later process, the output traffic of the uplink of the LSwitch does not change, and thus, a source VM is focused.

On the other hand, if the condition at step S17 is not satisfied or if a specific VServer is selected at step S5 (step S17: No route and step S15: No route), the first evaluation value calculating unit 1102 outputs the ID of the LSwitch selected at step S5 and the fact that it is a downlink, or the ID of the VServer selected at step S5, to the control unit 1101. Then, the control unit 1101 instructs the second evaluation value calculating unit 1103 to calculate evaluation values, by specifying the ID of the LSwitch selected at step S5 or the ID of the VServer selected at step S5, the ID of each VM, etc.

In response to the instruction from the control unit 1101, the second evaluation value calculating unit 1103 calculates an evaluation value of each VM in cooperation with the combining and computing unit 1104 (step S21). Then, processing transitions to step S23.

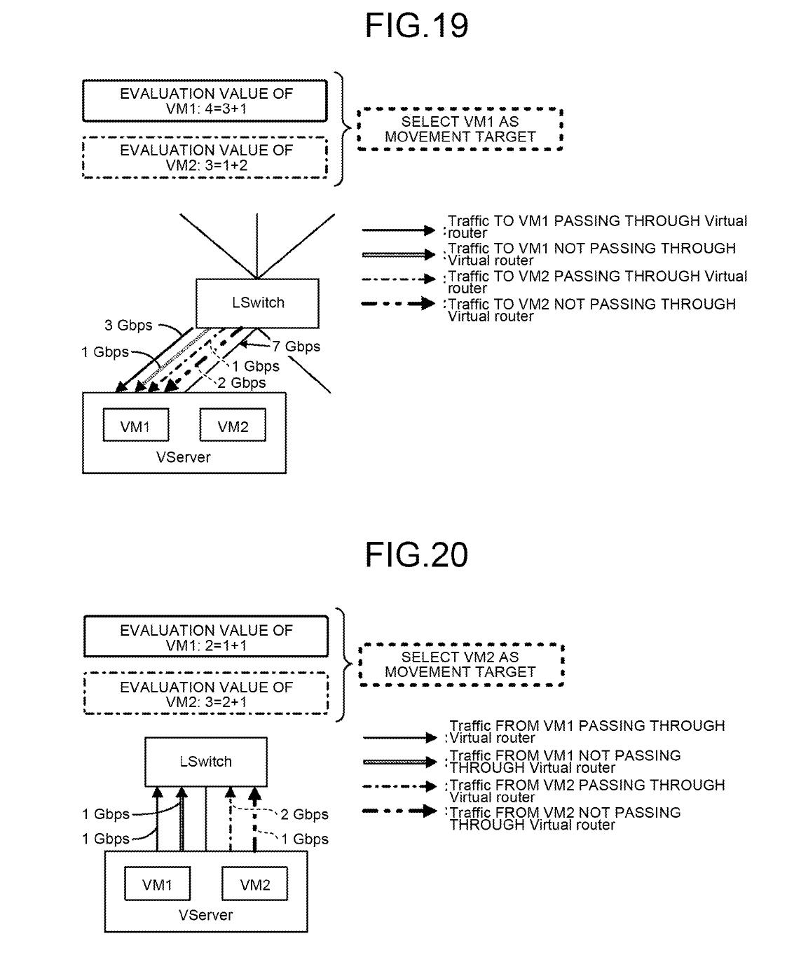

Note that when a downlink of an LSwitch is selected, pieces of output traffic are combined together for each destination VM. When, as illustrated in FIG. 19, the evaluation value of one downlink of an LSwitch is “7” and thus the LSwitch is selected at step S5, the combining and computing unit 1104 combines together pieces of output traffic to the VM1 and combines together pieces of output traffic to the VM2.

In the example of FIG. 19, an output traffic of 3 Gbps to the VM1 that passes through a Virtual router and an output traffic of 1 Gbps to the VM1 that does not pass through the Virtual router are added together, obtaining 4 Gbps. Likewise, an output traffic of 1 Gbps to the VM2 that passes through a Virtual router and an output traffic of 2 Gbps to the VM2 that does not pass through a Virtual router are added together, obtaining 3 Gbps.

Thus, from the combining results, the combining and computing unit 1104 calculates the evaluation value of the VM1 as “4” and the evaluation value of the VM2 as “3”.

In addition, when a VServer is selected, pieces of output traffic are combined together for each source VM. As illustrated in FIG. 20, when the physical link from a VServer is 5 Gbps and thus the VServer is selected at step S5, the combining and computing unit 1104 combines together pieces of output traffic from the VM1 and combines together pieces of output traffic from the VM2.

In the example of FIG. 20, an output traffic of 1 Gbps from the VM1 that passes through a Virtual router and an output traffic of 1 Gbps from the VM1 that does not pass through a Virtual router are added together, obtaining 2 Gbps. Likewise, an output traffic of 2 Gbps from the VM2 that passes through a Virtual router and an output traffic of 1 Gbps from the VM2 that does not pass through a Virtual router are added together, obtaining 3 Gbps.

Thus, from the combining results, the combining and computing unit 1104 calculates the evaluation value of the VM1 as “2” and the evaluation value of the VM2 as “3”.

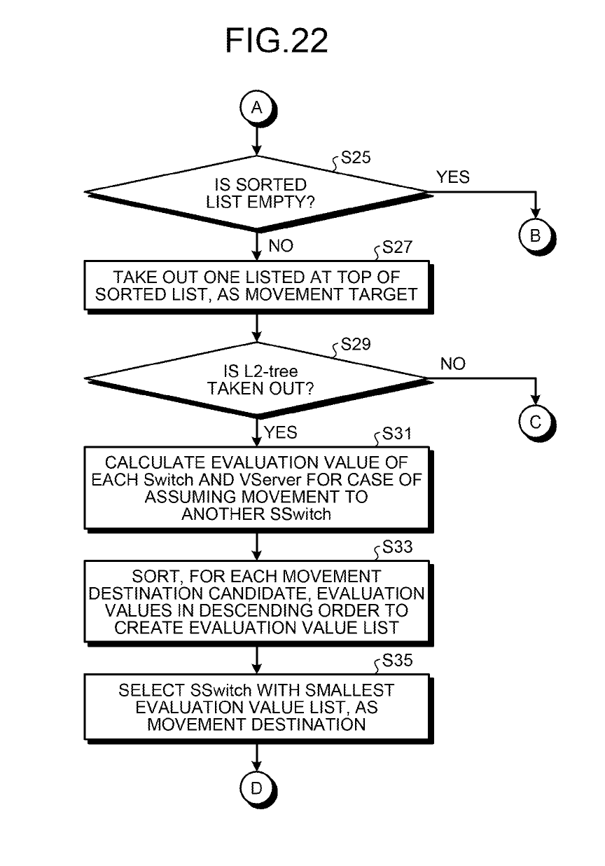

Thereafter, the second evaluation value calculating unit 1103 sorts the movement candidates (VMs, VRs, and L2-trees) whose evaluation values are calculated, in descending order of the evaluation values to create a sorted list, and outputs the sorted list to the control unit 1101 (step S23). Processing transitions to a process of FIG. 22 through a terminal A.

In the example of FIG. 14, a sorted list with the Virtual router1 listed at the top is created. In the example of FIG. 15, a sorted list in the order of VM1, L2-tree, VR1, and VM2 is created. In the example of FIG. 17, a sorted list in the order of VR1, VM1, VM2, and L2-tree is created. In the example of FIG. 19, a sorted list with VM1 listed at the top is created. In the example of FIG. 20, a sorted list with VM2 listed at the top is created.

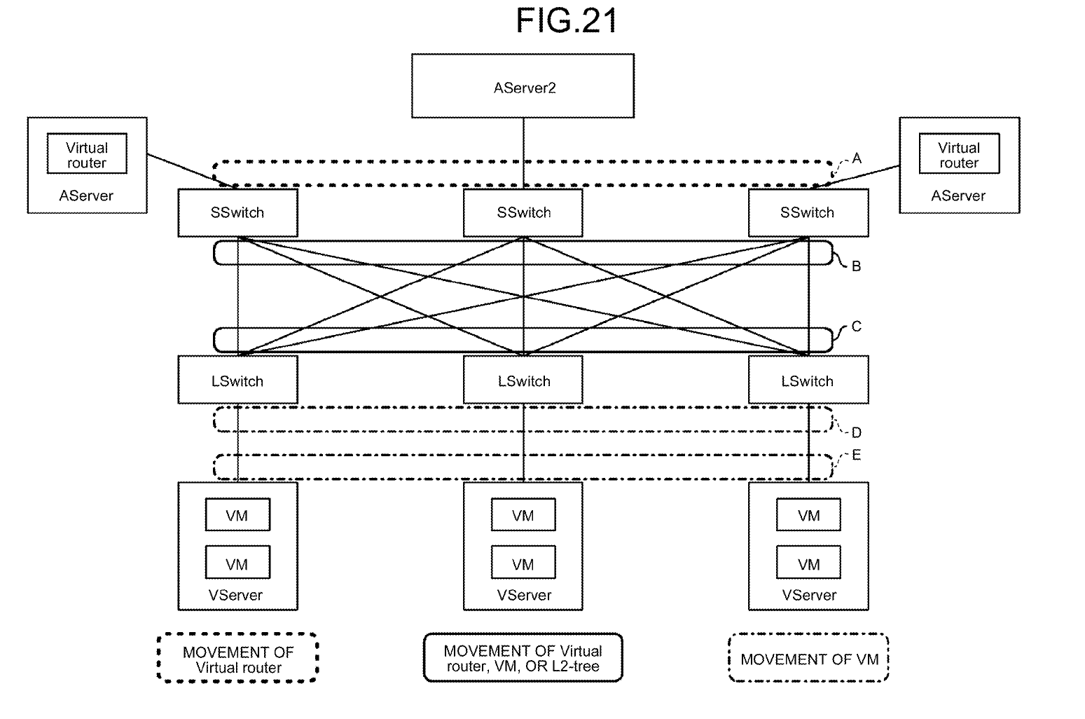

The above-described matters are summarized as illustrated in FIG. 21. Specifically, when an uplink of an SSwitch (A in FIG. 21) is selected, a Virtual router is a movement target. In addition, when a downlink of an SSwitch (B in FIG. 21) or an uplink of an LSwitch (C in FIG. 21) is selected, a Virtual router, a VM, or an L2-tree is a movement target. Furthermore, when a downlink of an LSwitch (D in FIG. 21) or a link of a VServer (E in FIG. 21) is selected, a VM is a movement target.

Moving to the description of the process of FIG. 22, the control unit 1101 determines whether the sorted list is empty (step S25). Since a movement candidate is taken out from the top of the sorted list in the following process, the sorted list is not empty initially. Note that when the sorted list is empty, it indicates that output traffic of physical links is not able to be leveled out any more, and thus, the process at this timing ends.

On the other hand, if the sorted list is not empty, the control unit 1101 takes out the one listed at the top of the sorted list, as a movement target (step S27). A VM, a VR, or an L2-tree is taken out.

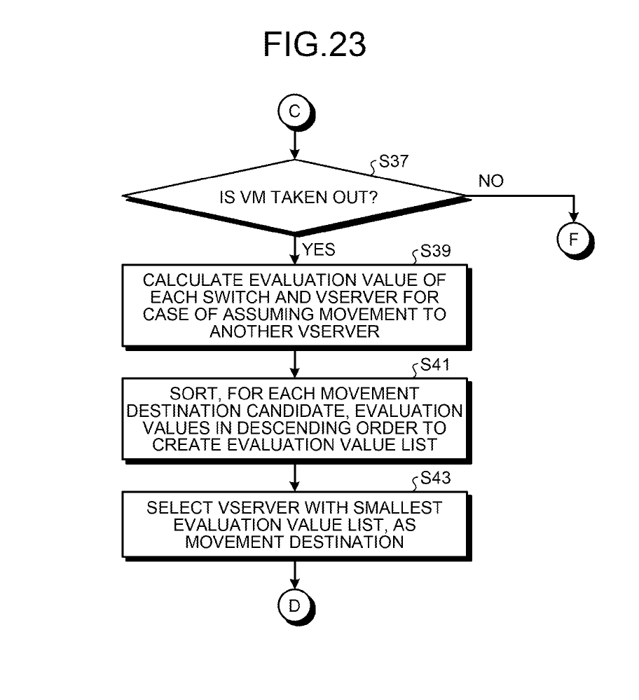

Then, the control unit 1101 determines whether the movement target is an L2-tree (step S29). If the movement target is not an L2-tree, processing transitions to a process of FIG. 23 through a terminal C.

On the other hand, if the movement target is an L2-tree, the control unit 1101 allows the first evaluation value calculating unit 1102 to calculate evaluation values of each switch and VServer for the case of assuming that the L2-tree is moved to another SSwitch (step S31). In this process, when there are a plurality of other SSwitches, evaluation values of each switch and VServer are calculated in the same manner as at step S3, with each of those other SSwitches being a movement destination candidate. Note, however, that since those that change by the movement target are some switches, etc., evaluation values are calculated only for those switches, etc. Note that the process at this step will be described in detail later.

Then, the control unit 1101 sorts, for each movement destination candidate, the evaluation values in descending order to create an evaluation value list (step S33). For example, when the evaluation values are computed as [0, 3, 5, 2], the evaluation value list is [5, 3, 2, 0].

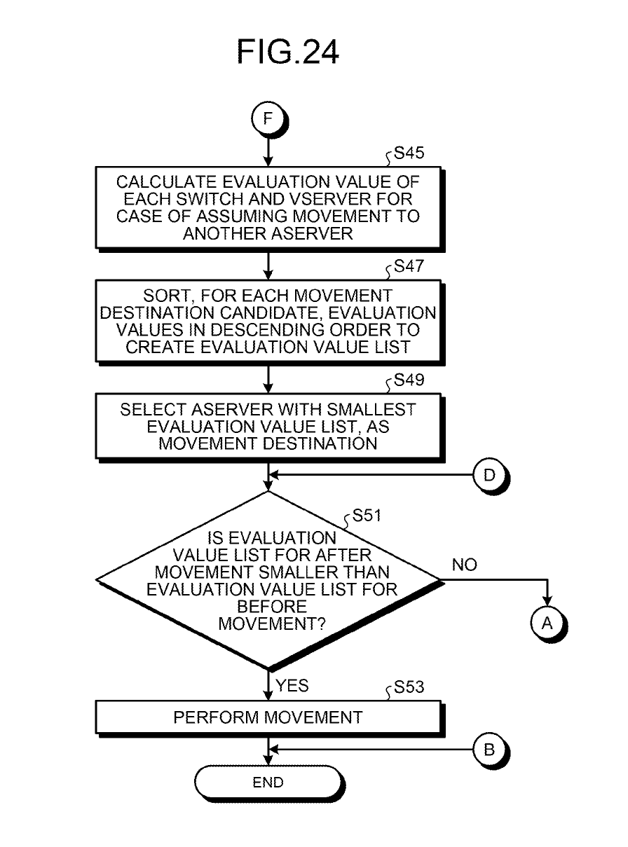

Then, the control unit 1101 selects an SSwitch with the smallest evaluation value list, as a movement destination (step S35). In this step, a comparison between the evaluation value lists is performed. Evaluation values with the same position are compared with each other in turn from the top. Then, a list with a smaller evaluation value that has made the first difference is determined to be a small evaluation value list. Specifically, when the evaluation value list [5, 3, 2, 0] is compared with the evaluation value list [5, 4, 2, 0], the second evaluation values are “3” and “4” and thus the former evaluation value list is determined to be small. Then, processing transitions to a process of FIG. 24 through a terminal D.

Using FIG. 23, a process after the terminal C will be described. The control unit 1101 determines whether the movement target is a VM (step S37). If the movement target is not a VM, processing transitions to a process of FIG. 24 through a terminal F.

On the other hand, if the movement target is a VM, the control unit 1101 allows the first evaluation value calculating unit 1102 to calculate evaluation values of each switch and VServer for the case of assuming that the VM is moved to another VServer (step S39). In this process, when there are a plurality of other VServers, evaluation values of each switch and VServer are calculated in the same manner as at step S3, with each of those other VServers being a movement destination candidate. Note, however, that since those that change by the movement target are some switches, etc., evaluation values are calculated only for those switches, etc. Note that the process at this step will be described in detail later together with step S31.

Then, the control unit 1101 sorts, for each movement destination candidate, the evaluation values in descending order to create an evaluation value list (step S41).

Then, the control unit 1101 selects a VServer with the smallest evaluation value list, as a movement destination (step S43). Then, processing transitions to a process of FIG. 24 through a terminal D.

Then, using FIG. 24, a process after the terminal F will be described. If it is determined at step S37 that the movement target is not a VM, the movement target is a Virtual router.

Therefore, the control unit 1101 allows the first evaluation value calculating unit 1102 to calculate evaluation values of each switch and VServer for the case of assuming that the Virtual router is moved to another AServer (step S45). In this process, when there are a plurality of other AServers, evaluation values of each switch and VServer are calculated in the same manner as at step S3, with each of those other AServers being a movement destination candidate. Note, however, that since those that change by the movement target are some switches, etc., evaluation values are calculated only for those switches, etc. Note that the process at this step will be described in detail later together with steps S31 and S39.

Then, the control unit 1101 sorts, for each movement destination candidate, the evaluation values in descending order to create an evaluation value list (step S47).

Then, the control unit 1101 selects an AServer with the smallest evaluation value list, as a movement destination (step S49).

Thereafter, the control unit 1101 determines whether the evaluation value list for after movement is smaller than the evaluation value list for before movement (the evaluation value list obtained from the evaluation values calculated at step S3) (step S51). If this condition is not satisfied, then even if movement is performed, the movement does not contribute to the leveling out of output traffic. Thus, the next movement target is taken out from the sorted list. Thus, processing returns to step S25 of FIG. 22 through a terminal A.

On the other hand, if the evaluation value list for after movement is smaller than the evaluation value list for before movement, the control unit 1101 instructs the movement control unit 1300 or the change control unit 1200 to move the movement target to the selected movement destination (step S53). Then, the process ends.

At step S53, when a VM or a VR is moved, the movement is implemented by specifying a physical machine where the VM or VR is currently disposed and a physical machine which is the movement destination, and executing a predetermined command. In addition, the data in the management data storage unit 1400 is also updated.

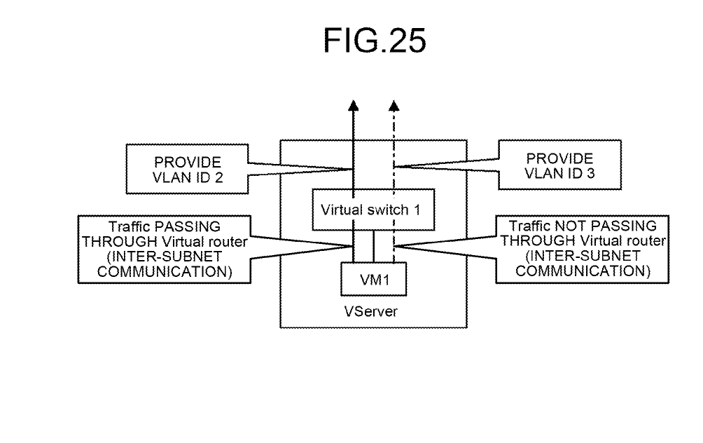

Furthermore, when an L2-tree is changed, an SSwitch through which intra-subnet communication passes is to be changed. In this case, a VLAN ID is changed so as to pass through an SSwitch which is a change destination. Therefore, as schematically illustrated in FIG. 25, a VLAN ID (“3” in FIG. 25) associated with the SSwitch which is the change destination is set on a Virtual switch in each VServer where a VM belonging to a subnet associated with the L2-tree is disposed, so as to add the VLAN ID to packets outputted from the VM belonging to the subnet associated with the L2-tree. More specifically, the VLAN ID associated with the SSwitch which is the change destination is set in packets outputted from a specific port of a Virtual switch to which a VM that satisfies the above-described condition is connected. Note that, as illustrated in FIG. 25, when communication is performed with a VM of a different subnet, the communication passes through a Virtual router. Thus, in that case, a different VLAN ID (“2” in FIG. 25) is provided.

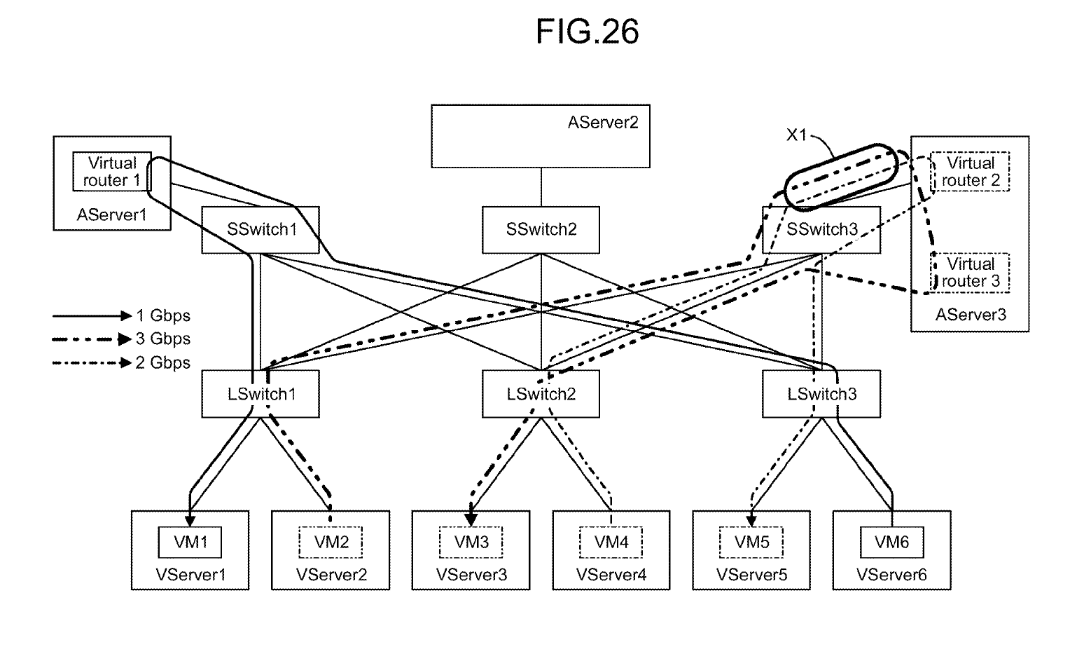

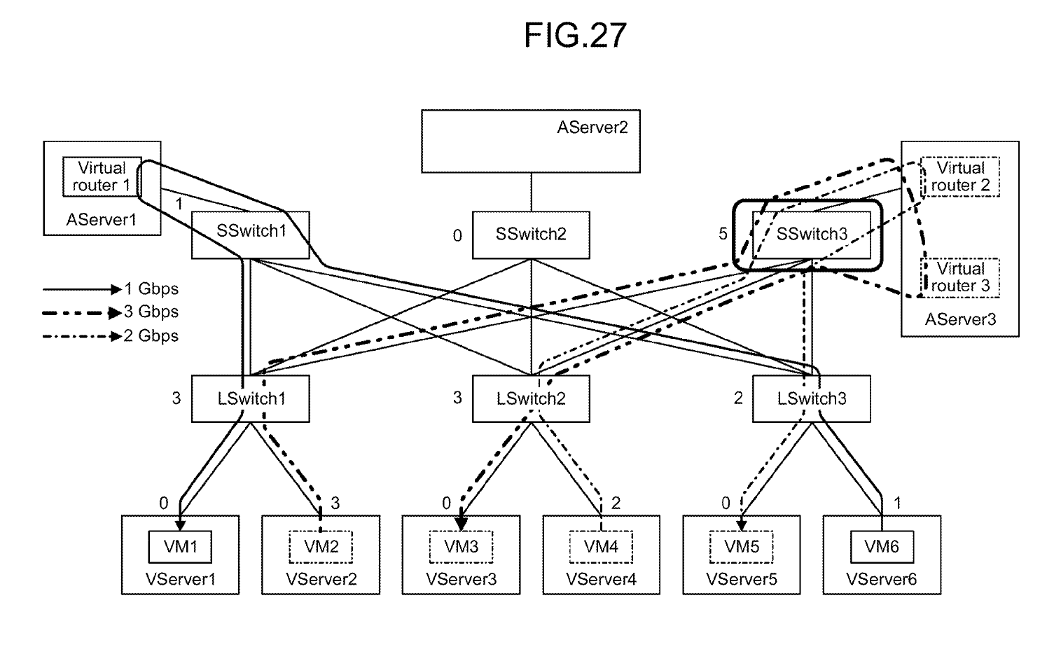

Next, the case of moving a Virtual router will be described using FIGS. 26 to 31. FIG. 26 illustrates an initial state. Since a Virtual router2 and a Virtual router3 are activated on an AServer3, an uplink of an SSwitch3 has a large latency (a portion X1). In the present embodiment, as illustrated in FIG. 27, evaluation values of output traffic are calculated for each switch and each VServer. As a result, the evaluation value of the SSwitch3 is “5” and thus the SSwitch3 is selected. According to the description of FIG. 21, a Virtual router is a movement target.

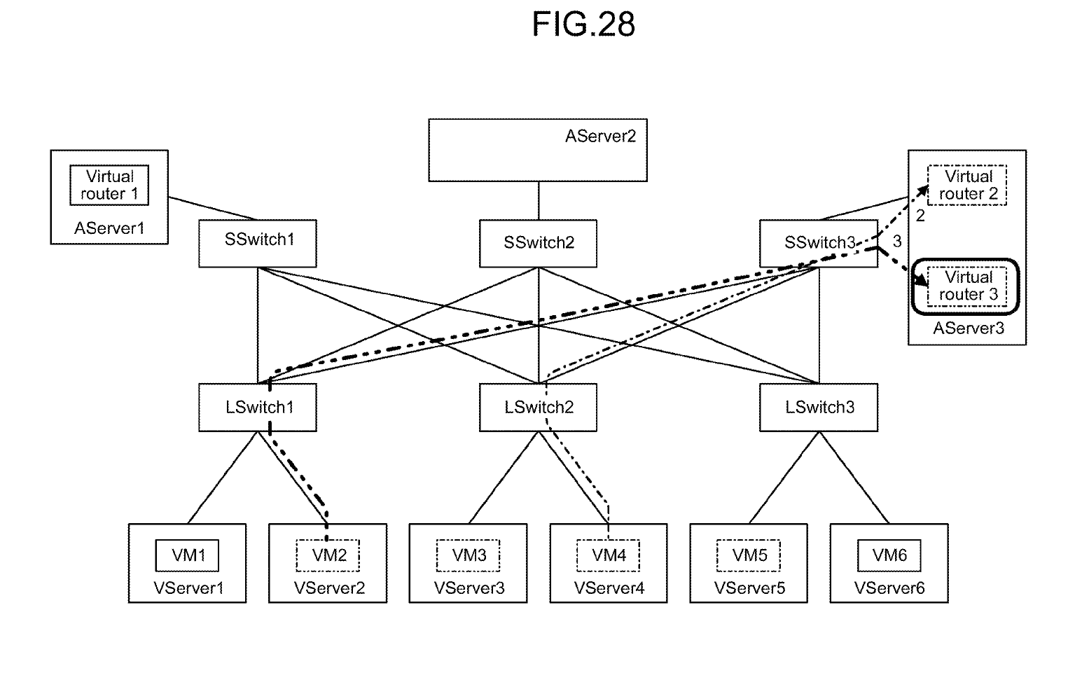

Then, as illustrated in FIG. 28, pieces of output traffic to the Virtual router2 are combined together and an evaluation value is calculated as “2”. Pieces of output traffic to the Virtual router3 are combined together and an evaluation value is calculated as “3”. Therefore, the first one to be selected as a movement target is the Virtual router3.

Accordingly, evaluation value lists are computed for a first case in which the Virtual router3 is moved to an AServer1 and a second case in which the Virtual router3 is moved to an AServer2.

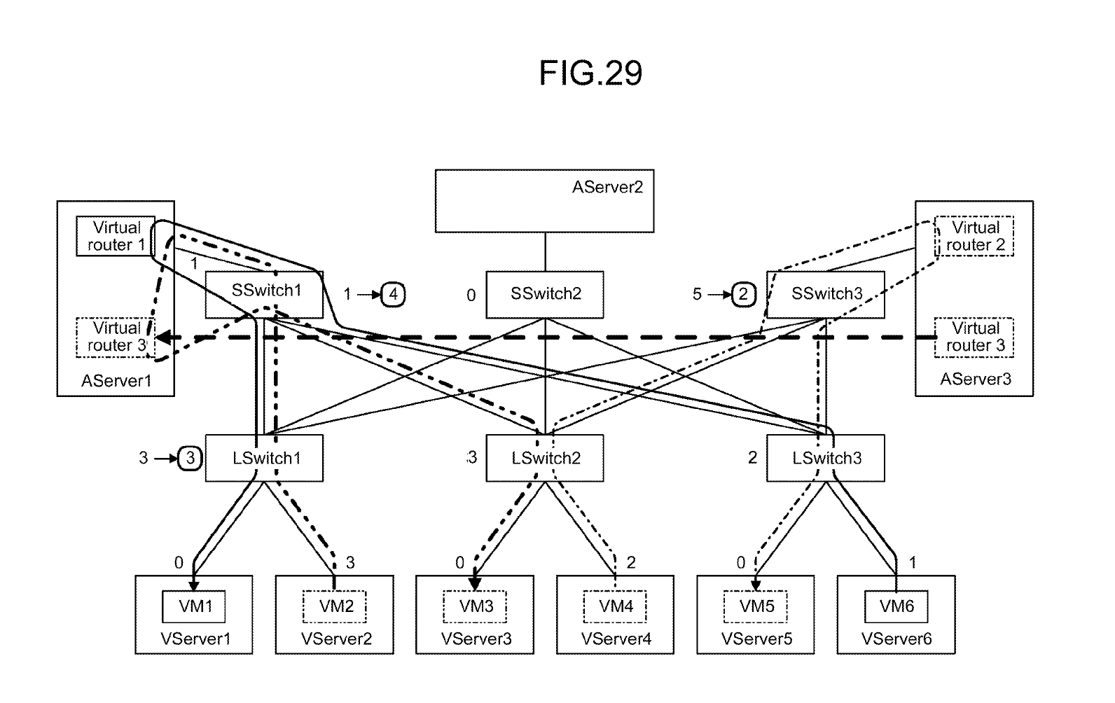

In the first case, as illustrated in FIG. 29, evaluation values are recalculated only for the SSwitch3 connected to the movement source AServer3, an SSwitch1 connected to the movement destination AServer1, and an LSwitch1 through which traffic passing through the Virtual router3 passes. In the case of FIG. 29, the evaluation value for the SSwitch3 decreases, the evaluation value for the SSwitch1 increases, and the evaluation value for the LSwitch1 consequently does not change. In this case, the evaluation value list is [4, 3, 3, 3, 2, 2, 2, 1, 0, 0, 0, 0]. Since the largest evaluation value is changed from “5” to “4”, it is obvious that the evaluation value list is smaller than that for before movement.

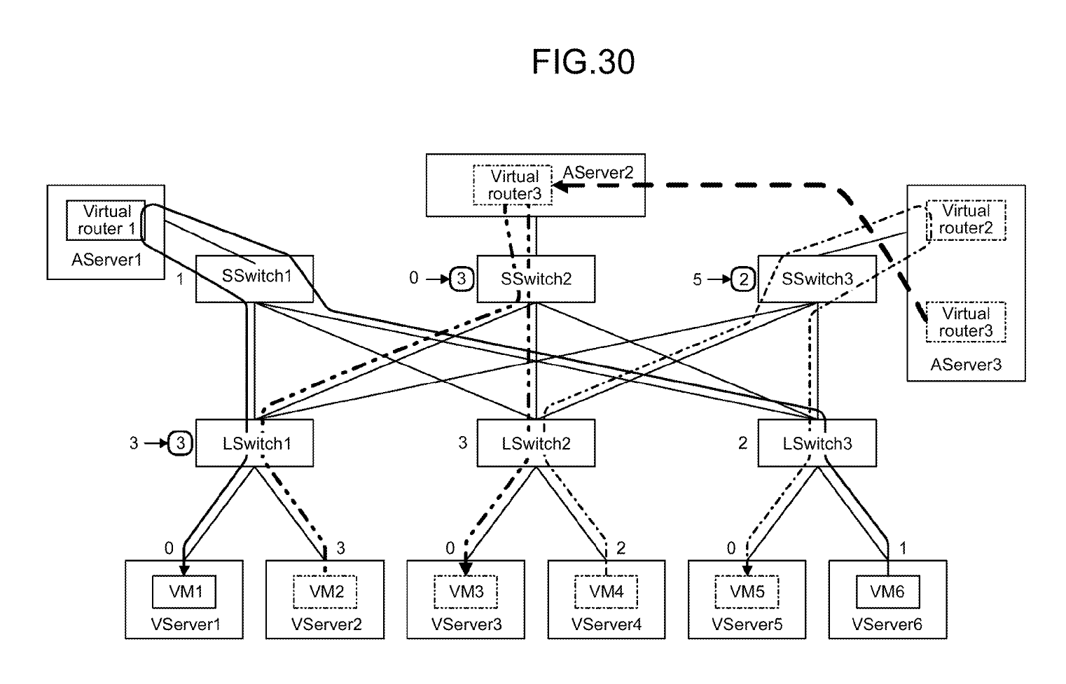

In the second case, as illustrated in FIG. 30, evaluation values are recalculated only for the SSwitch3 connected to the movement source AServer3, an SSwitch2 connected to the movement destination AServer2, and the LSwitch1 through which traffic passing through the Virtual router3 passes. In the case of FIG. 30, the evaluation value for the SSwitch3 decreases, the evaluation value for the SSwitch2 increases, and the evaluation value for the LSwitch1 consequently does not change. In this case, the evaluation value list is [3, 3, 3, 3, 2, 2, 2, 1, 1, 0, 0, 0]. Since the largest evaluation value is changed from “5” to “3”, it is obvious that the evaluation value is smaller than that for before movement. Furthermore, since the largest evaluation value is reduced from “4” to “3” over the first case, it can be seen that the AServer2 is an appropriate movement destination.

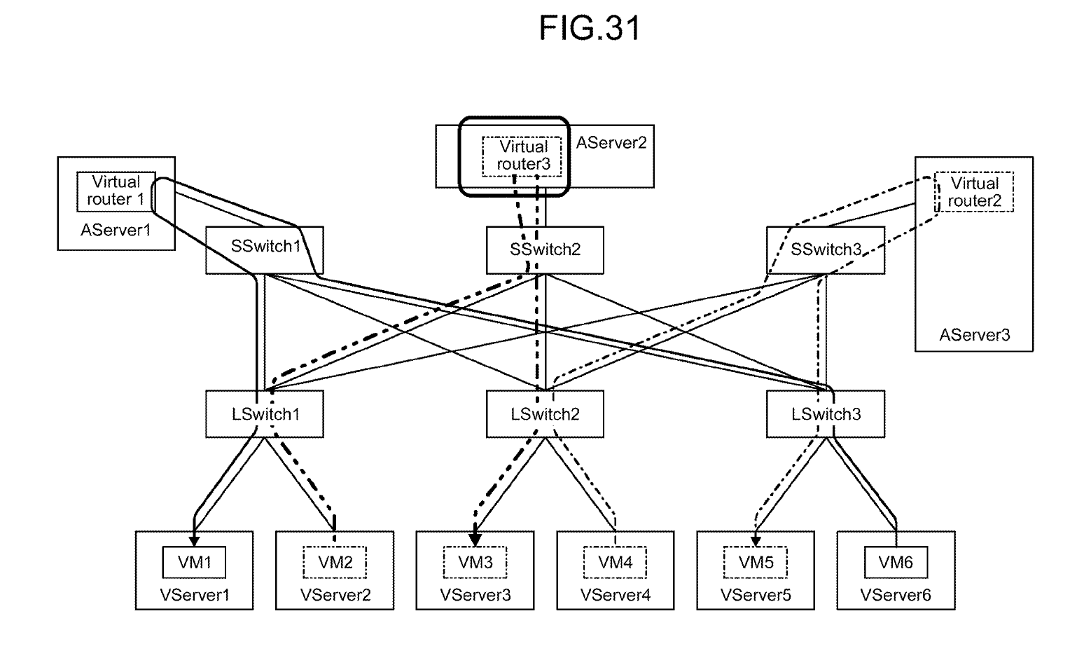

Namely, by changing the state to one such as that illustrated in FIG. 31, the output traffic is more leveled out than that for before movement.

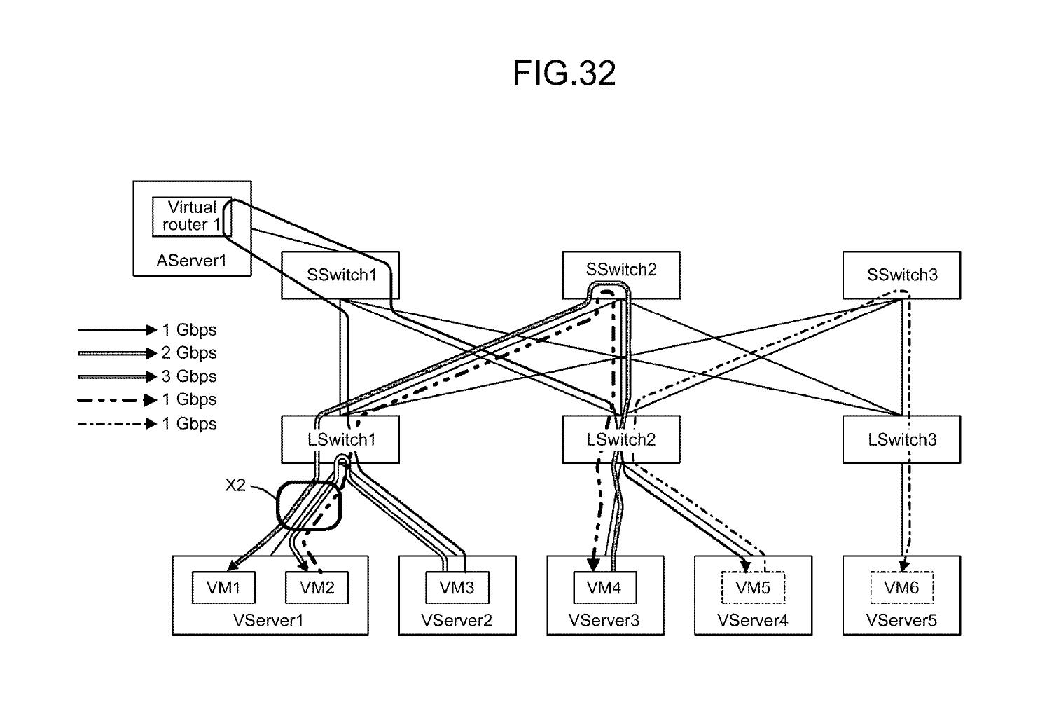

Next, the case of moving a VM will be described using FIGS. 32 to 39. FIG. 32 illustrates an initial state. Since traffic from a VM3 to a VM2 overlaps traffic from a VM4 to a VM1, a downlink of an LSwitch1 has a large latency (a portion X2).

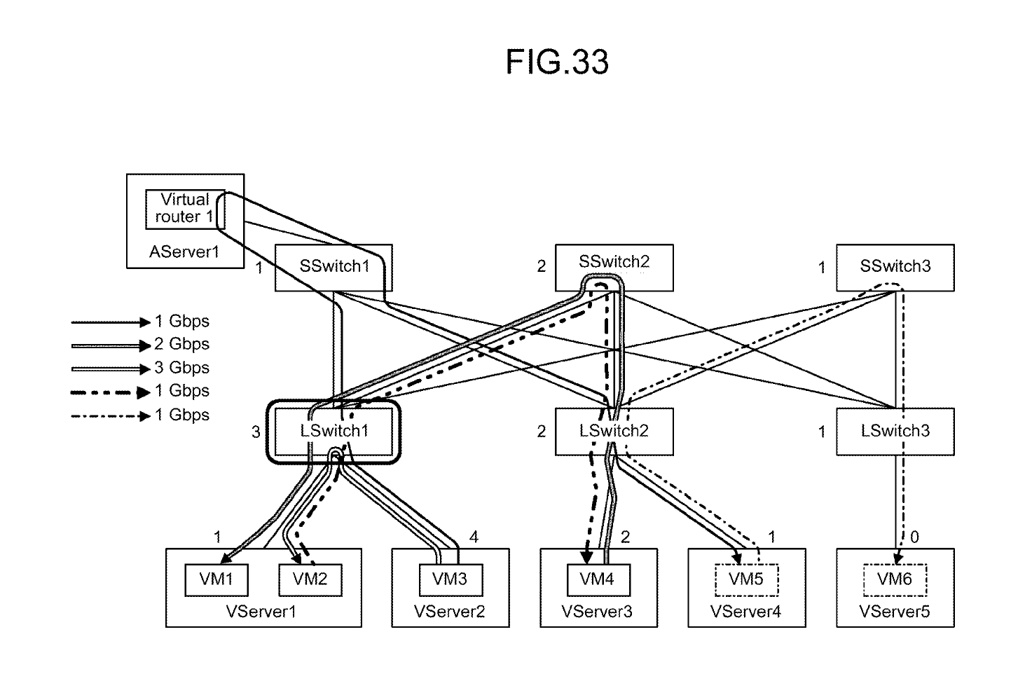

In the present embodiment, as illustrated in FIG. 33, evaluation values of output traffic are calculated for each switch and each VServer. Accordingly, the evaluation value of the LSwitch1 is “5” and thus the LSwitch1 is selected. According to the description of FIG. 21, a destination VM is a movement target.

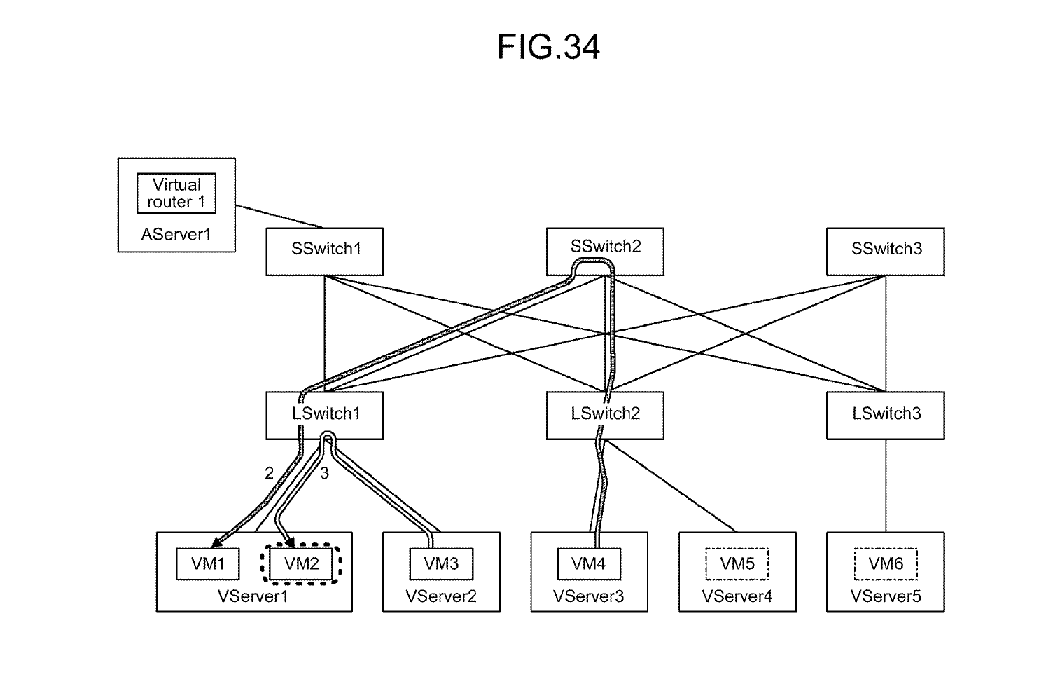

Then, as illustrated in FIG. 34, pieces of output traffic to the VM1 are combined together and an evaluation value is calculated as “2”. Pieces of output traffic to the VM2 are combined together and an evaluation value is calculated as “3”. Therefore, the first one to be selected as a movement target is the VM2.

Accordingly, evaluation value lists are calculated for a first case in which the VM2 is moved to a VServer2, a second case in which the VM2 is moved to a VServer3, a third case in which the VM2 is moved to a VServer4, and a fourth case in which the VM2 is moved to a VServer5.

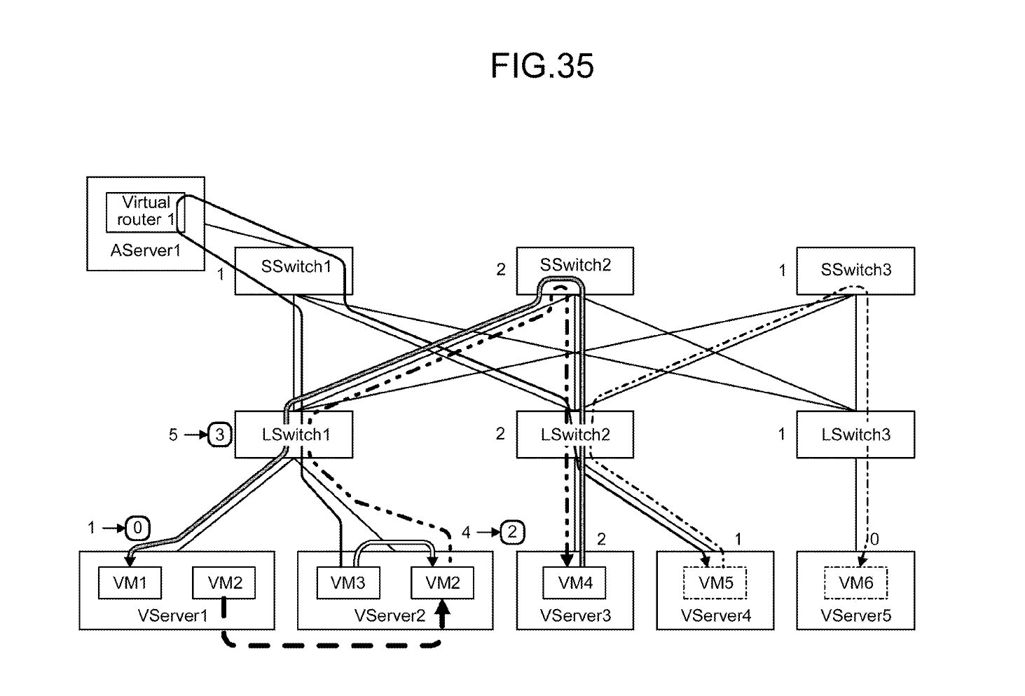

In the first case, as illustrated in FIG. 35, evaluation values are recomputed for a VServer1 which is a movement source, the VServer2 which is the movement destination, and the LSwitch1 to which the movement source VServer1 and the movement destination VServer2 are connected. In the case of FIG. 35, the evaluation value for the VServer1 decreases, the evaluation value for the VServer2 also decreases, and the evaluation value for the LSwitch1 also decreases. In this case, the evaluation value list is [3, 2, 2, 2, 2, 1, 1, 1, 1, 0, 0]. Since the largest evaluation value is changed from “5” to “3”, it is obvious that the evaluation value is smaller than that for before movement.

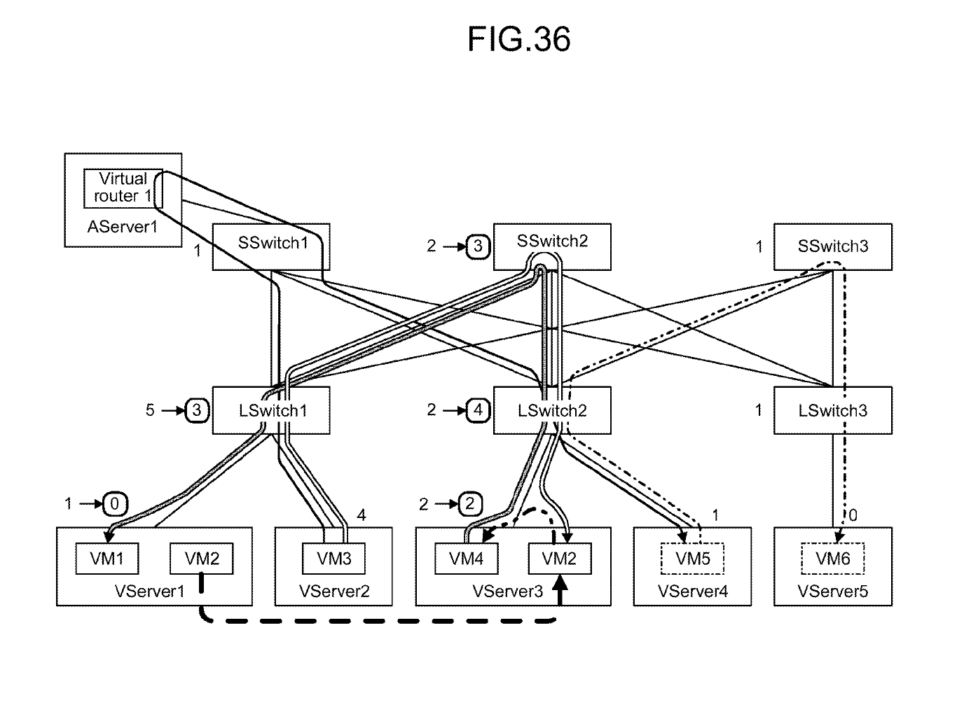

In the second case, as illustrated in FIG. 36, evaluation values are recomputed for the VServer1 which is the movement source, the VServer3 which is the movement destination, the LSwitch1 to which the movement source VServer1 is connected, an LSwitch2 to which the movement destination VServer3 is connected, and an SSwitch2 through which intra-subnet communication of the VM2 which is the movement target passes. In the case of FIG. 36, the evaluation value for the VServer1 decreases, the evaluation value for the VServer3 does not change, the evaluation value for the LSwitch1 decreases, the evaluation value for the LSwitch2 increases, and the evaluation value for the SSwitch2 increases. In this case, the evaluation value list is [4, 4, 3, 3, 2, 1, 1, 1, 1, 0, 0]. Since the largest evaluation value is changed from “5” to “4”, it is obvious that the evaluation value is smaller than that for before movement.

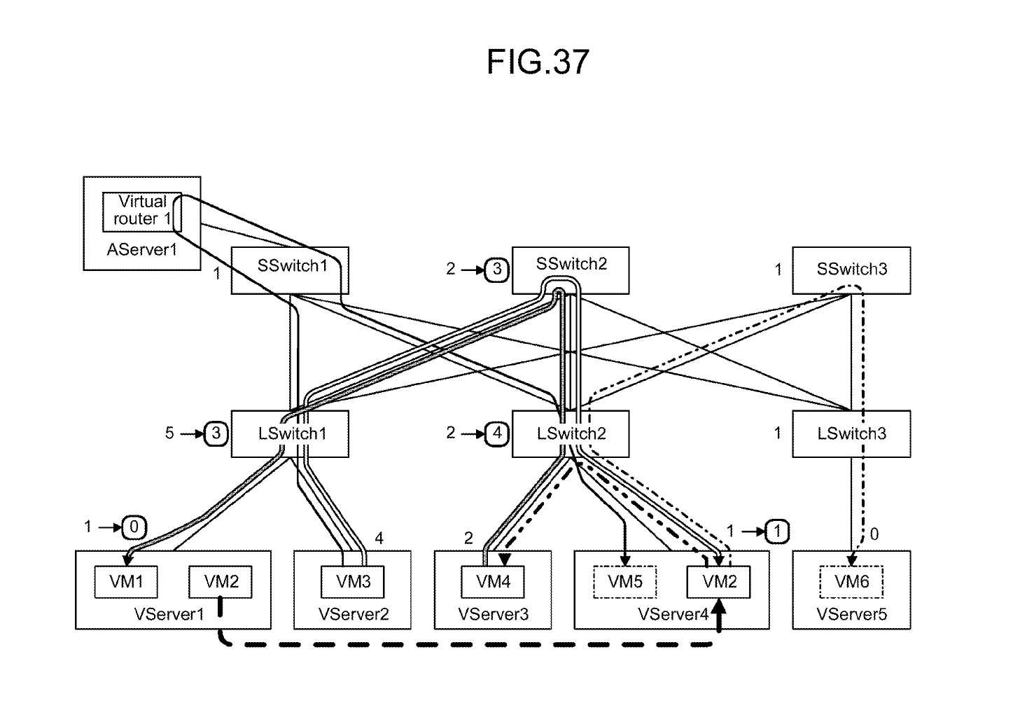

In the third case, as illustrated in FIG. 37, evaluation values are recomputed for the VServer1 which is the movement source, the VServer4 which is the movement destination, the LSwitch1 to which the movement source VServer1 is connected, the LSwitch2 to which the movement destination VServer4 is connected, and the SSwitch2 through which intra-subnet communication of the VM2 which is the movement target passes. In the case of FIG. 37, the evaluation value for the VServer1 decreases, the evaluation value for the VServer4 does not change, the evaluation value for the LSwitch1 decreases, the evaluation value for the LSwitch2 increases, and the evaluation value for the SSwitch2 increases. In this case, the evaluation value list is [4, 4, 3, 3, 2, 1, 1, 1, 1, 0, 0]. Since the largest evaluation value is changed from “5” to “4”, it is obvious that the evaluation value is smaller than that for before movement.

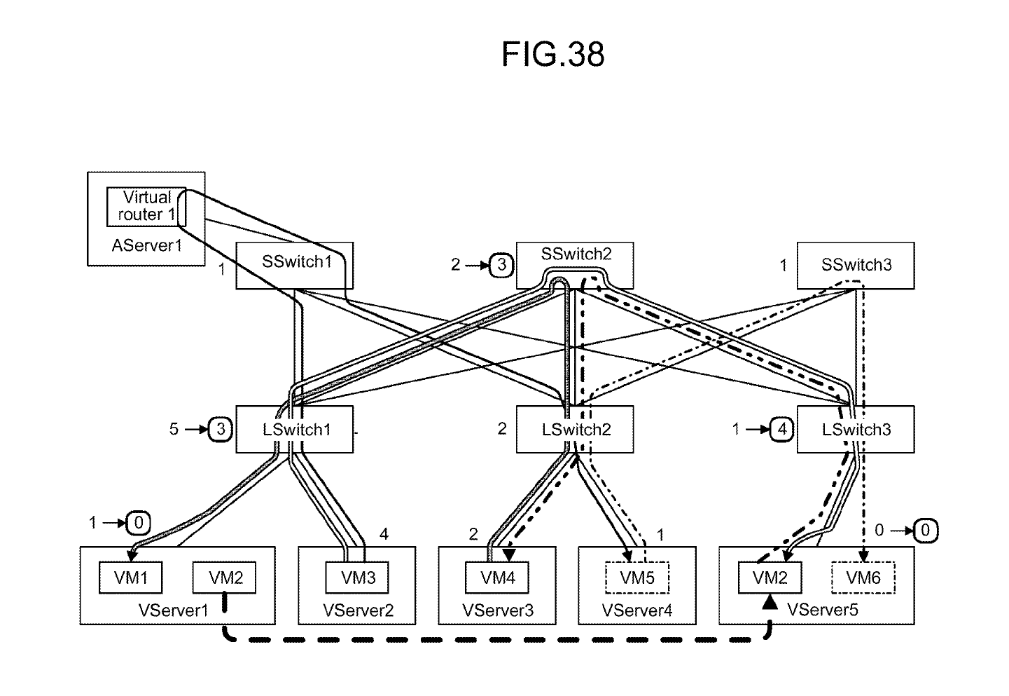

In the fourth case, as illustrated in FIG. 38, evaluation values are recomputed for the VServer1 which is the movement source, the VServer5 which is the movement destination, the LSwitch1 to which the movement source VServer1 is connected, an LSwitch3 to which the movement destination VServer5 is connected, and the SSwitch2 through which intra-subnet communication of the VM2 which is the movement target passes. In the case of FIG. 38, the evaluation value for the VServer1 decreases, the evaluation value for the VServer5 does not change, the evaluation value for the LSwitch1 decreases, the evaluation value for the LSwitch3 increases, and the evaluation value for the SSwitch2 increases. In this case, the evaluation value list is [4, 4, 3, 3, 2, 2, 1, 1, 1, 0, 0]. Since the largest evaluation value is changed from “5” to “4”, it is obvious that the evaluation value is smaller than that for before movement.

Comparing the evaluation value lists of the first to fourth cases, the first case has a small largest evaluation value and thus the evaluation value list for the first case is also determined to be small.

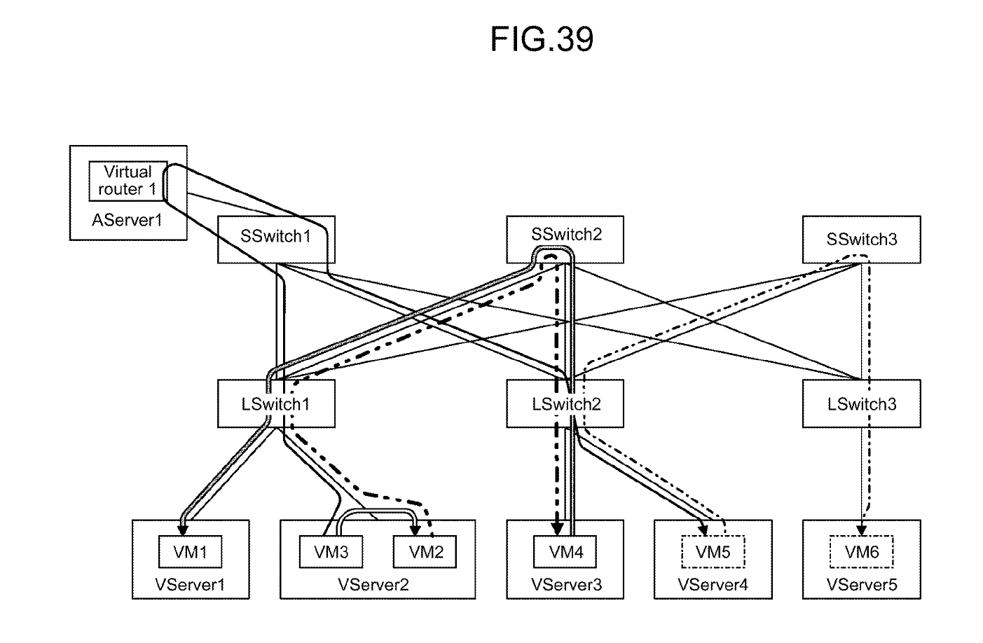

Namely, by changing the state to one such as that illustrated in FIG. 39, the output traffic is more leveled out than that for before movement.

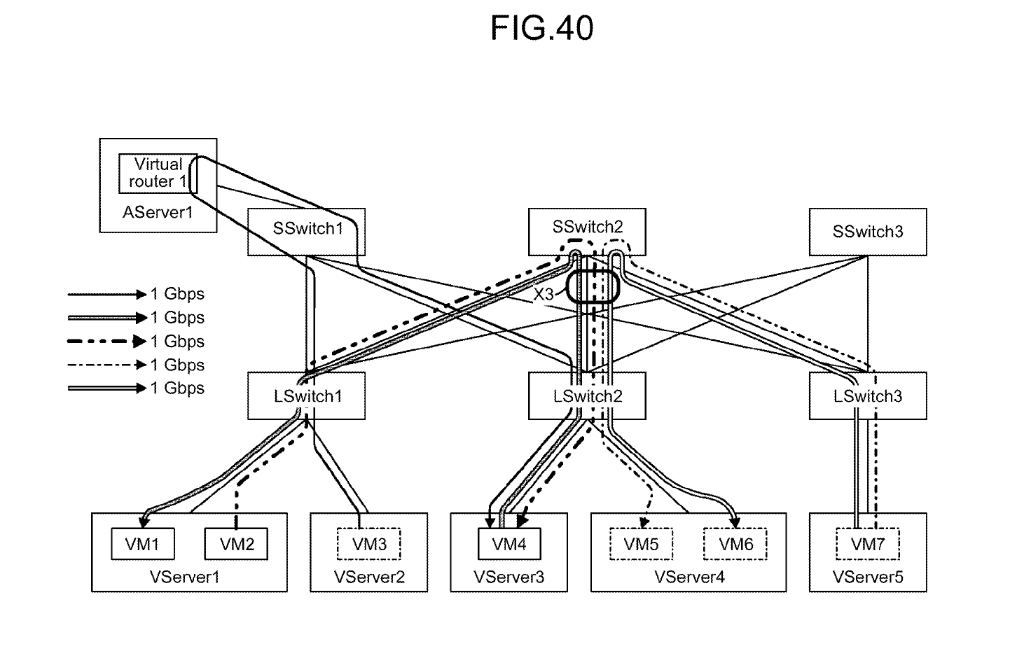

Next, the case of moving an L2-tree (intra-subnet communication) will be described using FIGS. 40 to 45. FIG. 40 illustrates an initial state. Since traffic from a VM7 to a VM6, traffic from the VM7 to a VM5, and traffic from a VM2 to a VM4 overlap each other, a downlink of an SSwitch2 has a large latency (a portion X3).

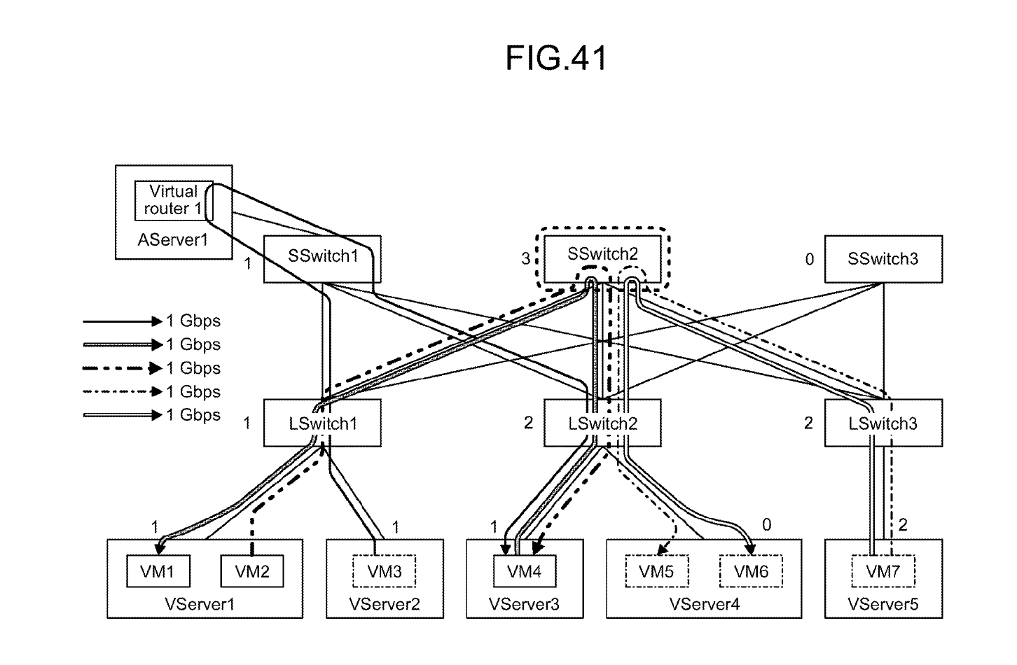

In the present embodiment, as illustrated in FIG. 41, evaluation values of output traffic are calculated for each switch and each VServer. As a result, the evaluation value of the SSwitch2 is “3” and thus the SSwitch2 is selected. According to the description of FIG. 21, a destination VM, a VR, and an L2-tree are movement targets. Note, however, that since the SSwitch2 is not connected to an AServer, the VR is not selected as a movement target.

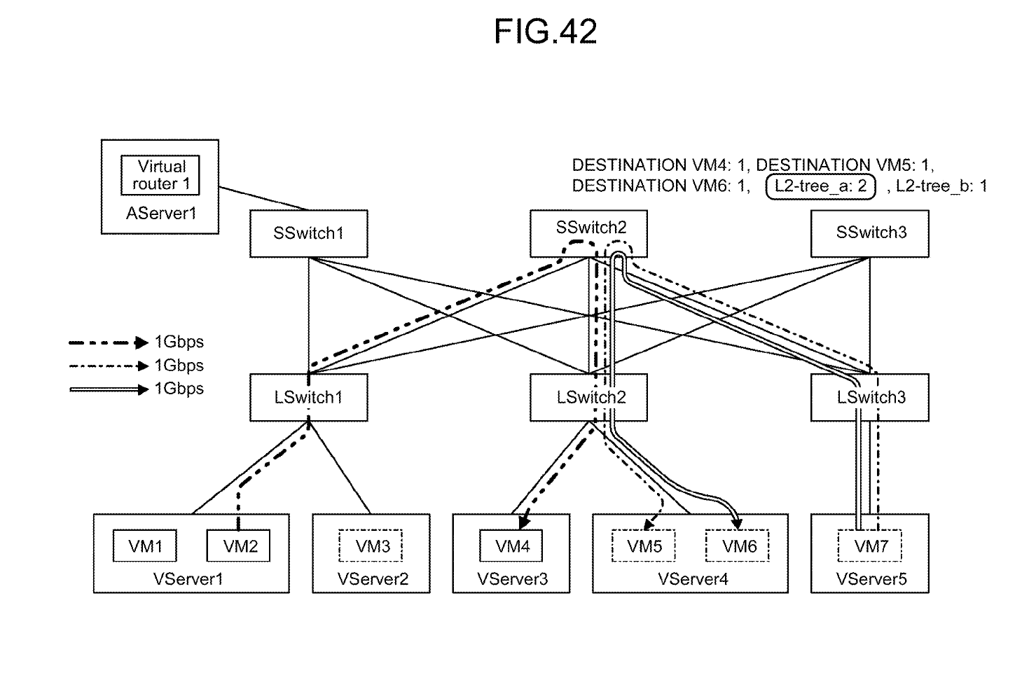

Then, as illustrated in FIG. 42, pieces of output traffic to the VM4 are combined together and an evaluation value is calculated as “1”. Pieces of output traffic to the VM5 are combined together and an evaluation value is calculated as “1”. Pieces of output traffic to the VM6 are combined together and an evaluation value is calculated as “1”. The evaluation value of a subnet L2-tree a for a VM3 and the VM5 to the VM7 is “2”. The evaluation value of a subnet L2-tree b for a VM1, the VM2, and the VM4 is “1”. Therefore, the first one to be selected is the L2-tree a.

Accordingly, evaluation value lists are calculated for a first case in which the L2-tree a is moved to an SSwitch1 and a second case in which the L2-tree a is moved to an SSwitch3.

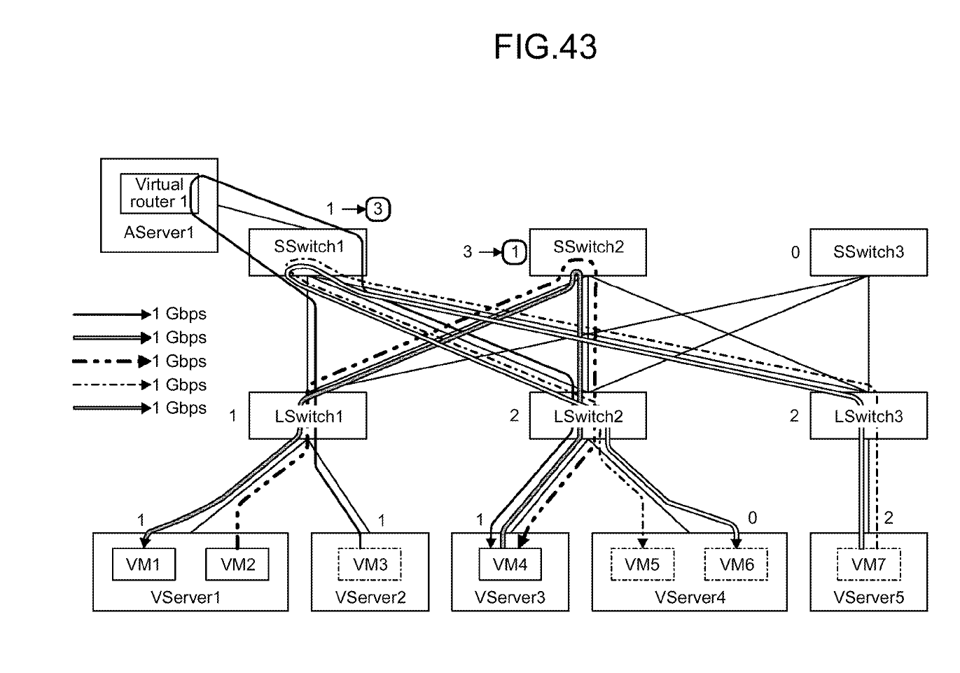

In the first case, as illustrated in FIG. 43, evaluation values are recomputed for the SSwitch2 which is the movement source and the SSwitch1 which is the movement destination. In the case of FIG. 43, the evaluation value for the SSwitch2 decreases and the evaluation value for the SSwitch1 increases. In this case, the evaluation value list is [3, 2, 2, 2, 1, 1, 1, 1, 1, 0, 0]. The evaluation value list has not been changed from that for before movement.

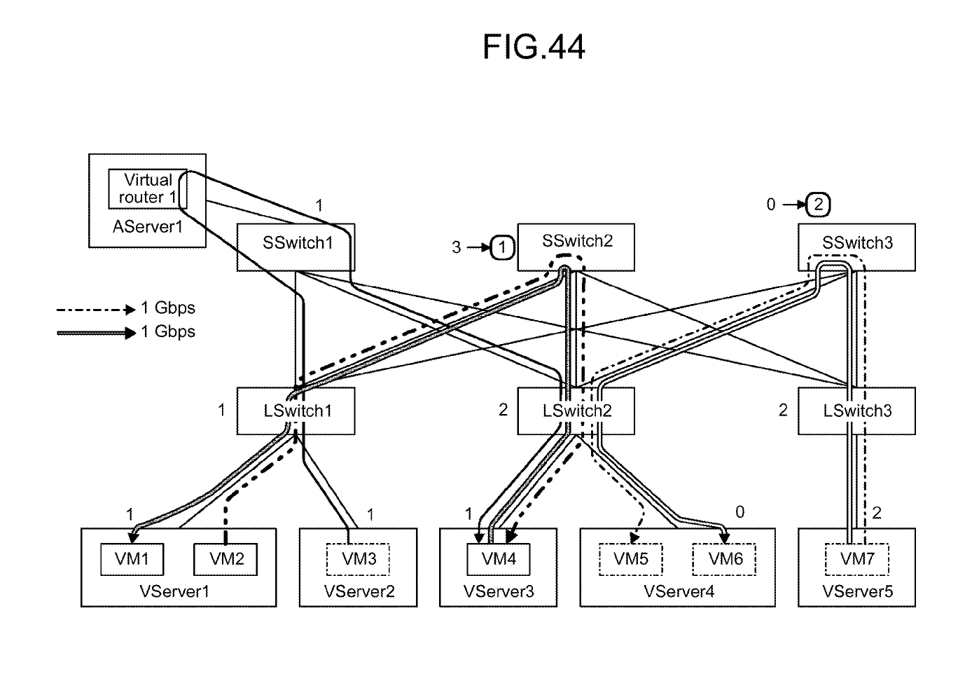

In the second case, as illustrated in FIG. 44, evaluation values are recomputed for the SSwitch2 which is the movement source and the SSwitch3 which is the movement destination. In the case of FIG. 44, the evaluation value for the SSwitch2 decreases and the evaluation value for the SSwitch3 increases. In this case, the evaluation value list is [2, 2, 2, 2, 1, 1, 1, 1, 1, 1, 0]. Since the largest evaluation value is changed from “3” to “2”, it is obvious that the evaluation value is smaller than that for before movement.

Comparing the evaluation value lists of the first and second cases, the second case has a small largest evaluation value and thus the evaluation value list for the second case is also determined to be small.

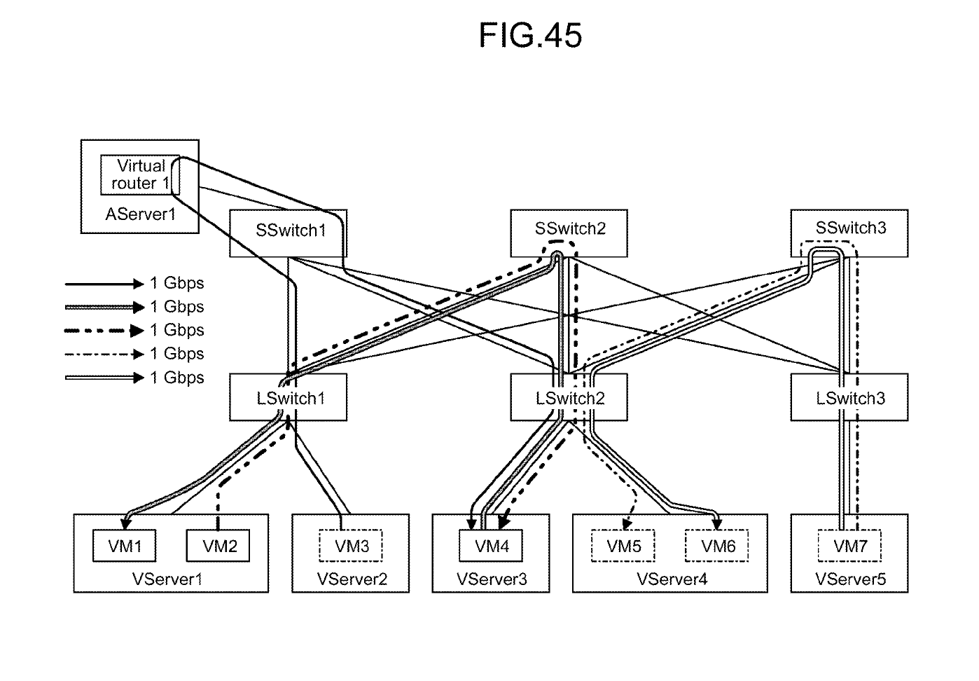

Namely, by changing the state to one such as that illustrated in FIG. 45, the output traffic is more leveled out than that for before movement.

As described above, traffic imbalance that is not able to be relieved by switching of a path by a physical switch which is performed in conventional art can be leveled out (balanced). By this, communication performance between VMs improves. In addition, by leveling out traffic, extra bandwidth increases for each physical link. Thus, it is highly likely that congestion caused by temporarily increased traffic can be avoided.

In addition, the above-described process has a low processing load and short computation time. Specifically, evaluation values at a first stage are calculated on a per physical link basis, and then, flows are combined together for a selected physical link and evaluation values are calculated for a VM, a VR, or an L2-tree. Thus, the load on a combining process is reduced. Furthermore, in terms of updating evaluation values only for physical apparatuses related to a VM, a VR, or an L2-tree which is to be moved or changed, too, processing load is reduced.

Supplements

For combining of flows

Flows to be combined together vary according to a physical link to be focused.

(a) The Uplink of the SSwitch

A flow for each virtual router

(b) The Downlink of the SSwitch

A flow for each Virtual router, a flow for each L2-tree, a flow for each source VM, and a flow for each destination VM

For the VM, for the process of determining a movement destination, combining of flows that pass through a Virtual router and combining of flows that do not pass through a Virtual router are performed distinctively from each other.

(c) The Uplink of the LSwitch

A flow for each Virtual router, a flow for each L2-tree, a flow for each source VM, and a flow for each destination VM

For the VM, for the process of determining a movement destination, combining of flows that pass through a Virtual router and combining of flows that do not pass through a Virtual router are performed distinctively from each other.

(d) the Downlink of the LSwitch

A flow for each source VM and a flow for each destination VM

For the VM, for the process of determining a movement destination, combining of flows that pass through a Virtual router and combining of flows that do not pass through a Virtual router are performed distinctively from each other.

(e) VServer

A flow for each source VM and a flow for each destination VM

For the VM, for the process of determining a movement destination, combining of flows that pass through a Virtual router and combining of flows that do not pass through a Virtual router are performed distinctively from each other.

Traffic Changed by Movement

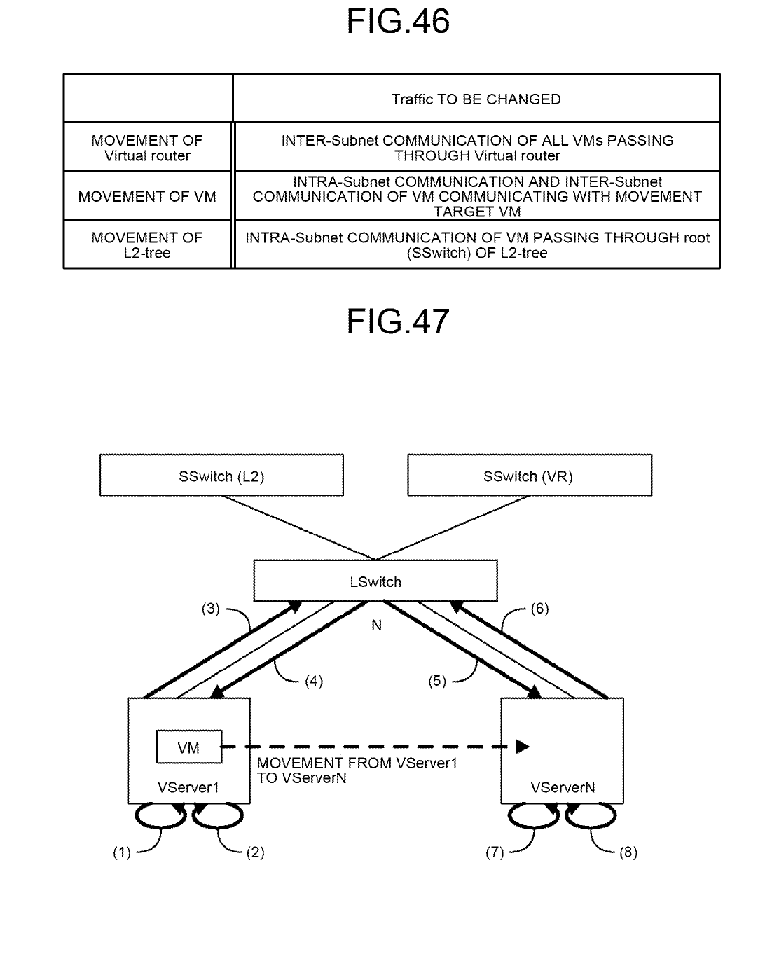

When a VM, a Virtual router, or an L2-tree to be moved is identified, the identified one is supposedly moved and evaluation values are updated. The traffic influenced at that time is one such as that illustrated in FIG. 46. The evaluation values of a switch and a VServer through which such traffic passes change.

For the Process of Determining a Movement Destination

Evaluation values are recomputed only for a switch and a VServer that have a physical link influenced by the movement or change of a VM, a VR, or an L2-tree, for the switch and the VServer. At this time, the evaluation values of the switch and the VServer are updated using the evaluation value of a movement target (a VM, a VR, or an L2-tree) for before movement.

(1) The Case of Moving a Virtual Router or an L2-Tree

The uplink and downlink of an SSwitch and the uplink of an SSwitch

For these uplinks and downlink, an SSwitch or SSwitch connected to an AServer which is a movement destination is influenced by the amount corresponding to the evaluation value of a movement target.

(2) The Case of Moving a VM

When a VM which is a movement target is moved to a VServer connected to the same LSwitch as the VM, eight pieces of output traffic which are described below change.

On the other hand, when a VM which is a movement target is moved to a VServer connected to a different LSwitch than that connected to the VM, 16 pieces of output traffic which are described below change.

Here, symbols used in the following description are described.

$${t}_{A \to B} \\ Traffic before movement from A to B \\ A and B are SSwitches , LSwitches , or VServers \\ {t}_{before \to after} \\ Traffic before movement \to Traffic after movement \\ t ( L 2 ) \\ Traffic passing through an L 2 - tree \\ t ( VR ) \\ Traffic passing through a Vitrual router \\ fromVM \\ Traffic transmitted from a VM \\ toVM \\ Traffic transmitted to a VM \\ \sum {t}_{k} ( k \text{:} 1 , … , N ) \\ {t}_{1} + … + {t}_{N} \\ SS \\ SSwitch \\ SSwitch ( L 2 ) , SS ( L 2 ) \\ An SSwitch passed through when an L 2 \\ - tree is passed through \\ SSwitch ( VR ) , SS ( VR ) \\ An SSwitch passed through when a Vitrual router is passed through \\ LS \\ LSwitch \\ VS \\ VServer \qquad ( 1 )$$

(A) the Case of Moving a VM to a VServer Connected to the Same LSwitch as the VM

As illustrated in FIG. 47, it is assumed that, when N numbers of VServers are connected to one LSwitch, a VM activated on the first VServer is moved to an Nth VServer. In this case, pieces of traffic (1) to (8) change. Specifically, there are changes such as those illustrated below.

$$( 1 ) {t}_{VS : 1 \to VS : 1 ( fromVM )} \to 0 \\ ( 2 ) {t}_{VS : 1 \to VS : 1 ( toVM )} \to 0 \\ ( 3 ) {t}_{VS : 1 \to LS} \to {t}_{VS : 1 \to VS : 1 ( toVM )} + {t ( VR )}_{VS : 1 \to LS ( toVM )} \\ ( 4 ) {t}_{LS \to VS : 1} \to {t}_{VS : 1 \to VS : 1 ( fromVM )} + {t ( VR )}_{LS \to VS : 1 ( fromVM )} \\ ( 5 ) {t}_{LS \to VS : N} \to {t}_{VS : 1 \to VS : 1 ( toVM )} + {t}_{LS \to VS : 1 ( toVM )} + {t ( VR )}_{LS \to VS : N ( fromVM )} - {t ( L 2 )}_{VS : N \to LS ( toVM )} \\ ( 6 ) {t}_{VS : N \to LS} \to {t}_{VS : 1 \to VS : 1 ( fromVM )} + {t}_{VS : 1 \to LS ( fromVM )} + {t ( VR )}_{VS : N \to LS ( toVM )} - {t ( L 2 )}_{LS \to VS : N ( fromVM )} \\ ( 7 ) 0 \to {t ( L 2 )}_{LS \to VS : N ( fromVM )} \\ ( 8 ) 0 \to {t ( L 2 )}_{VS : N \to LS ( toVM )} \qquad ( 2 )$$

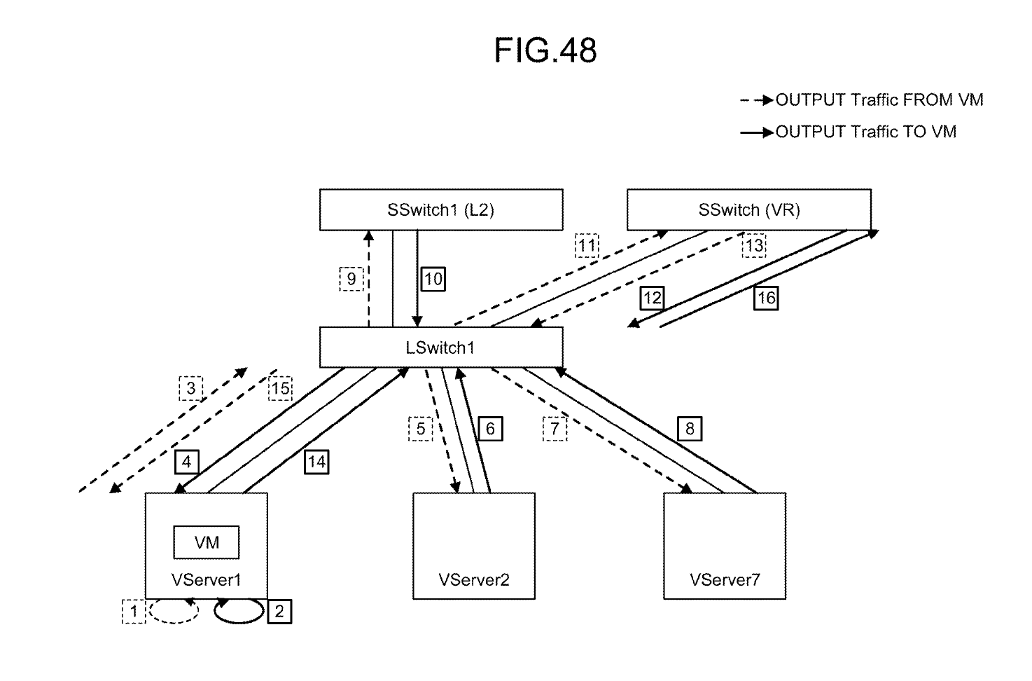

Such a case will be specifically illustrated below. Here, description is made based on traffic for before movement which is illustrated in FIG. 48. Note that it is assumed that a Virtual router is provided on the SSwitch2 side and an L2-tree is set in an SSwitch1. Then, it is assumed that the VM moves from a VServer1 to a VServer2. Furthermore, it is assumed that in FIG. 48 dashed lines indicate output traffic from the VM and solid lines indicate output traffic to the VM.

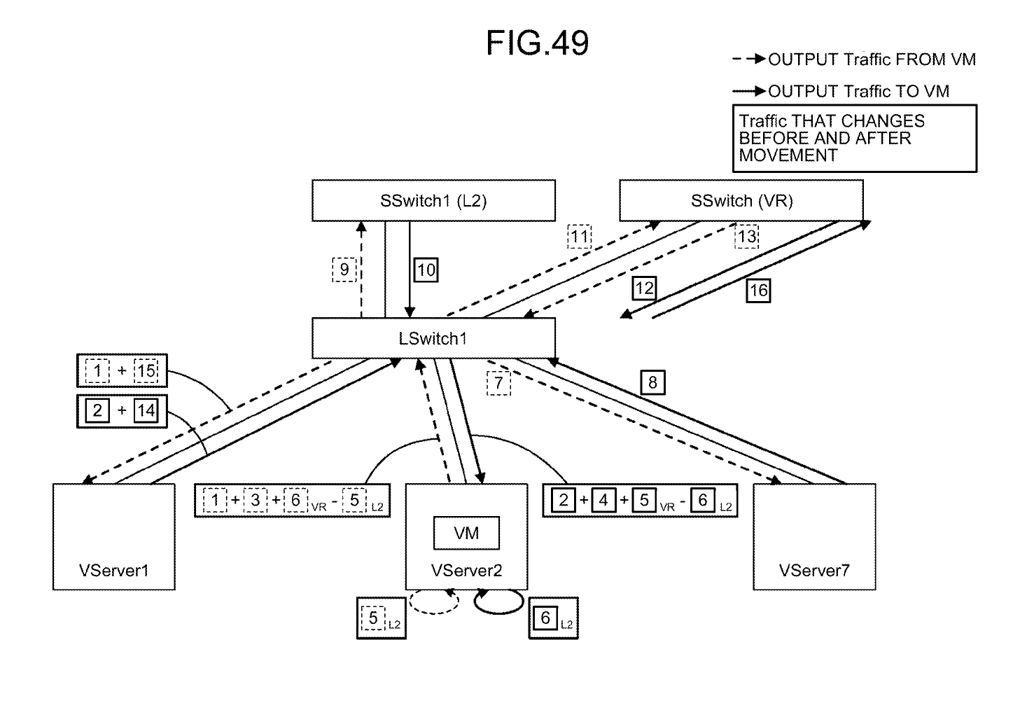

FIG. 49 illustrates traffic for after movement. Note that the traffic of the VM in the VServer1 which is the movement source changes to “0”, though not illustrated. Then, output traffic from the VServer1 to an LSwitch1, output traffic from the LSwitch1 to the VServer1, output traffic to a VM in the VServer2 and output traffic from the VM, output traffic from the VServer2 to the LSwitch1, and output traffic from the LSwitch1 to the VServer2 change.

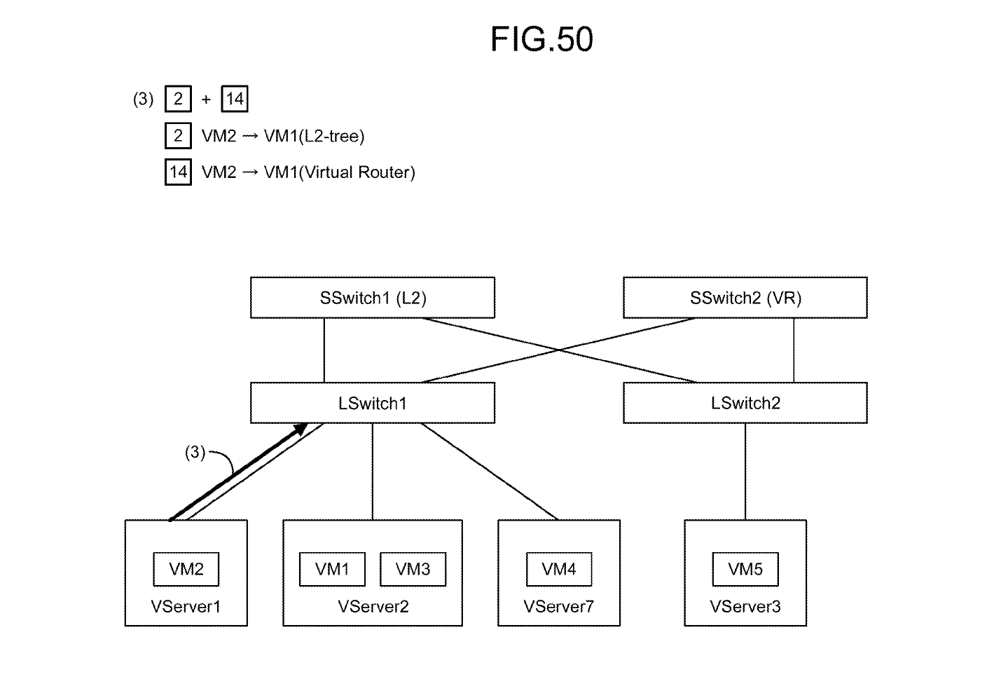

The output traffic (3) of FIG. 47 is, as illustrated in FIG. 50, the sum of intra-subnet communication (L2-tree) from a VM2 to a VM1 and inter-subnet communication (Virtual router) from the VM2 to the VM1. “2” and “14” indicate output traffic for before movement which is illustrated in FIG. 48.

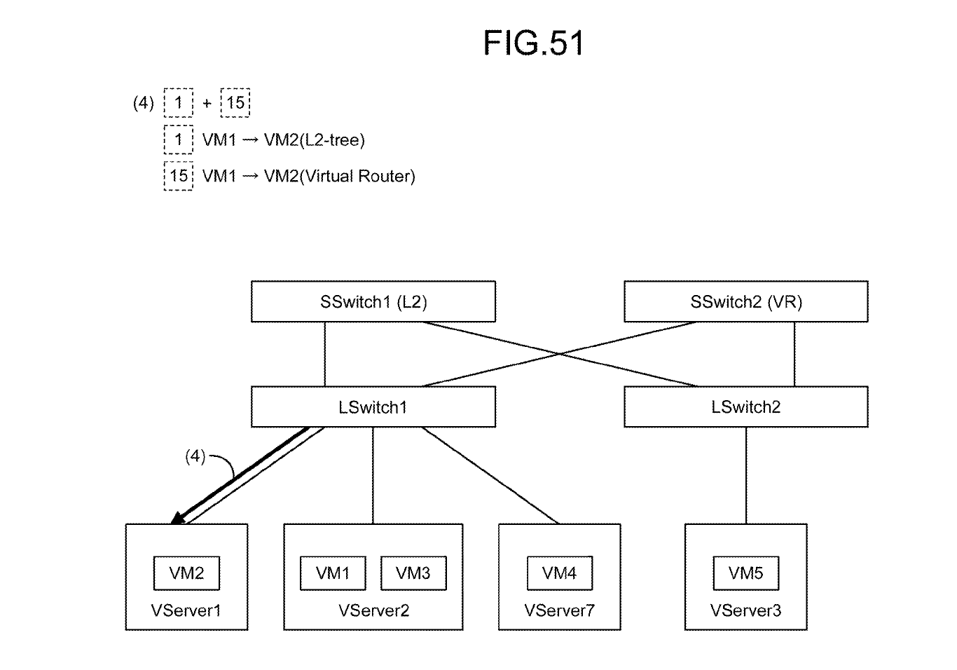

The output traffic (4) of FIG. 47 is, as illustrated in FIG. 51, the sum of intra-subnet communication (L2-tree) from the VM1 to the VM2 and intra-subnet communication (Virtual router) from the VM2 to the VM1. “1” and “15” indicate output traffic for before movement which is illustrated in FIG. 48.

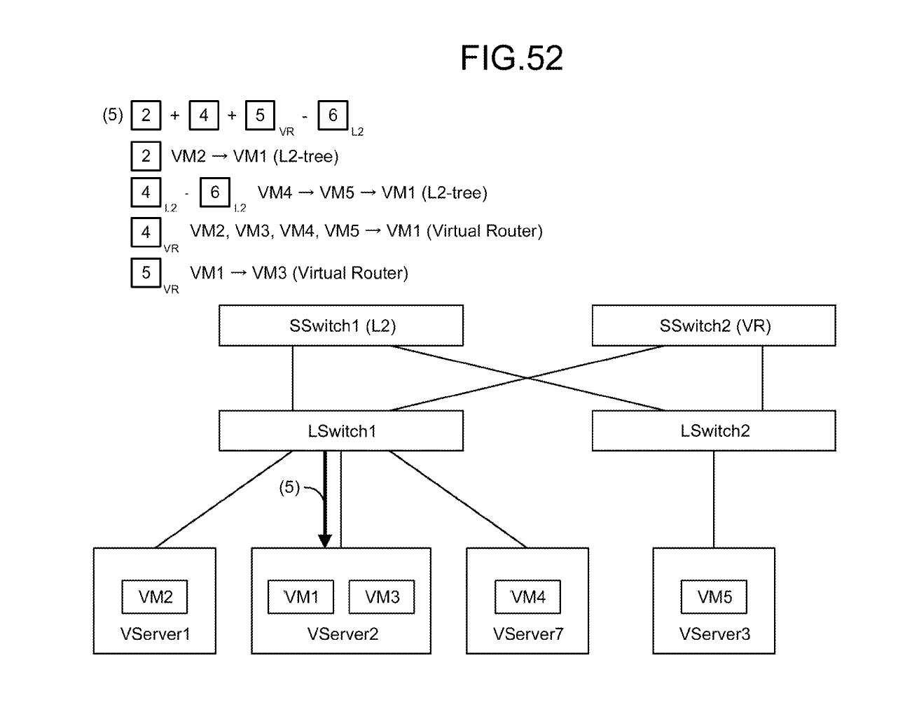

The output traffic (5) of FIG. 47 is, as illustrated in FIG. 52, the sum of intra-subnet communication (L2-tree) from the VM2 to the VM1, intra-subnet communication (L2-tree) from a VM4 and a VM5 to the VM1, inter-subnet communication (Virtual router) from the VM2 to the VM5 to the VM1, and inter-subnet communication (Virtual router) from the VM1 to the VM3. “2”, “4”, “5”, and “6” indicate output traffic for before movement which is illustrated in FIG. 48.

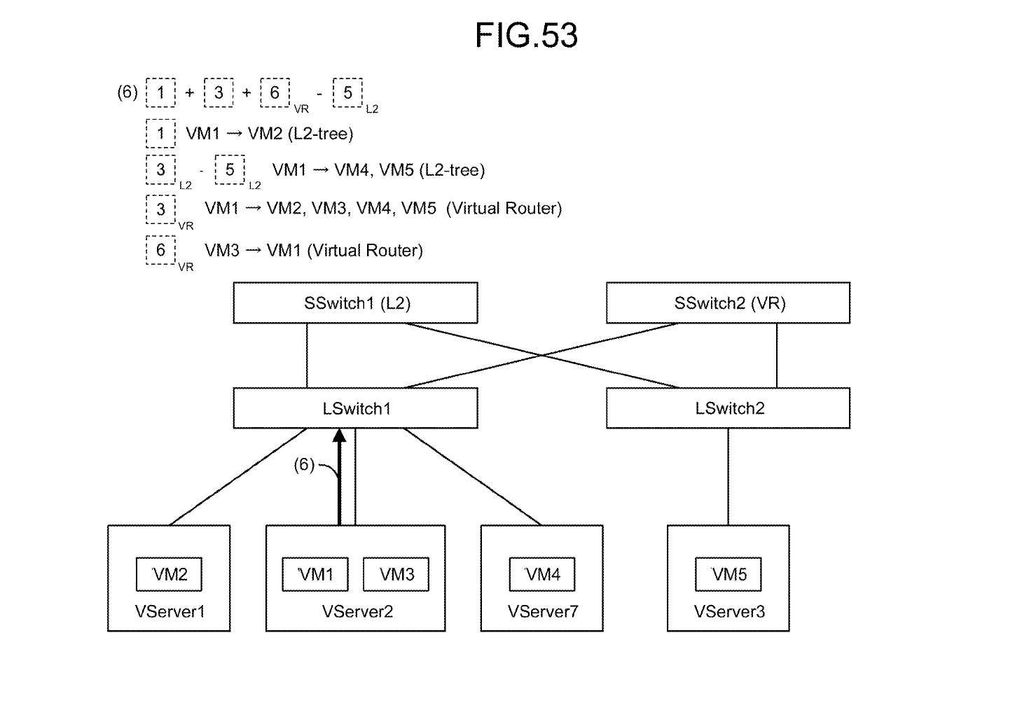

The output traffic (6) of FIG. 47 is, as illustrated in FIG. 53, the sum of intra-subnet communication (L2-tree) from the VM1 to the VM2, intra-subnet communication (L2-tree) from the VM1 to the VM4 and the VM5, inter-subnet communication (Virtual router) from the VM1 to the VM2 to the VM5, and inter-subnet communication (Virtual router) from the VM3 to the VM1. “1”, “3”, “6”, and “5” indicate output traffic for before movement which is illustrated in FIG. 48.

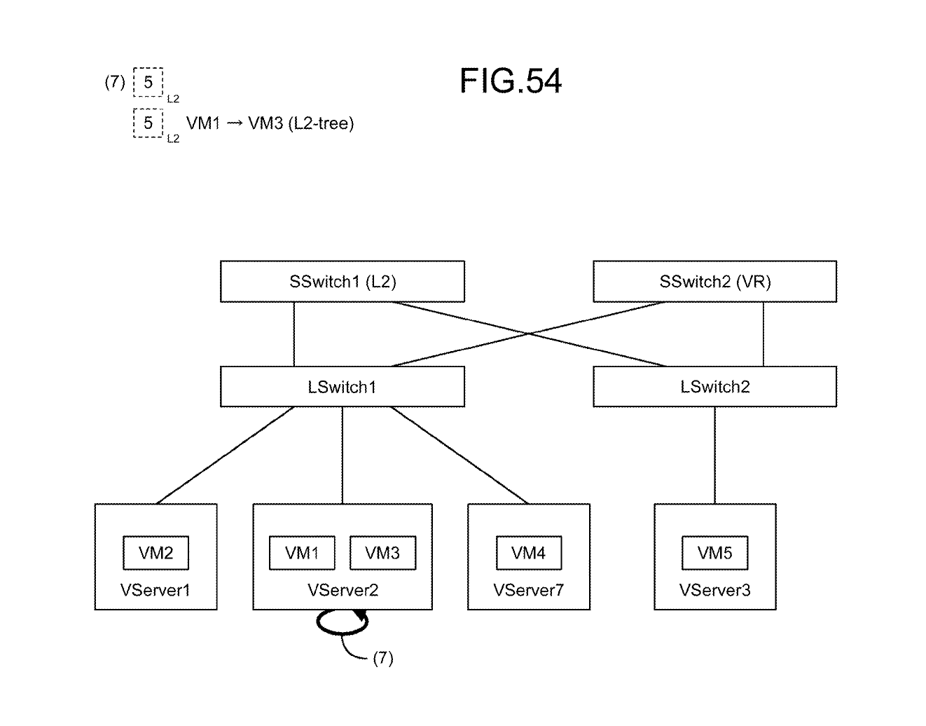

The output traffic (7) of FIG. 47 is, as illustrated in FIG. 54, intra-subnet communication (L2-tree) from the VM1 to the VM3. “5” indicates output traffic for before movement which is illustrated in FIG. 48.

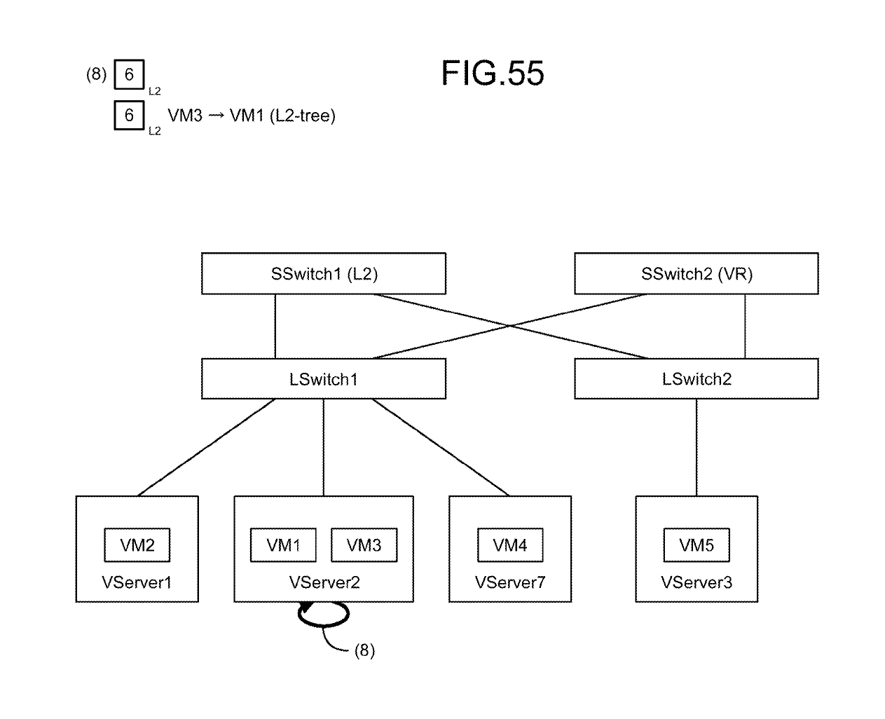

The output traffic (8) of FIG. 47 is, as illustrated in FIG. 55, intra-subnet communication (L2-tree) from the VM3 to the VM1. “6” indicates output traffic for before movement which is illustrated in FIG. 48.

(B) the Case of Moving a VM to a VServer Connected to a Different LSwitch than that Connected to the VM

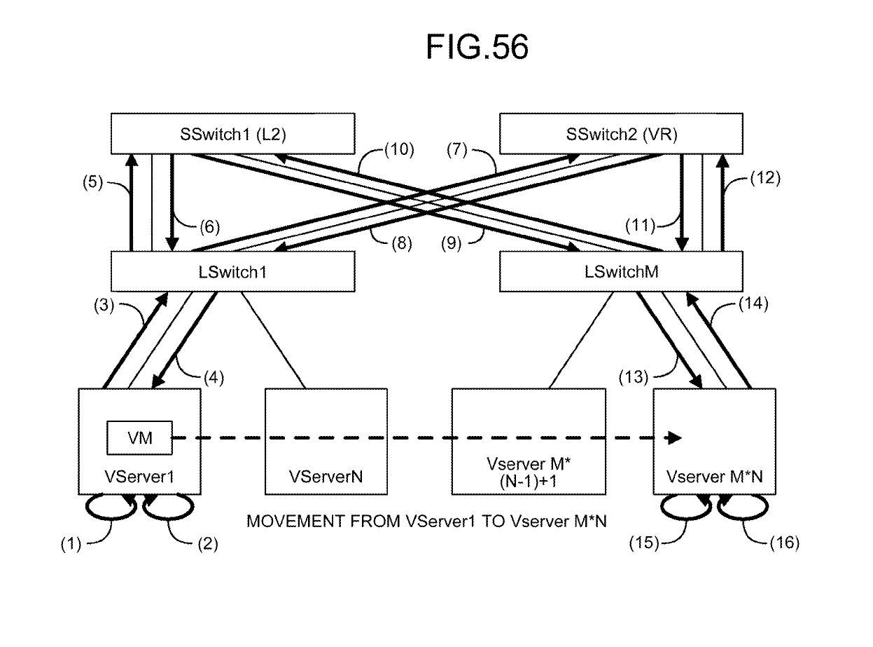

As illustrated in FIG. 56, it is assumed that, when N numbers of VServers are connected to one LSwitch and there are provided M numbers of LSwitches in total, a VM activated on the first VServer is moved to an M*Nth VServer. In this case, pieces of traffic (1) to (16) change. Specifically, there are changes such as those illustrated below.

$$\begin{matrix}( 1 ) {t}_{VS : 1 \to VS : 1 ( fromVM )} \to 0 \\ ( 2 ) {t}_{VS : 1 \to VS : 1 ( toVM )} \to 0 \\ ( 3 ) {t}_{VS : 1 \to LS} \to {t}_{VS : 1 \to VS : 1 ( toVM )} + {t ( VR )}_{VS : 1 \to LS : 1 ( toVM )} \\ ( 4 ) {t}_{LS \to VS : 1} \to {t}_{VS : 1 \to VS : 1 ( fromVM )} + {t ( VR )}_{LS : 1 \to VS : 1 ( fromVM )} \\ ( 5 ) {t}_{LS : 1 \to SS ( L 2 )} \to {t}_{VS : 1 \to VS : 1 ( toVM )} + \sum {t ( L 2 )}_{VS : k \to LS : 1 ( toVM )} ( k \text{:} 2 , … , N ) \\ ( 6 ) {t}_{SS ( L 2 ) \to LS : 1} \to {t}_{VS : 1 \to VS : 1 ( fromVM )} + \sum {t ( L 2 )}_{VS : 1 \to VS : k ( fromVM )} ( k \text{:} 2 , … , N ) \\ ( 7 ) {t}_{LS : 1 \to SS ( VR )} \to {t ( VR )}_{VS : 1 \to LS : 1 ( toVM )} + \sum {t ( VR )}_{VS : k \to LS : 1 ( toVM )} ( k \text{:} 2 , … , N ) = {t ( VR )}_{LS : 1 \to SS ( VR ) ( toVM )} \\ ( 8 ) {t}_{SS ( VR ) \to LS : 1} \to {t ( VR )}_{LS : 1 \to VS : 1 ( fromVM )} + \sum {t ( VR )}_{LS : 1 \to VS : k ( fromVM )} ( k \text{:} 2 , … , N ) = {t ( VR )}_{SS ( VR ) \to VS : 1 ( fromVM )} & ( 3 ) \\ ( 9 ) {t}_{SS ( L 2 ) \to LS : M} \to ( 3 ) + \sum {t ( L 2 )}_{LS : k \to SS ( L 2 ) ( toVM )} ( k \text{:} 2 , … , M - 1 ) \\ ( 10 ) {t}_{LS : M \to SS ( L 2 )} \to ( 4 ) + \sum {t ( L 2 )}_{SS ( L 2 ) \to LS : k ( fromVM )} ( k \text{:} 2 , … , M - 1 ) \\ ( 11 ) {t}_{SS ( VR ) \to LS : M} \to {t ( VR )}_{ss ( VR ) \to LS : 1 ( toVM )} ( = {t ( VR )}_{LS : 1 \to VS : 1 ( toVM )} ) + \sum {t ( VR )}_{LS : M \to VS : k ( fromVM )} ( k \text{:} M * ( N - 1 ) + 1 , … , M * N ) \\ ( 12 ) {t}_{LS : M \to SS ( VR )} \to {t ( VR )}_{LS : 1 \to SS ( VR ) ( fromVM )} ( = {t ( VR )}_{VS : 1 \to LS : 1 ( fromVM )} ) + \sum {t ( VR )}_{VS : k \to LS : M ( toVM )} ( k \text{:} M * ( N - 1 ) + 1 , … , M * N ) \\ ( 13 ) {t}_{LS : M \to VS : M * N} \to {t}_{VS : 1 \to VS : 1 ( toVM )} + {t}_{LS : 1 \to VS : 1 ( toVM )} + {t ( VR )}_{LS : M \to VS : M * N ( fromVM )} - {t ( L 2 )}_{VS : M * N \to LS : M ( toVM )} \\ ( 14 ) {t}_{VS : M * N \to LS : M} \to {t}_{VS : 1 \to VS : 1 ( fromVM )} + {t}_{VS : 1 \to LS : 1 ( fromVM )} + {t ( VR )}_{VS : M * N \to LS : M ( toVM )} - {t ( L 2 )}_{LS : M \to VS : M * N ( fromVM )} \\ ( 15 ) 0 \to {t ( L 2 )}_{VS : 1 \to VS : M * N ( fromVM )} \\ ( 16 ) 0 \to {t ( L 2 )}_{VS : M * N \to VS : 1 ( toVM )} & ( 4 )\end{matrix}$$

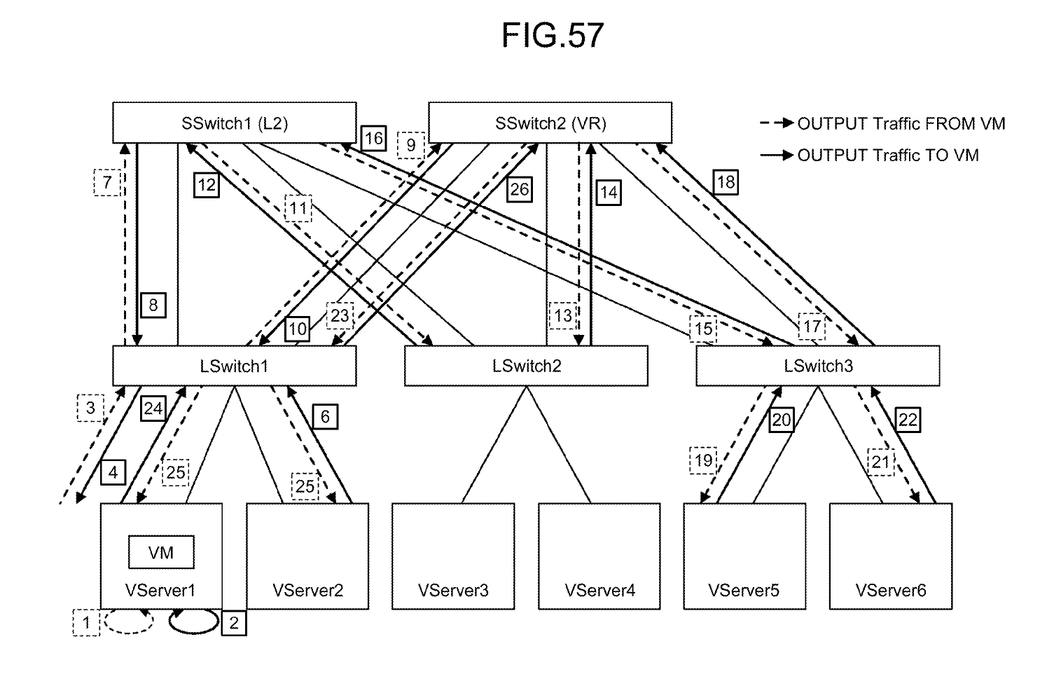

Such a case will be specifically illustrated below. Here, description is made based on traffic for before movement which is illustrated in FIG. 57. Note that it is assumed that a Virtual router is provided on the SSwitch2 side and an L2-tree is set in an SSwitch1. Then, it is assumed that the VM moves from a VServer1 to a VServer6. Furthermore, it is assumed that in FIG. 57 dashed lines indicate output traffic from the VM and solid lines indicate output traffic to the VM.

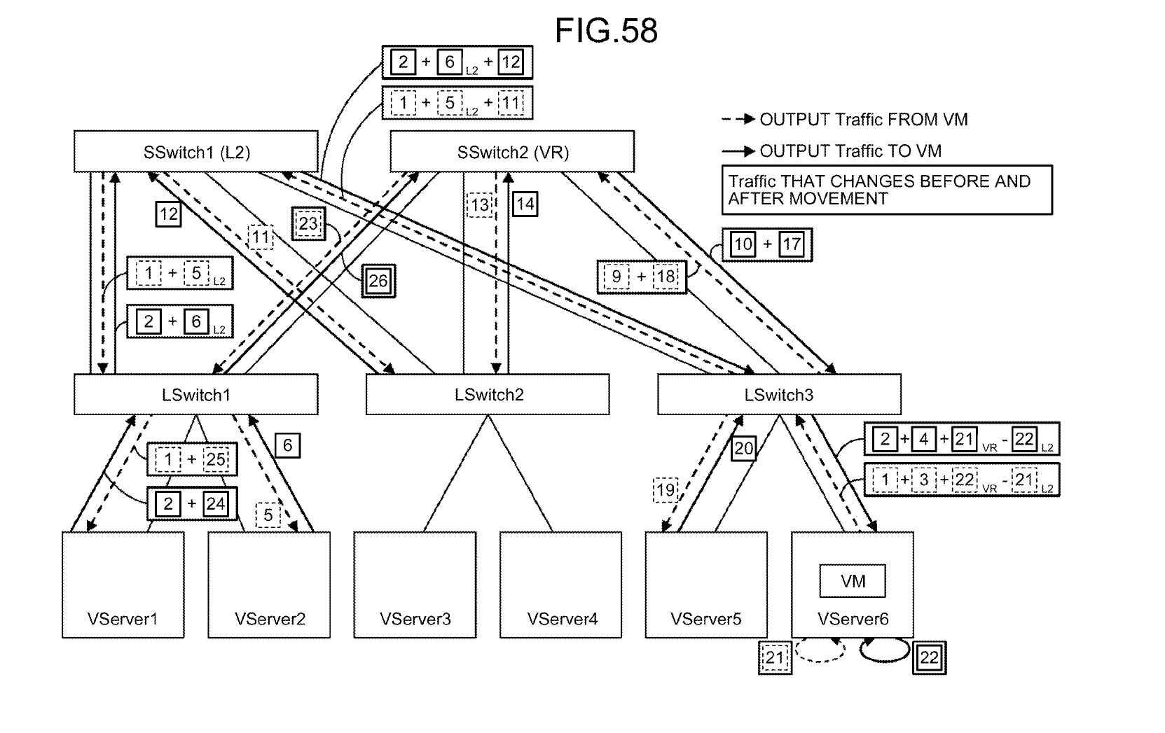

FIG. 58 illustrates traffic for after movement. Note that the traffic of the VM in the VServer1 which is the movement source changes to “0”, though not illustrated. Then, output traffic from the VServer1 to an LSwitch1, output traffic from the LSwitch1 to the VServer1, output traffic from the LSwitch1 to the SSwitch1, output traffic from the SSwitch1 to the LSwitch1, output traffic from the LSwitch1 to the SSwitch2, output traffic from the SSwitch2 to the LSwitch1, output traffic from the SSwitch1 to an LSwitch3, output traffic from the LSwitch3 to the SSwitch1, output traffic from the SSwitch2 to the LSwitch3, output traffic from the LSwitch3 to the SSwitch2, output traffic to a VM in the VServer6 and output traffic from the VM, output traffic from the VServer6 to the LSwitch3, and output traffic from the LSwitch3 to the VServer6 change.

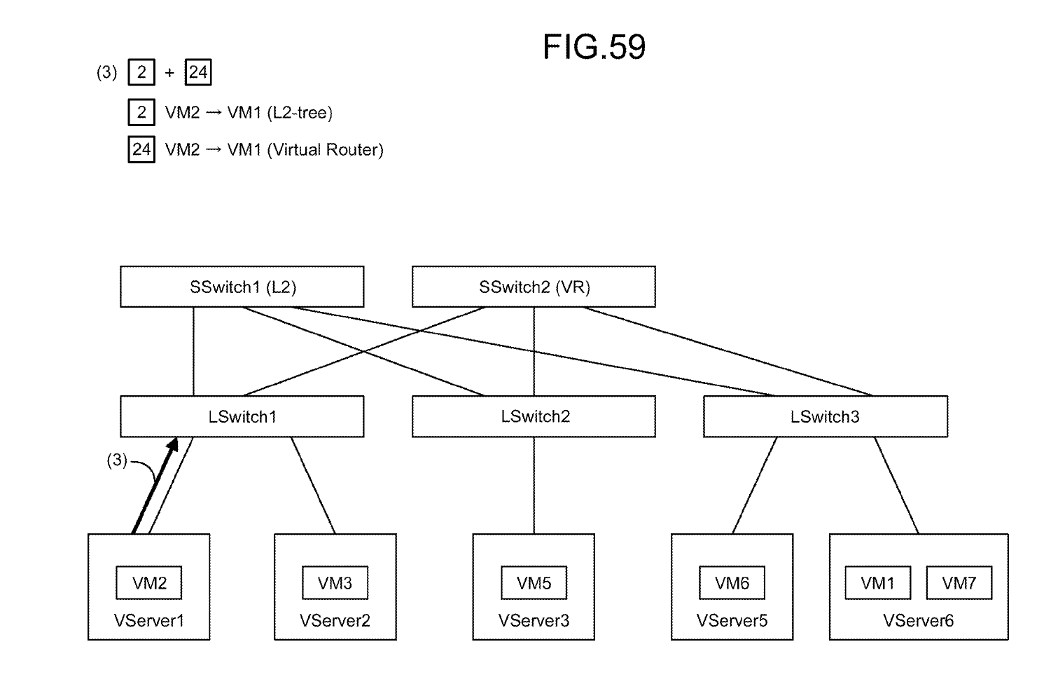

The output traffic (3) of FIG. 56 is, as illustrated in FIG. 59, the sum of intra-subnet communication (L2-tree) from a VM2 to a VM1 and inter-subnet communication (Virtual router) from the VM2 to the VM1. “2” and “24” indicate output traffic for before movement which is illustrated in FIG. 57.

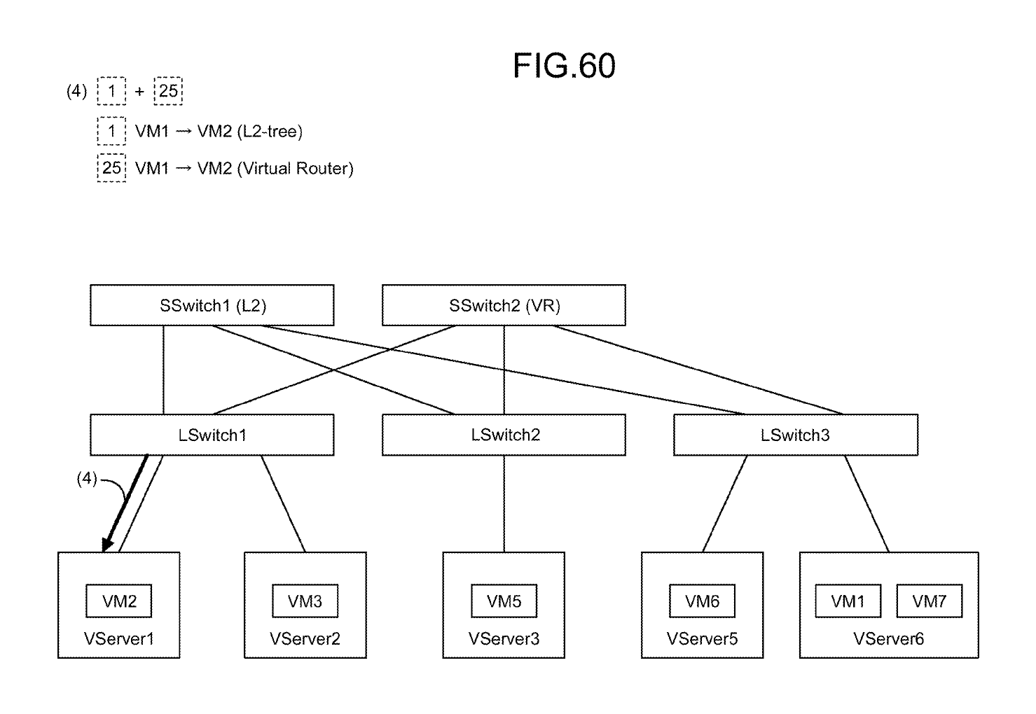

The output traffic (4) of FIG. 56 is, as illustrated in FIG. 60, the sum of intra-subnet communication (L2-tree) from the VM1 to the VM2 and inter-subnet communication (Virtual router) from the VM1 to the VM2. “1” and “25” indicate output traffic for before movement which is illustrated in FIG. 57.

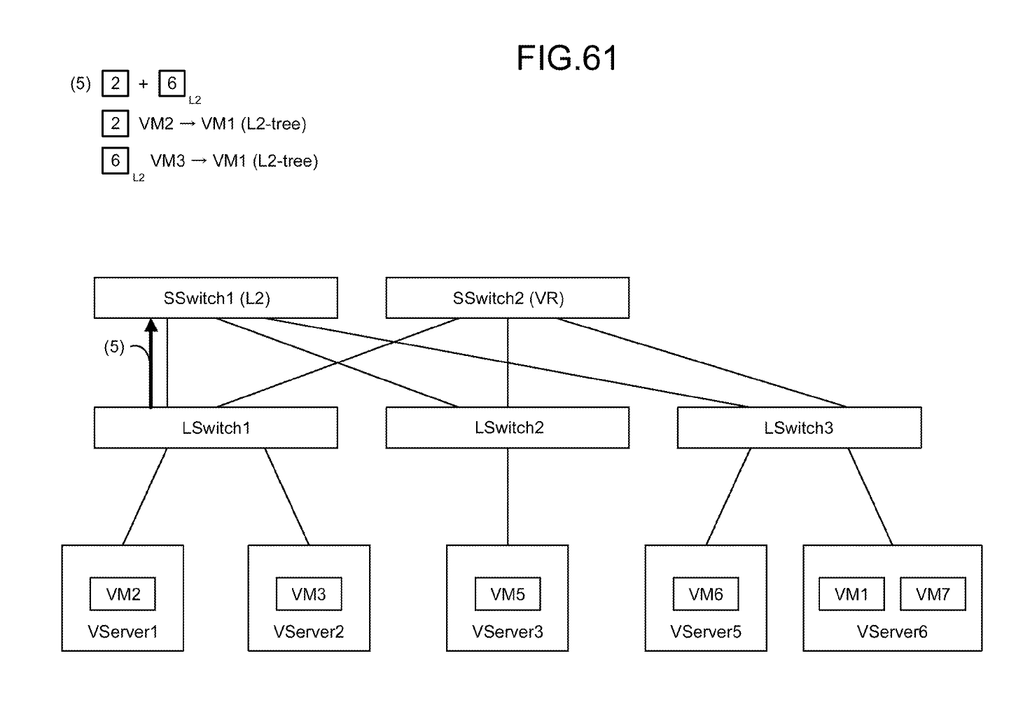

The output traffic (5) of FIG. 56 is, as illustrated in FIG. 61, the sum of intra-subnet communication (L2-tree) from the VM2 to the VM1 and intra-subnet communication (L2-tree) from a VM3 to the VM1. “2” and “6” indicate output traffic for before movement which is illustrated in FIG. 57.

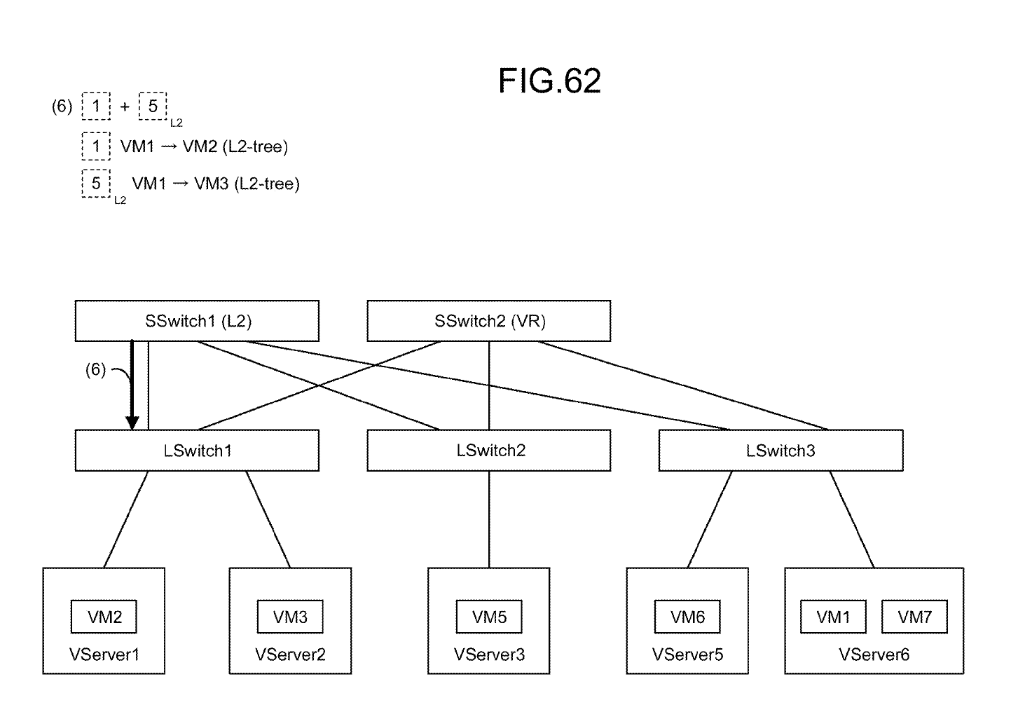

The output traffic (6) of FIG. 56 is, as illustrated in FIG. 62, the sum of intra-subnet communication (L2-tree) from the VM1 to the VM2 and intra-subnet communication (L2-tree) from the VM1 to the VM3. “1” and “5” indicate output traffic for before movement which is illustrated in FIG. 57.

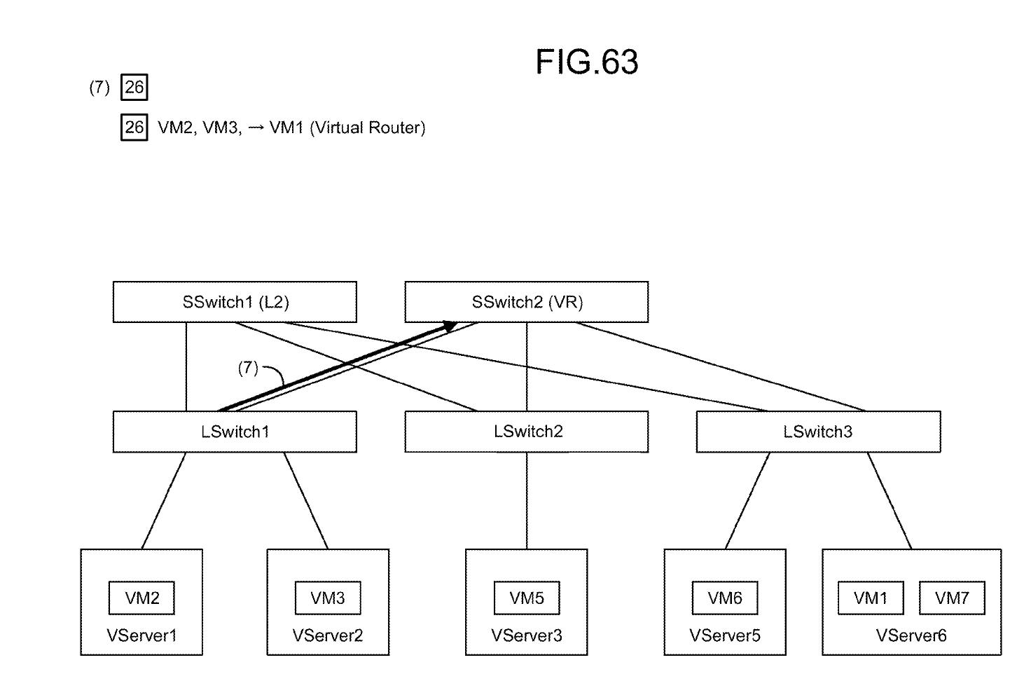

The output traffic (7) of FIG. 56 is, as illustrated in FIG. 63, inter-subnet communication (Virtual router) from the VM2 and the VM3 to the VM1. “26” indicates output traffic for before movement which is illustrated in FIG. 57.

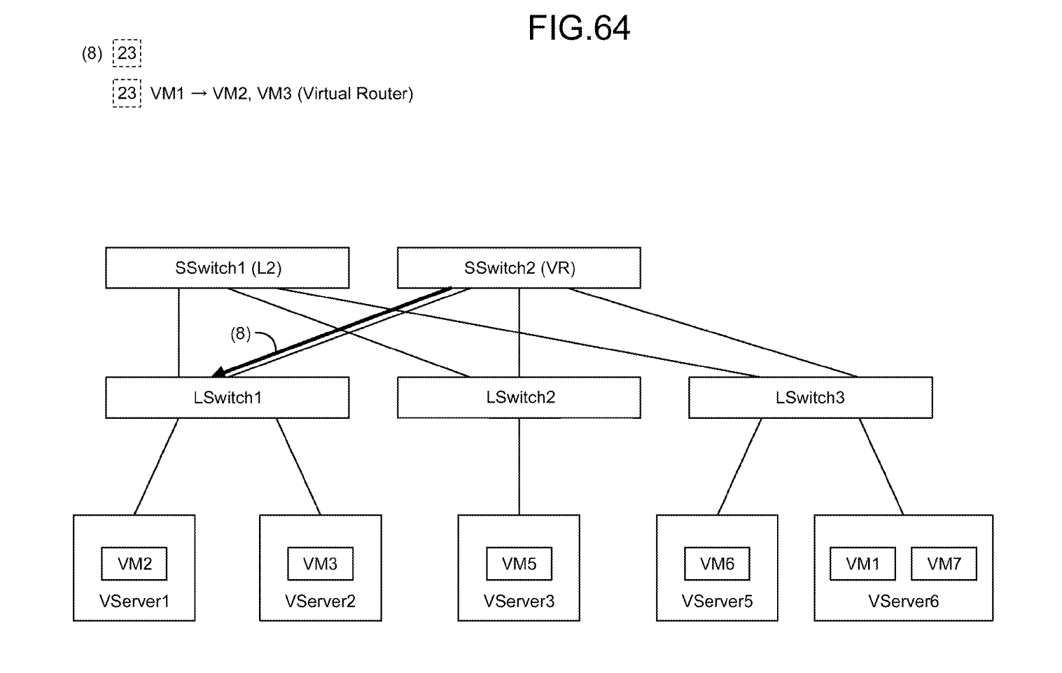

The output traffic (8) of FIG. 56 is, as illustrated in FIG. 64, inter-subnet communication (Virtual router) from the VM1 to the VM2 and the VM3. “23” indicates output traffic for before movement which is illustrated in FIG. 57.

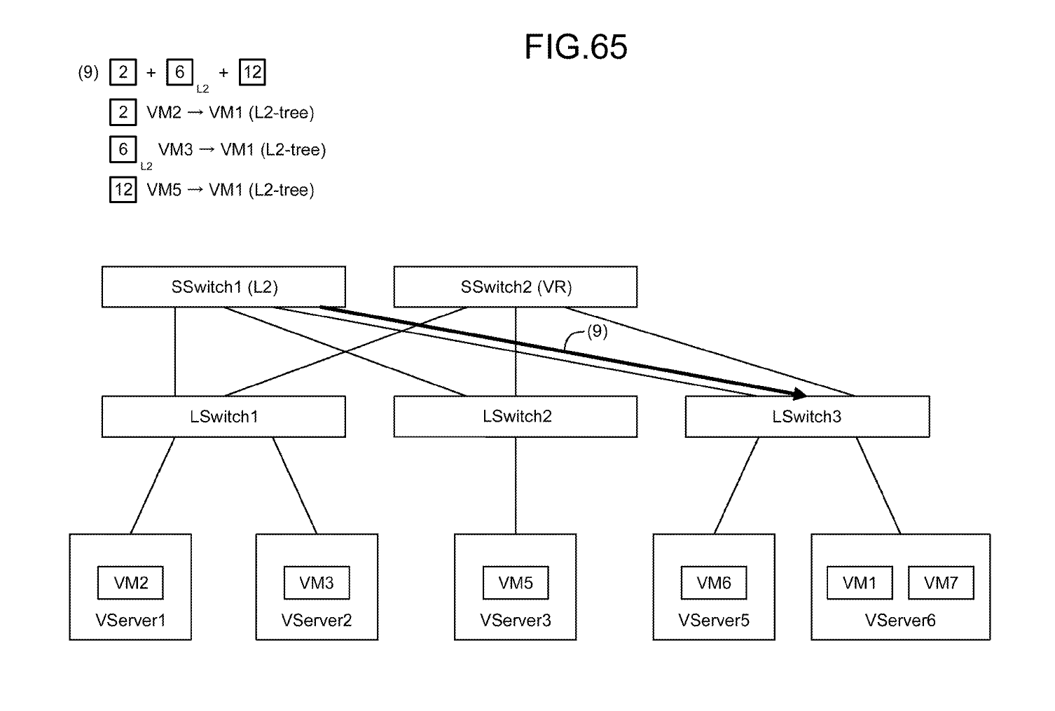

The output traffic (9) of FIG. 56 is, as illustrated in FIG. 65, the sum of intra-subnet communication (L2-tree) from the VM2 to the VM1, intra-subnet communication (L2-tree) from the VM3 to the VM1, and intra-subnet communication (L2-tree) from a VM5 to the VM1. “2”, “6”, and “12” indicate output traffic for before movement which is illustrated in FIG. 57.

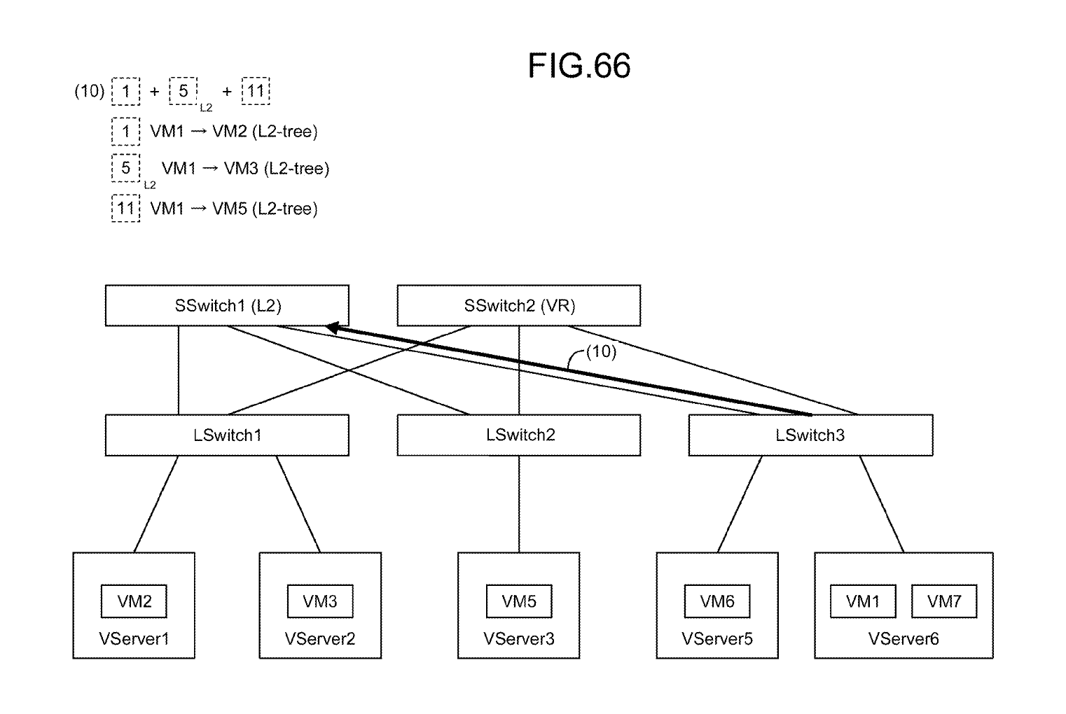

The output traffic (10) of FIG. 56 is, as illustrated in FIG. 66, the sum of intra-subnet communication (L2-tree) from the VM1 to the VM2, intra-subnet communication (L2-tree) from the VM1 to the VM3, and intra-subnet communication (L2-tree) from the VM1 to the VM5. “1”, “5”, and “11” indicate output traffic for before movement which is illustrated in FIG. 57.

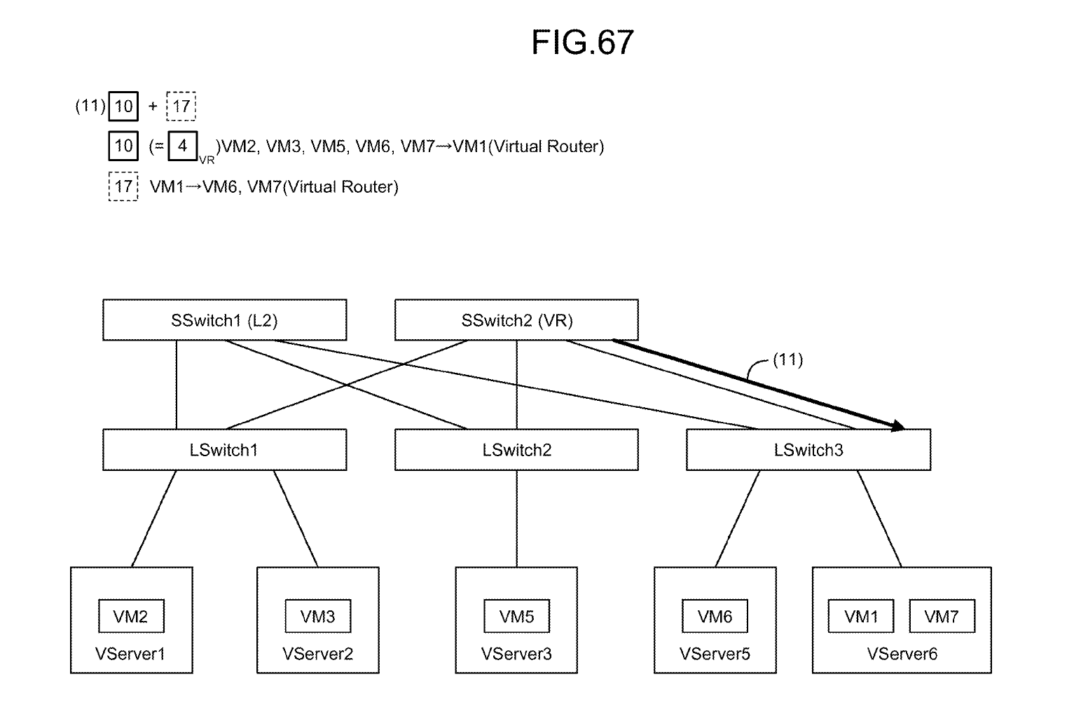

The output traffic (11) of FIG. 56 is, as illustrated in FIG. 67, the sum of inter-subnet communication (Virtual router) from the VM2, the VM3, and the VM5 to a VM7 to the VM1 and inter-subnet communication (Virtual router) from the VM1 to the VM6 and the VM7. “10” and “17” indicate output traffic for before movement which is illustrated in FIG. 57.

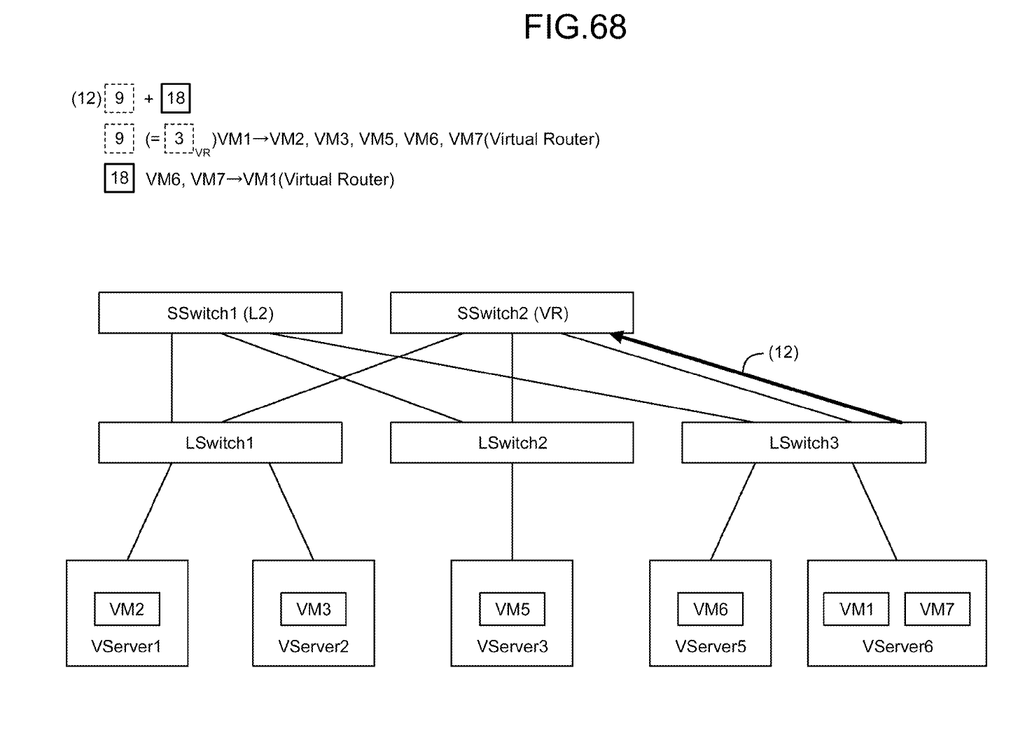

The output traffic (12) of FIG. 56 is, as illustrated in FIG. 68, the sum of inter-subnet communication (Virtual router) from the VM1 to the VM2, the VM3, and the VM5 to the VM7 and inter-subnet communication (Virtual router) from the VM6 and the VM7 to the VM1. “9” and “18” indicate output traffic for before movement which is illustrated in FIG. 57.

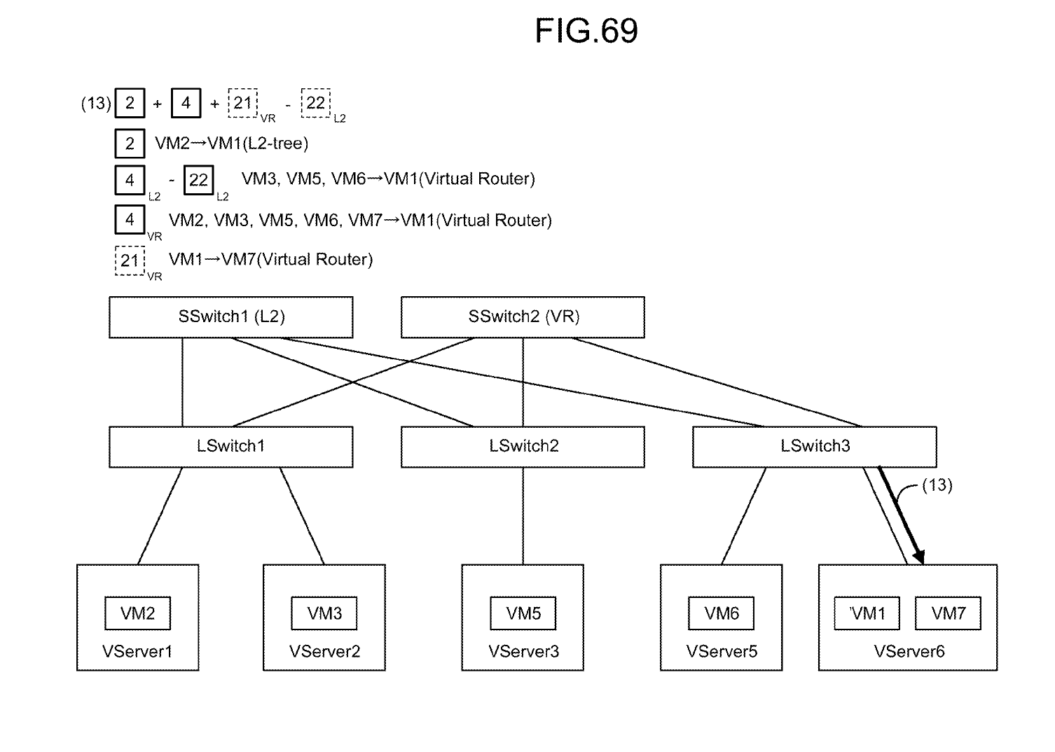

The output traffic (13) of FIG. 56 is, as illustrated in FIG. 69, the sum of intra-subnet communication (L2-tree) from the VM2 to the VM1, intra-subnet communication (L2-tree) from the VM3, the VM5, and the VM6 to the VM1, inter-subnet communication (Virtual router) from the VM2, the VM3, and the VM5 to the VM7 to the VM1, and inter-subnet communication (Virtual router) from the VM1 to the VM7. “2”, “4”, “22”, and “21” indicate output traffic for before movement which is illustrated in FIG. 57.

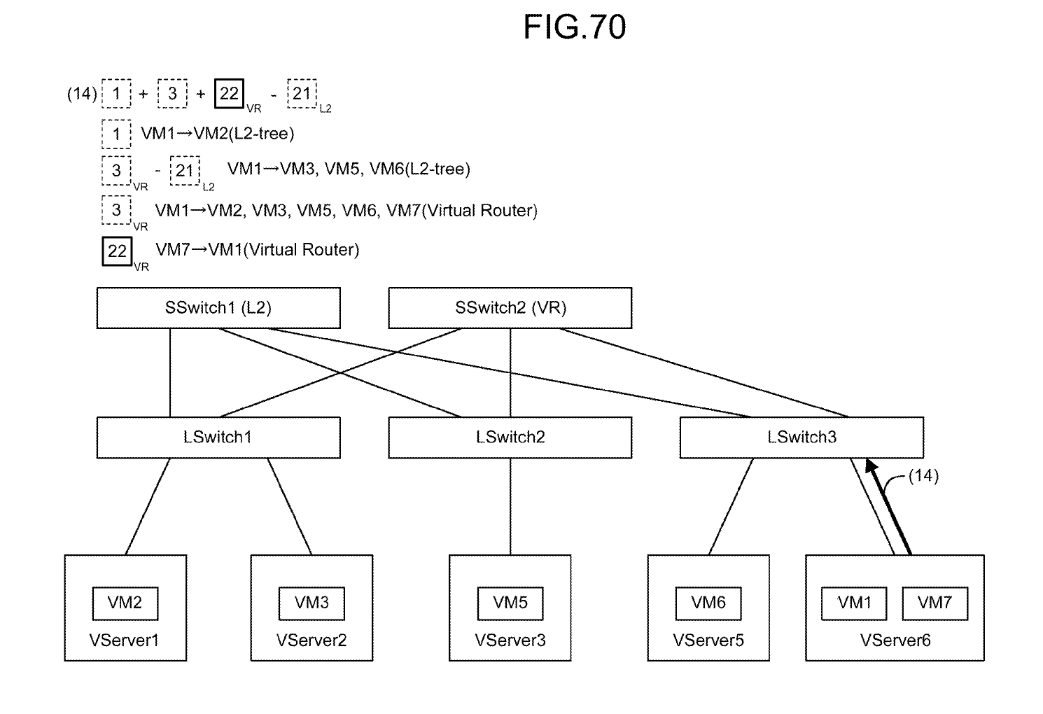

The output traffic (14) of FIG. 56 is, as illustrated in FIG. 70, the sum of intra-subnet communication (L2-tree) from the VM1 to the VM2, inter-subnet communication (Virtual router) from the VM1 to the VM3, the VM5, and the VM6, inter-subnet communication (Virtual router) from the VM1 to the VM2, the VM3, and the VM5 to the VM7, and inter-subnet communication (Virtual router) from the VM7 to the VM1. “1”, “3”, “21”, and “22” indicate output traffic for before movement which is illustrated in FIG. 57.

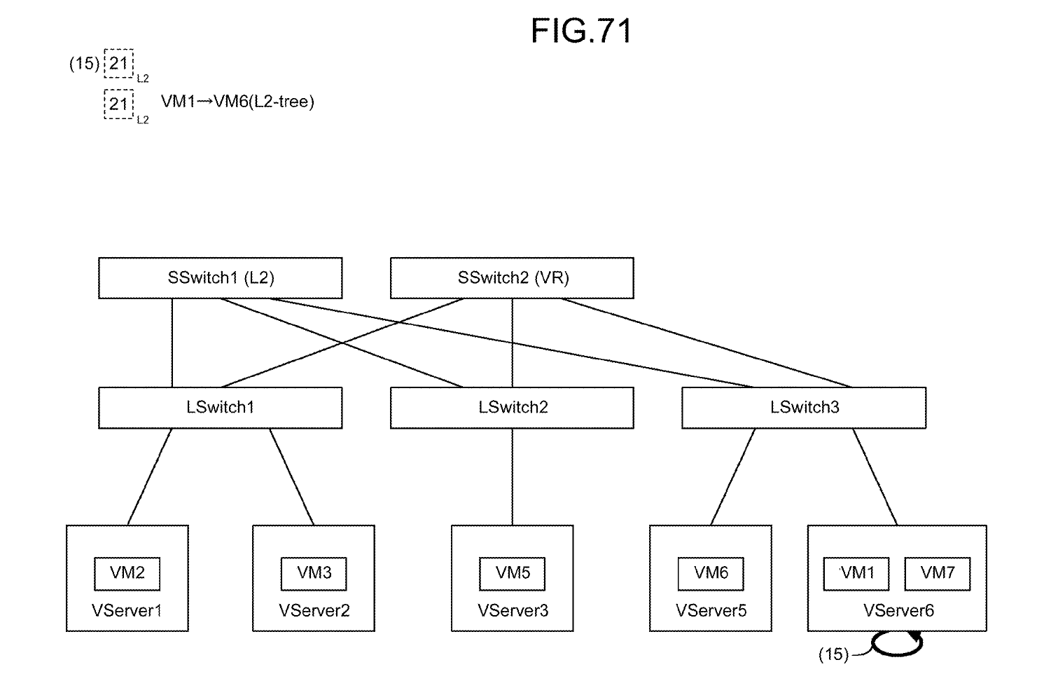

The output traffic (15) of FIG. 56 is, as illustrated in FIG. 71, intra-subnet communication (L2-tree) from the VM1 to the VM6. “21” indicates output traffic for before movement which is illustrated in FIG. 57.

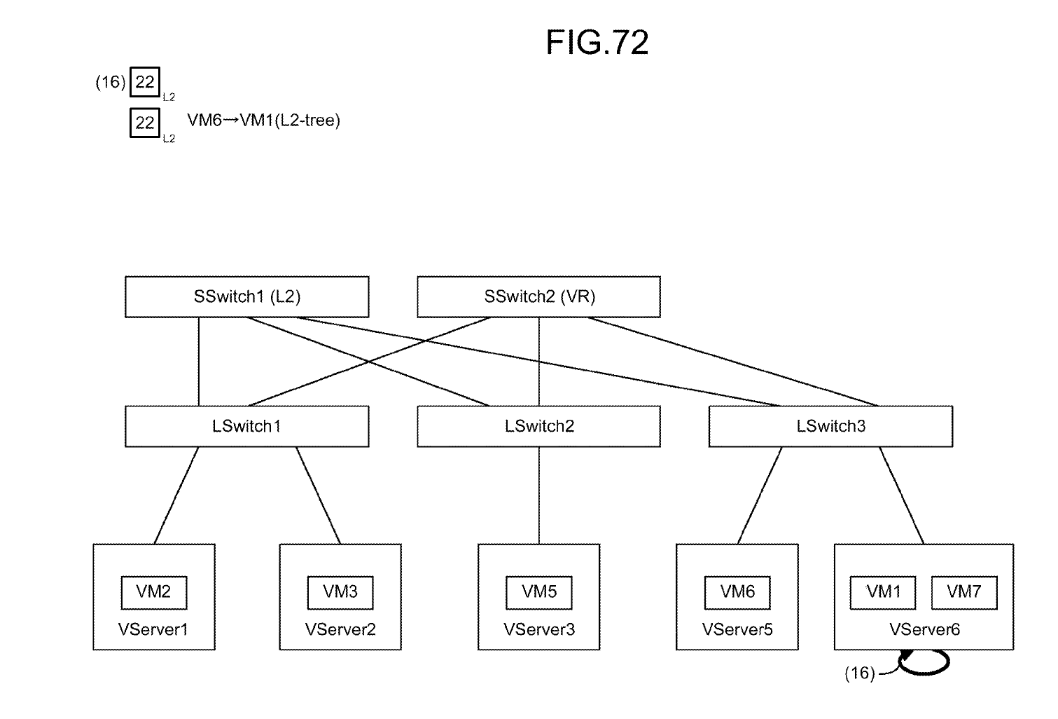

The output traffic (16) of FIG. 56 is, as illustrated in FIG. 72, intra-subnet communication (L2-tree) from the VM6 to the VM1. “22” indicates output traffic for before movement which is illustrated in FIG. 57.

Reduction in the Load on the Process of Calculating Evaluation Values for after Movement

Which movement destination is to be selected is determined using an evaluation value list. Ultimately, if an evaluation value list is smaller than an evaluation value list for before movement, then movement is actually performed. Thus, when an evaluation value greater than or equal to the largest evaluation value in an evaluation value list for before movement is calculated for any of the switches or the VServers, calculation of evaluation values for a corresponding movement destination is terminated, enabling to reduce the amount of computation.

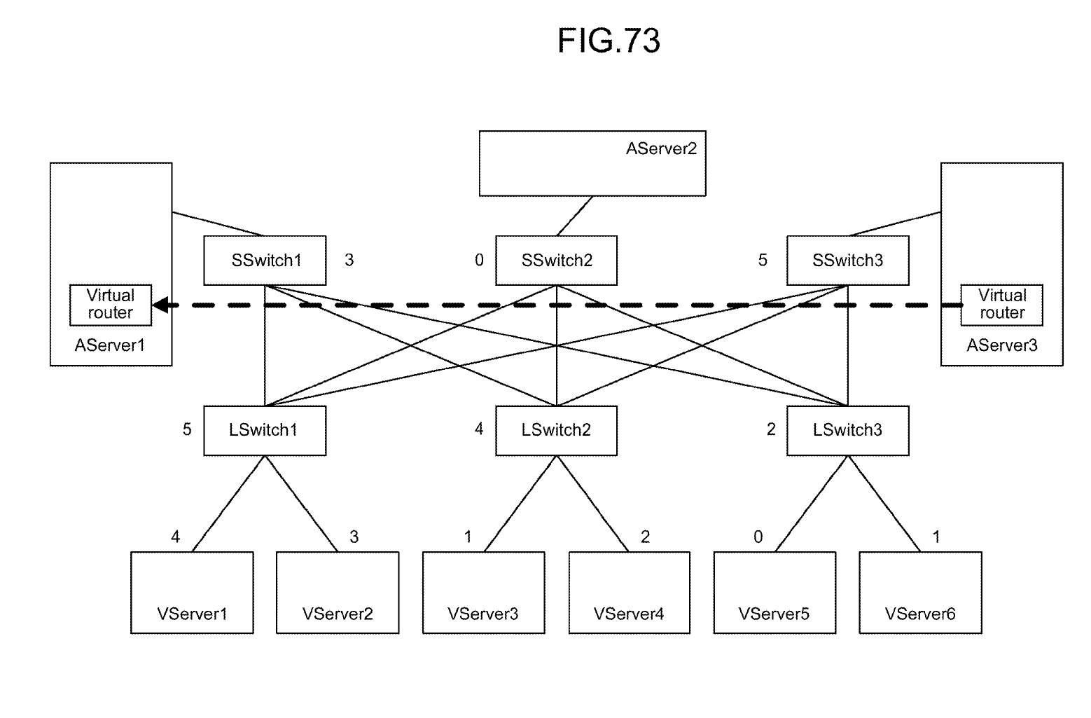

For example, an example of a state for before movement is illustrated in FIG. 73. In the example of FIG. 73, a Virtual router is activated on an AServer3. Here, the case of moving the Virtual router to an AServer1 which is a movement destination candidate is considered. Note that the largest evaluation value in an evaluation value list for before movement is “5”.

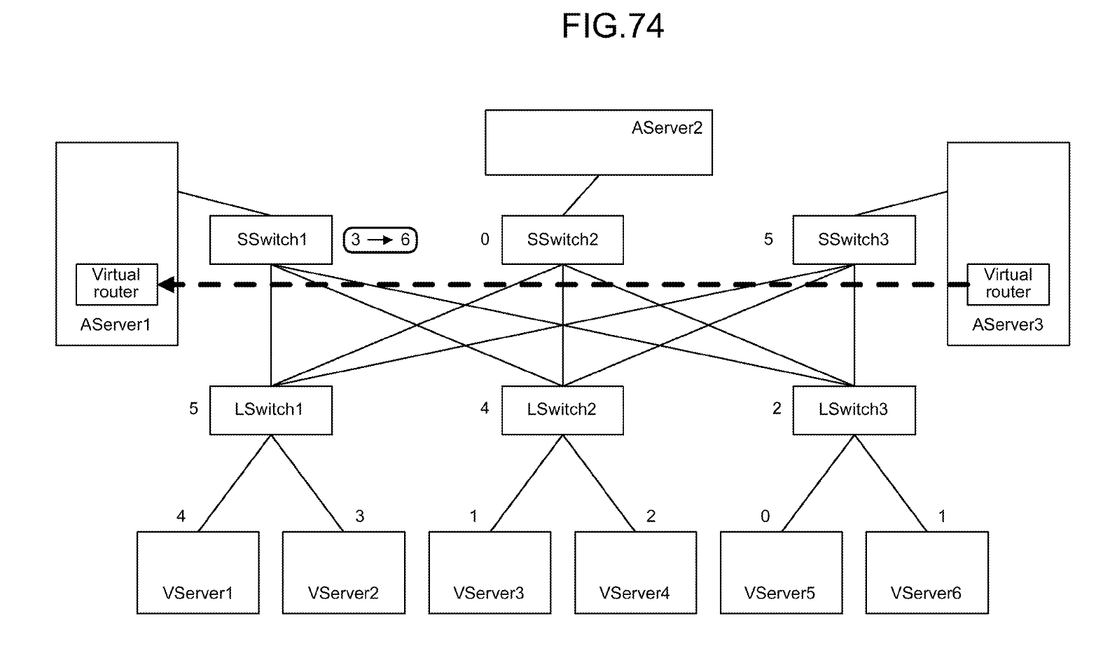

In this example, it is assumed that, as illustrated in FIG. 74, when the evaluation value of an SSwitch1 to which the movement destination AServer1 is connected is recalculated, “6” is obtained. Accordingly, the evaluation values of an SSwitch3, etc., are to be updated. However, since there is no chance of selecting the AServer1 without updating, an evaluation value calculation process for the movement destination AServer1 is terminated, and processing transitions to a process for a movement destination candidate AServer2.

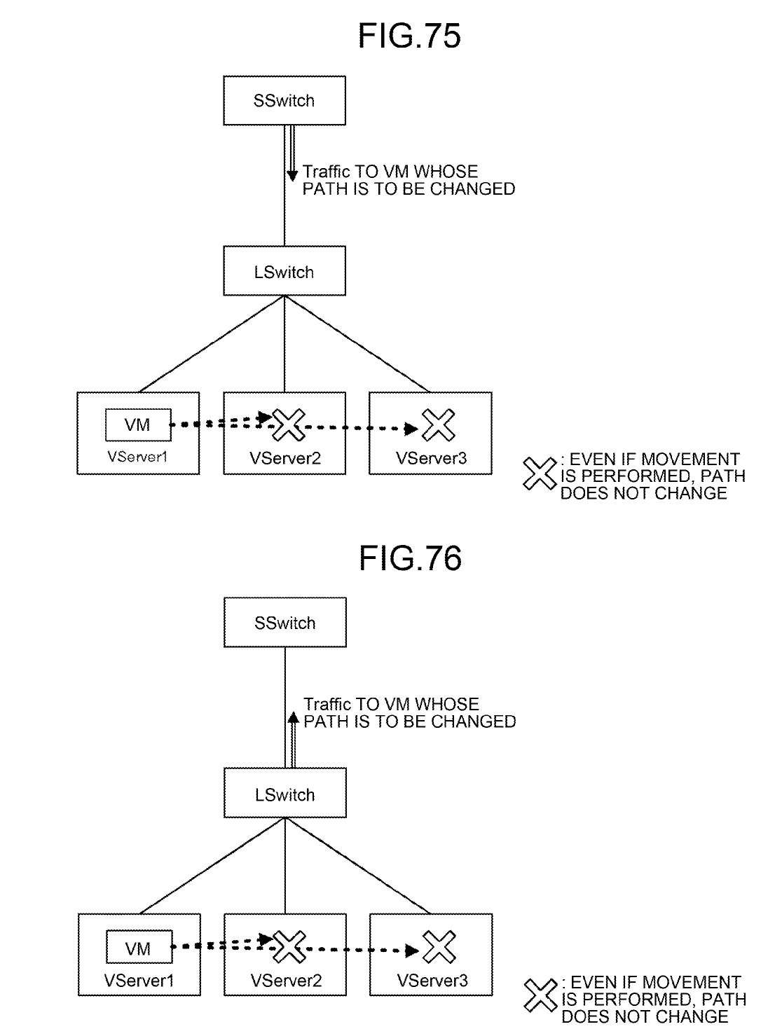

Furthermore, it is assumed that, as illustrated in FIG. 75, a downlink of an SSwitch has the largest evaluation value and thus the SSwitch is selected and a destination VM activated on a VServer1 is selected as a movement target. However, even if the destination VM is moved to a VServer2 and a VServer3 which are connected to an LSwitch to which the VServer1 is connected, the output traffic of the downlink of the SSwitch does not change. Therefore, the VServer2 and the VServer3 can be excluded from movement destination candidates. By doing this, the load on the computation of evaluation values can be reduced.

In addition, it is assumed that, as illustrated in FIG. 76, an uplink of an LSwitch has the largest evaluation value and thus the LSwitch is selected and a source VM activated on a VServer1 is selected as a movement target. However, even if the source VM is moved to a VServer2 and a VServer3 which are connected to the LSwitch to which the VServer1 is connected, the output traffic of the uplink of the LSwitch does not change. Therefore, the VServer2 and the VServer3 can be excluded from movement destination candidates. By doing this, the load on the computation of evaluation values can be reduced.

Although the embodiment of the present invention is described above, the present invention is not limited thereto. The functional block configuration of the resource controller 1000 illustrated in FIG. 7 is an example and thus may not match a program module configuration or a file configuration.

For a processing flow, too, as long as processing results do not change, the order in which processing steps are performed may be changed or a plurality of steps may be performed in parallel.

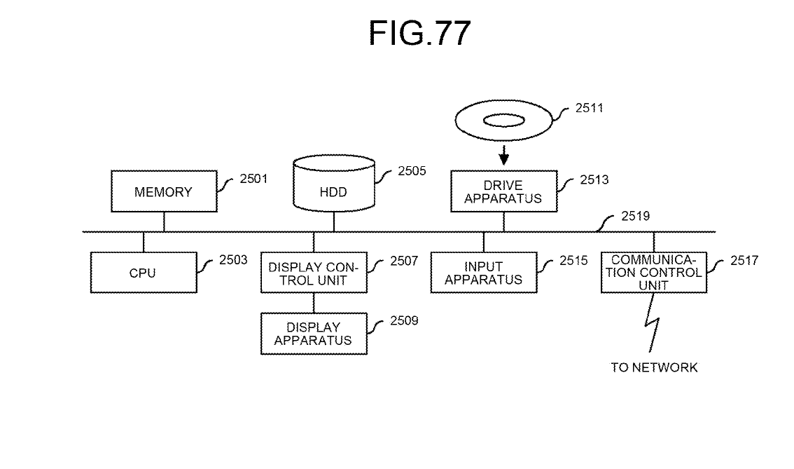

Note that the above-described resource controller 1000 is a computer apparatus and, as illustrated in FIG. 77, a memory 2501, a Central Processing Unit (CPU) 2503, a hard disk drive (HDD) 2505, a display control unit 2507 connected to a display apparatus 2509, a drive apparatus 2513 for a removable disk 2511, an input apparatus 2515, and a communication control unit 2517 used to connect to a network are connected to each other by a bus 2519. An operating system (OS) and an application program for performing the processes of the present implementation example are stored in the HDD 2505. When the operating system and the application program are executed by the CPU 2503, the operating system and the application program are read into the memory 2501 from the HDD 2505. The CPU 2503 controls the display control unit 2507, the communication control unit 2517, and the drive apparatus 2513, according to the processing contents of the application program to allow them to perform predetermined operation. In addition, for data in the middle of processing is mainly stored in the memory 2501, but may be stored in the HDD 2505. In an implementation example of the present technique, the application program for performing the above-described processes is stored in the computer-readable removable disk 2511 and distributed and then installed on the HDD 2505 through the drive apparatus 2513. The application program may be installed on the HDD 2505 via a network such as the Internet and the communication control unit 2517. Such a computer apparatus implements various types of functions such as those described above, by hardware such as the above-described CPU 2503 and the memory 2501 and programs such as the OS and the application program organically cooperating with each other.

The above-described embodiment is summarized as follows.

An information processing system according to the present embodiment includes: (A) a plurality of first information processing apparatuses where a virtual machine belonging to at least any one of a plurality of subnets is activated; (B) a plurality of second information processing apparatuses where a virtual router used for inter-subnet communication is activated; (C) a control apparatus that controls intra-subnet communication paths, disposition of the virtual machines, and disposition of the virtual routers; and (D) a plurality of switches that connect the plurality of first information processing apparatuses, the plurality of second information processing apparatuses, and the control apparatus. The above-described plurality of switches include: (d1) a plurality of first switches connected to the plurality of first information processing apparatuses; and (d2) a plurality of second switches connected to the plurality of second information processing apparatuses. In addition, each of the plurality of first switches is connected to two or more of the plurality of second switches. Furthermore, the above-described control apparatus: (c1) selects any one of a virtual machine, a virtual router, and any one of the intra-subnet communication paths, based on a predetermined evaluation value for the amount of communication of each of the plurality of first information processing apparatuses and a predetermined evaluation value for the amount of communication of each of the plurality of switches, and changes a disposition destination of the selected virtual machine or virtual router, or the selected intra-subnet communication path.

It becomes possible to level out network load which is not able to be overcome by simply moving only a virtual machine or changing a communication path between switches. Namely, the most appropriate change target in terms of leveling out of network load can be selected from a first information processing apparatus which is a disposition destination of a virtual machine, a second information processing apparatus which is a disposition destination of a virtual router, and any one of the intra-subnet communication paths, based on the amounts of communication of physical apparatuses.

In addition, the above-described control apparatus may: (c2) select any one of physical apparatuses including the plurality of first information processing apparatuses and the plurality of switches, based on the predetermined evaluation value for the amount of communication of each of the plurality of first information processing apparatuses and the predetermined evaluation value for the amount of communication of each of the plurality of switches; and (c3) combine together data flows associated with the selected physical apparatus, on at least any one of a per virtual machine basis, a per inter-subnet basis, and a per intra-subnet basis, and select any one of change targets including the virtual machines, the virtual routers, and the intra-subnet communication paths, based on the combining results. By narrowing down a physical apparatus first and then combining data flows together, a change target can be determined. Thus, a change target effective for leveling out of network load can be selected while reducing processing load.

Furthermore, the above-described control apparatus may: (c4) identify a predetermined evaluation value for the amount of communication of each of the plurality of first information processing apparatuses and a predetermined evaluation value for the amount of communication of each of the plurality of switches, for each of a plurality of cases in which the selected change target is supposedly changed to change destination candidates; (c5) identify one of the plurality of cases that satisfies a condition about leveling out of the predetermined evaluation values, based on the predetermined evaluation value for the amount of communication of each of the plurality of first information processing apparatuses and the predetermined evaluation value for the amount of communication of each of the plurality of switches; and (c6) change the selected change target to a change destination candidate, according to the identified case. By doing this, a change destination candidate effective for leveling out can be identified.

Furthermore, each of the above-described predetermined evaluation values may be the largest value or average value of output traffic.

In addition, the above-described condition may include a condition that it is a case of the smallest evaluation value list among evaluation value lists for a plurality of cases obtained by arranging the predetermined evaluation value for the amount of communication of each of the plurality of first information processing apparatuses and the predetermined evaluation value for the amount of communication of each of the plurality of switches in descending order; and a condition that the smallest evaluation value list is smaller than a current evaluation value list.

Note that a program for causing a computer to perform processes such as those described above can be created. The program is stored in, for example, a flexible disk, an optical disk such as a CD-ROM, a magneto-optical disk, a semiconductor memory (e.g., a ROM), a computer-readable storage medium, such as a hard disk, or a storage apparatus. Note that data in the middle of processing is temporarily saved in a storage apparatus such as a RAM.

Creation of a Movement Target List

When a movement target and a movement destination are determined, the above-described resource controller 1000 performs movement of the movement target, as illustrated in step S53 of FIG. 24. The resource controller 1000 may perform a plurality of movements all at once. Hence, the case will be described in which the resource controller 1000 creates a movement target list in which a plurality of movements are put together. Here, the movement target list is a list including, as one entry, a set of a movement target, a Server which is a movement source, and a Server which is a movement destination, and is stored in the management data storage unit 1400. In addition, the Server is an AServer or a VServer. In addition, the change control unit 1200 illustrated in FIG. 7 changes an L2-tree based on the movement target list, and the movement control unit 1300 controls the movement of a Virtual object based on the movement target list.

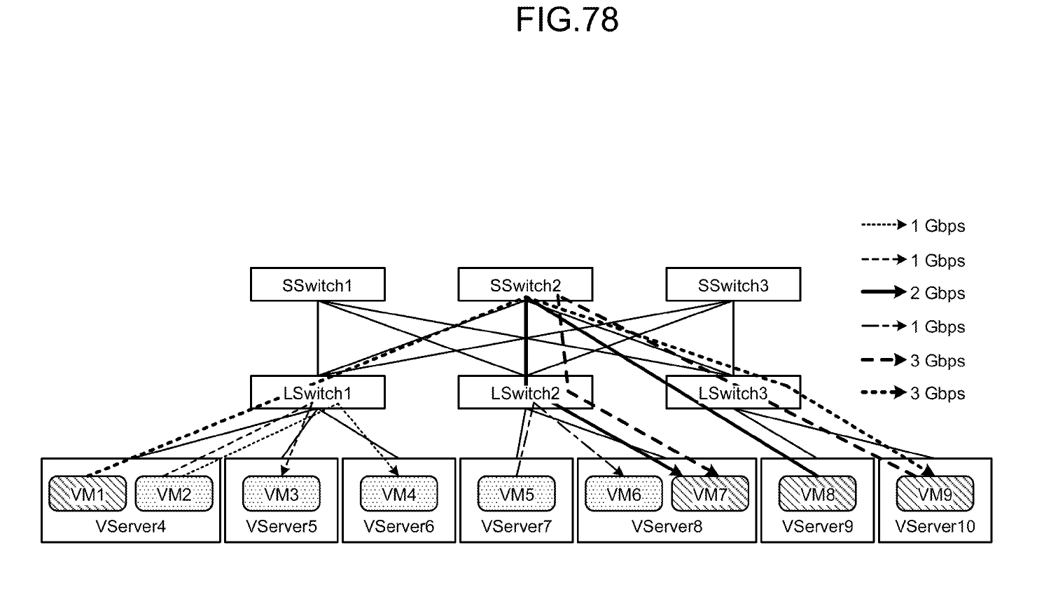

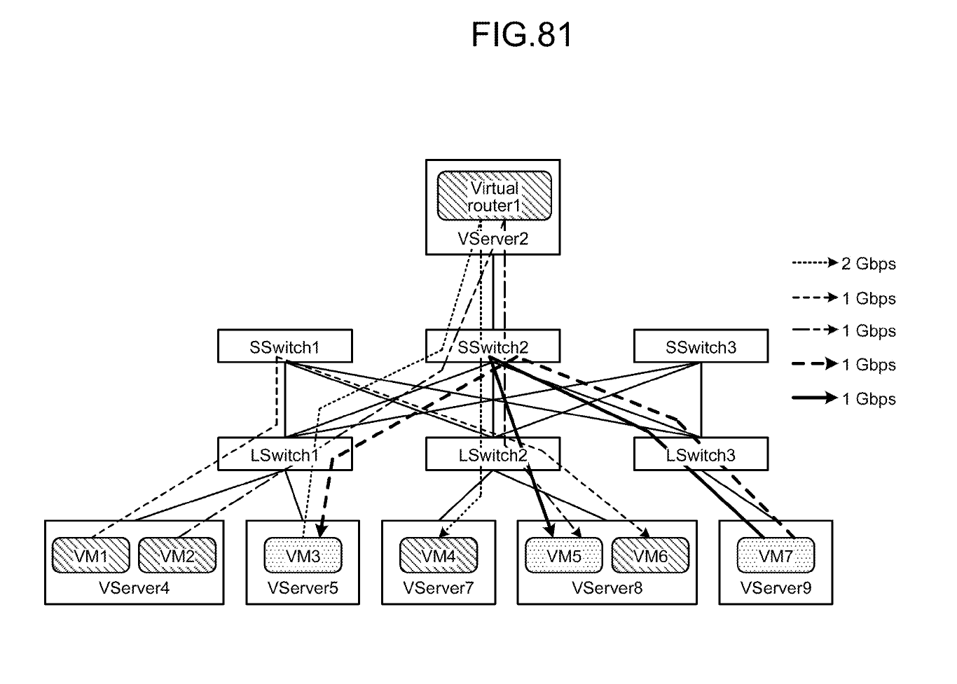

The movement target list may include a plurality of identical movement targets. FIGS. 78 to 80 are diagrams for describing a first example in which a movement target list includes a plurality of identical movement targets, and FIGS. 81 to 83 are diagrams for describing a second example in which a movement target list includes a plurality of identical movement targets.

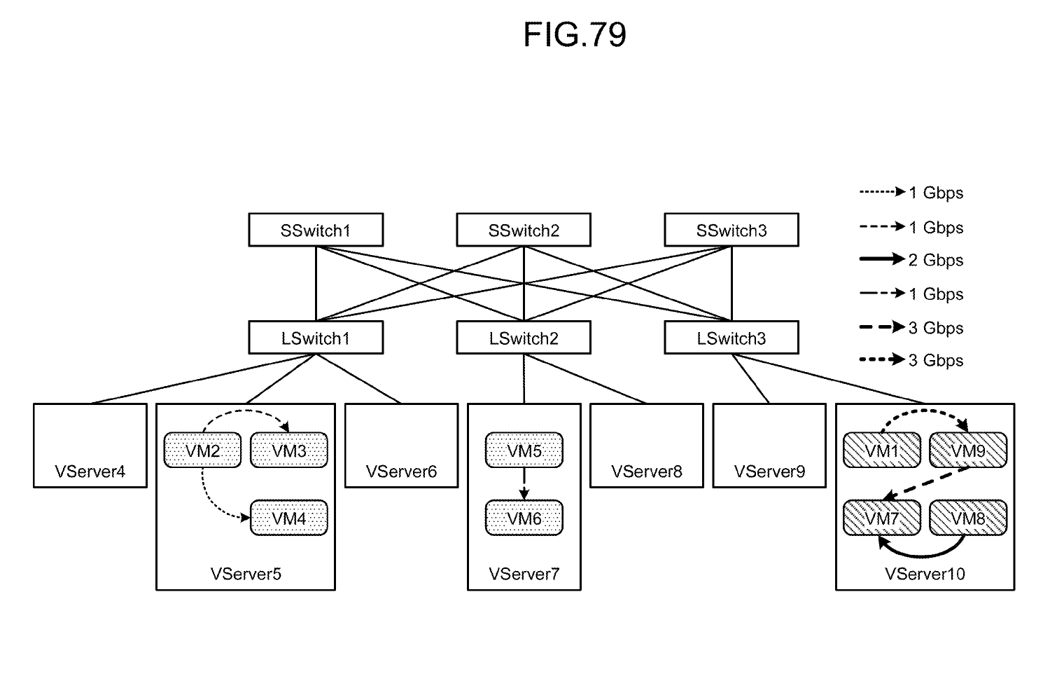

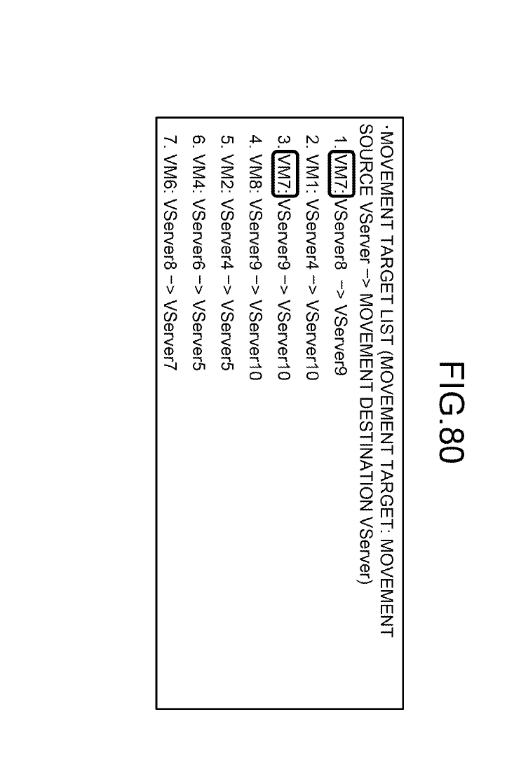

For the first example, FIG. 78 illustrates a state for before movement, FIG. 79 illustrates a state for after movement, and FIG. 80 illustrates a movement target list. Comparing FIGS. 78 and 79, a VM1 is moved from a VServer4 to a VServer10, a VM7 is moved from a VServer8 to the VServer10, and a VM8 is moved from a VServer9 to the VServer10. In addition, a VM2 is moved from the VServer4 to a VServer5, a VM4 is moved from a VServer6 to the VServer5, and a VM6 is moved from the VServer8 to a VServer7.

At this time, in the state of traffic illustrated in FIG. 78, the VM7 is not directly moved from the VServer8 to the VServer10, but as illustrated in the movement target list of FIG. 80, the VM7 is moved from the VServer8 to the VServer9 and then moved from the VServer9 to the VServer10. Namely, a single movement is performed by two separate, redundant movements. Therefore, due to the wasted movement, the load on the VServers increases. As such, when a movement target list includes a plurality of identical movement targets, due to wasted movement, the load on VServers increases.

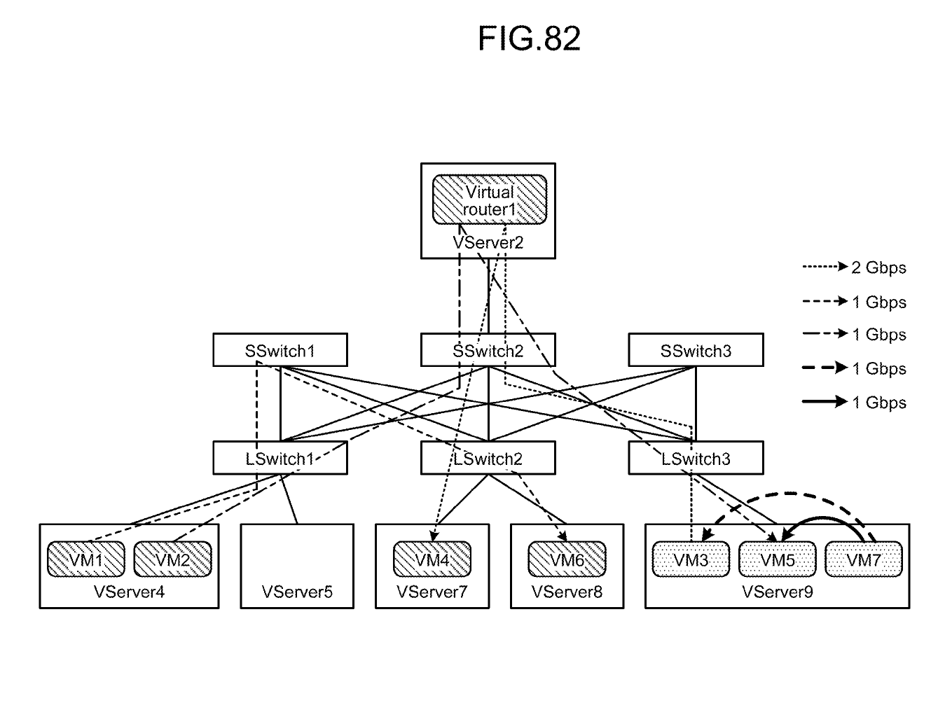

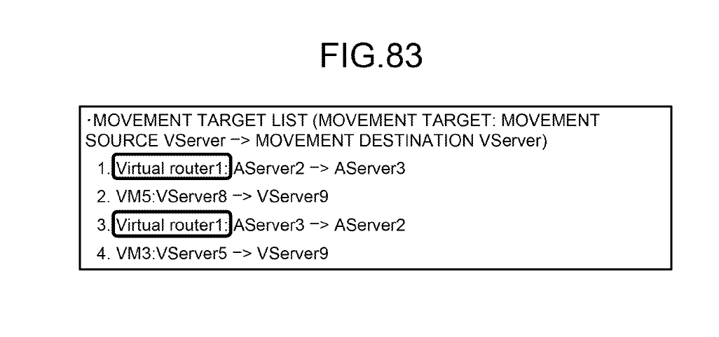

In addition, for the second example, FIG. 81 illustrates a state for before movement, FIG. 82 illustrates a state for after movement, and FIG. 83 illustrates a movement target list. Comparing FIGS. 81 and 82, a VM3 is moved from a VServer5 to a VServer9 and a VM5 is moved from a VServer8 to the VServer9, but a Virtual router1 is not moved. However, in the state of traffic illustrated in FIG. 81, as illustrated in the movement target list of FIG. 83, the Virtual router1 performs back-and-forth movement where the Virtual router1 is moved from an AServer2 to an AServer3 and then moved back to the AServer2 from the AServer3. Therefore, due to the wasted movement, the load on the AServers increases. As such, when a movement target list includes a plurality of identical movement targets, due to wasted movement, the load on AServers increases.

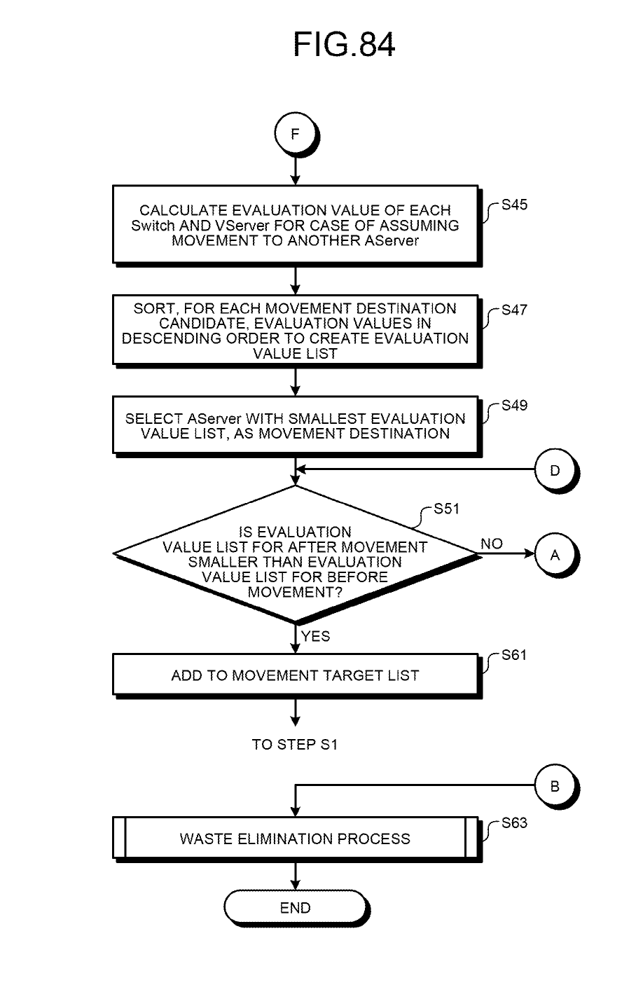

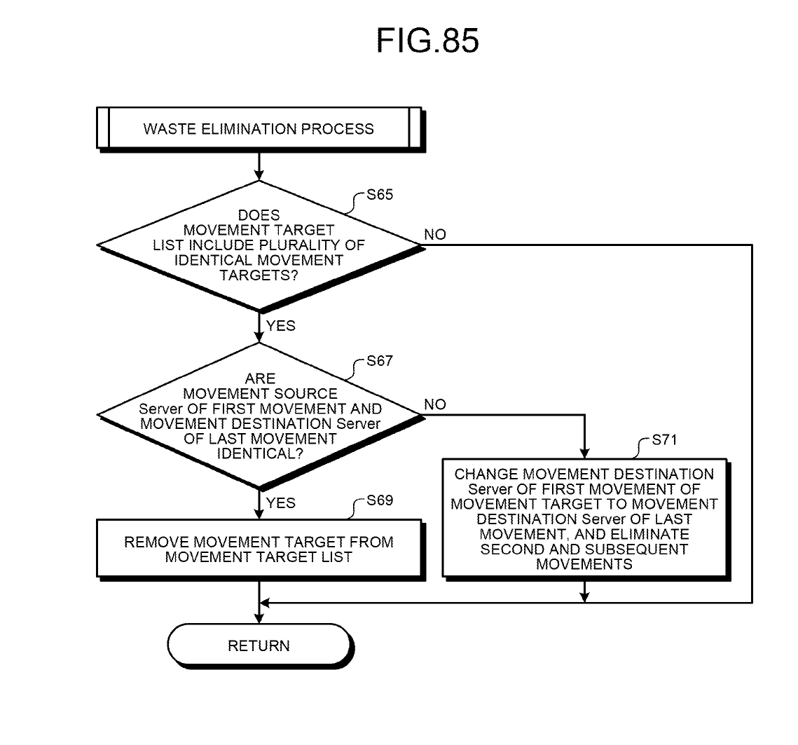

Hence, the resource controller 1000 creates a movement target list such that identical movement targets are not included in the movement target list. FIGS. 84 and 85 are diagrams illustrating a processing flow of the process of avoiding inclusion of identical movement targets in a movement target list. FIG. 84 is a processing flow obtained by changing a part of the processing flow illustrated in FIG. 24.

As illustrated in FIG. 84, compared with FIG. 24, the control unit 1101 adds movement information to a movement target list (step S61) instead of performing movement, and returns to step S1. In addition, if the condition for changing a disposition destination of a VM or a VR, or an L2-tree is not satisfied (step S1 of FIG. 10: No route), the control unit 1101 proceeds to step S63 through the terminal B and performs a waste elimination process before ending the process of creating a movement target list.

FIG. 85 illustrates a processing flow of a waste elimination process. As illustrated in FIG. 85, the control unit 1101 determines whether the movement target list includes a plurality of identical movement targets (step S65). If the condition at step S65 is not satisfied, the control unit 1101 ends the waste elimination process.

On the other hand, if the condition at step S65 is satisfied, the control unit 1101 determines whether a movement source Server of the first movement and a movement destination Server of the last movement are identical (step S67). If the condition at step S67 is satisfied, it is circulating movement of returning to an original Server by a plurality of movements. Thus, the control unit 1101 removes the movement targets from the movement target list (step S69). On the other hand, if the condition at step S67 is not satisfied, the control unit 1101 changes a movement destination Server of the first movement of the movement target to a movement destination Server of the last movement, and eliminates the second and subsequent movements (step S71).

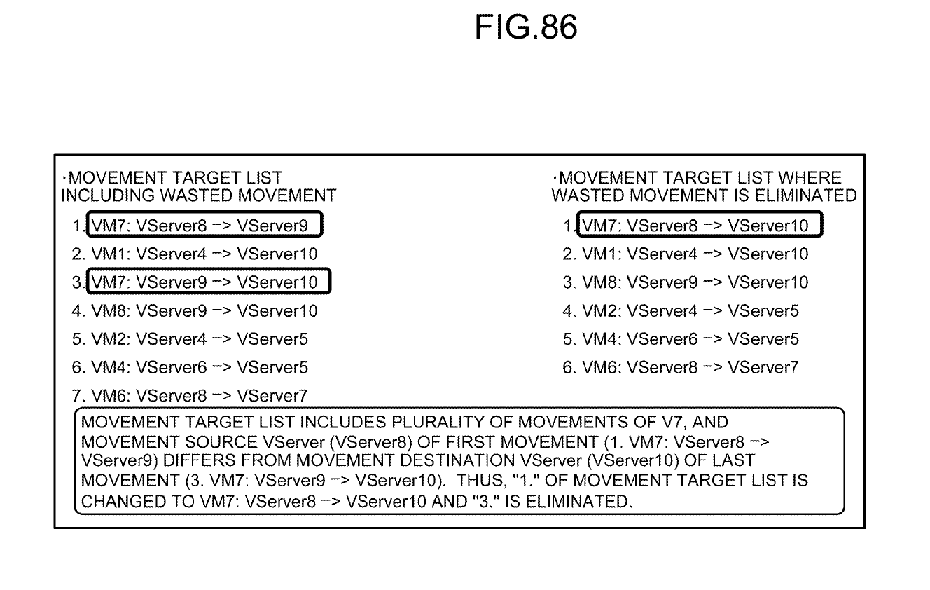

FIG. 86 is a diagram illustrating the results of avoiding inclusion of identical movement targets in a movement target list in the first example. As illustrated in FIG. 86, in a movement target list including wasted movement, the first entry includes movement of a VM7 from a VServer8 to a VServer9, and the third entry includes movement of the VM7 from the VServer9 to a VServer10. On the other hand, in a movement target list where the wasted movement is eliminated, the movement destination of the first entry is changed to the VServer10, and the third entry in the movement target list including wasted movement is eliminated.

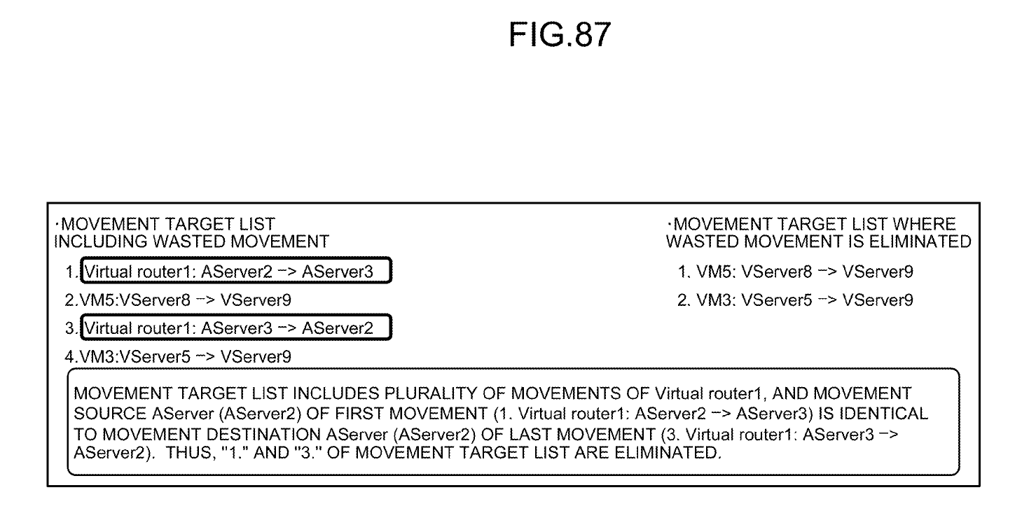

FIG. 87 is a diagram illustrating the results of avoiding inclusion of identical movement targets in a movement target list in the second example. As illustrated in FIG. 87, in a movement target list including wasted movement, the first entry includes movement of a Virtual router1 from an AServer2 to an AServer3, and the third entry includes movement of the Virtual router1 from the AServer3 to the AServer2. On the other hand, in a movement target list where the wasted movement is eliminated, these two entries are eliminated.

As such, by the control unit 1101 removing wasted movement from a movement target list, the resource controller 1000 can suppress an increase in the load on Servers associated with wasted movement.

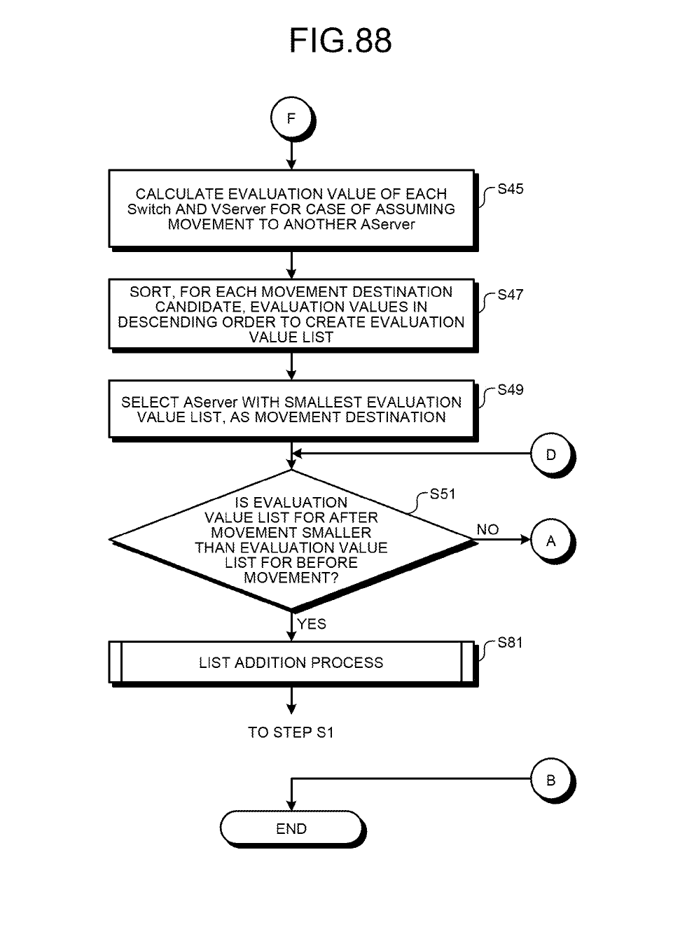

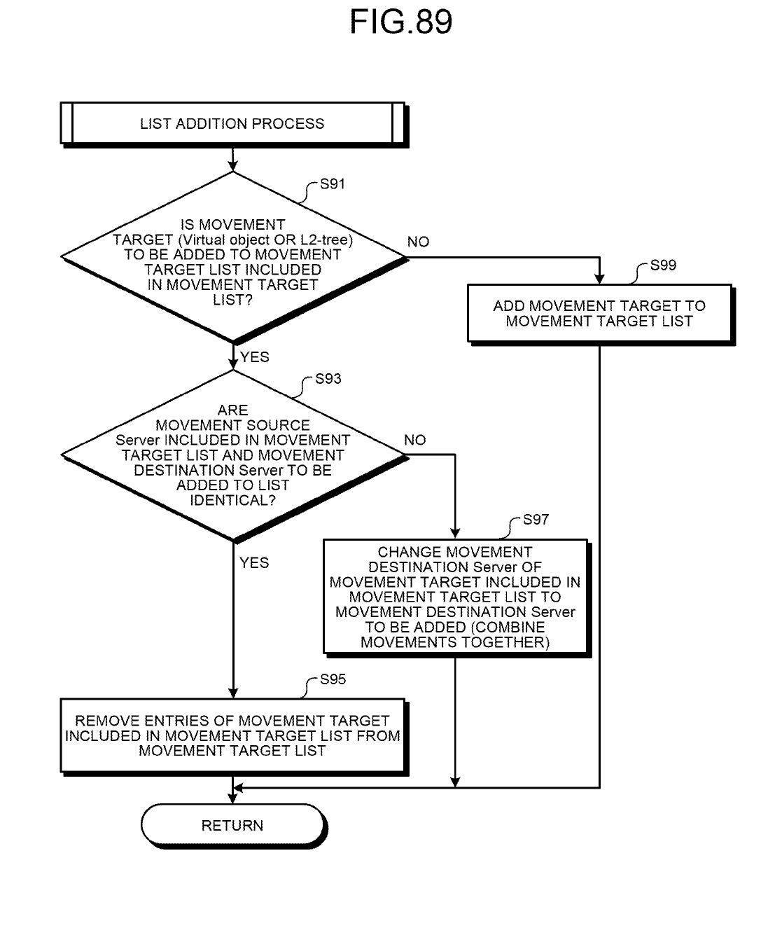

Note that instead of removing wasted movement from a movement target list after creating the movement target list, the control unit 1101 may avoid the occurrence of wasted movement upon adding a new entry to the movement target list. FIGS. 88 and 89 are diagrams illustrating a processing flow of the process of avoiding the occurrence of wasted movement upon adding a new entry to a movement target list. FIG. 88 is a processing flow obtained by changing a part of the processing flow illustrated in FIG. 24.

As illustrated in FIG. 88, compared with FIG. 24, the control unit 1101 performs a list addition process where movement information is added to a movement target list (step S81) instead of performing movement, and returns to step S1. In addition, if the condition for changing a disposition destination of a VM or a VR, or an L2-tree is not satisfied (step S1 of FIG. 10: No route), the control unit 1101 ends the process of creating a movement target list through the terminal B.

FIG. 89 is a processing flow of a list addition process. As illustrated in FIG. 89, the control unit 1101 determines whether a movement target (a Virtual object or an L2-tree) to be added to the movement target list is included in the movement target list (step S91). If the condition at step S91 is not satisfied, the control unit 1101 adds the movement target to the movement target list (step S99) and ends the list addition process.

On the other hand, if the condition at step S91 is satisfied, the control unit 1101 determines whether a movement source Server included in the movement target list and a movement destination Server to be added to the list are identical (step S93). If the condition at step S93 is satisfied, it is back-and-forth movement of returning to an original Server by two movements. Thus, the control unit 1101 removes entries of the movement target included in the movement target list from the movement target list (step S95).

On the other hand, if the condition at step S93 is not satisfied, the control unit 1101 changes a movement destination Server of the movement target included in the movement target list to the movement destination Server to be added (step S97). Namely, the control unit 1101 combines two movements into one movement.

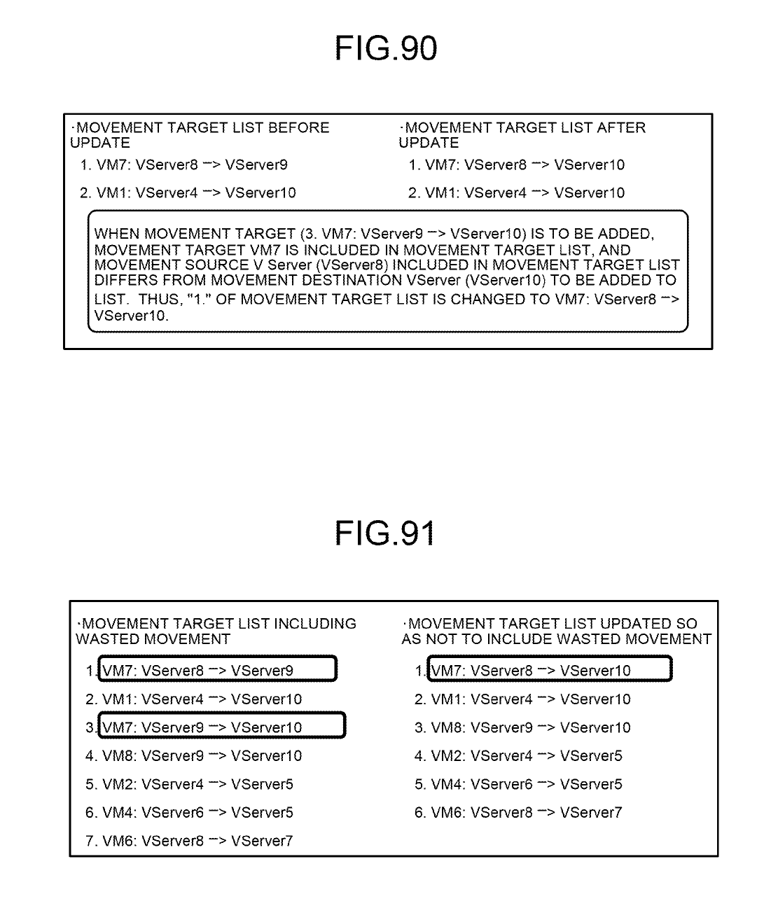

FIG. 90 is a diagram illustrating movement target lists before and after update in the first example. As illustrated in FIG. 90, in the movement target list before update, the first entry includes movement of a VM7 from a VServer8 to a VServer9, and as movement to be added, there is movement of the VM7 from the VServer9 to a VServer10. Accordingly, in the movement target list after update, the movement destination of the VM7 of the first entry is changed to the VServer10.

FIG. 91 is a diagram illustrating the results of avoiding inclusion of identical movement targets in a movement target list in the first example. As illustrated in FIG. 91, in a movement target list including wasted movement, the first entry includes movement of a VM7 from a VServer8 to a VServer9, and the third entry includes movement of the VM7 from the VServer9 to a VServer10. On the other hand, in a movement target list updated so as not to include wasted movement, the movement destination of the first entry is changed to the VServer10, and the movement of the VM7 from the VServer9 to the VServer10 is not added to the movement target list.

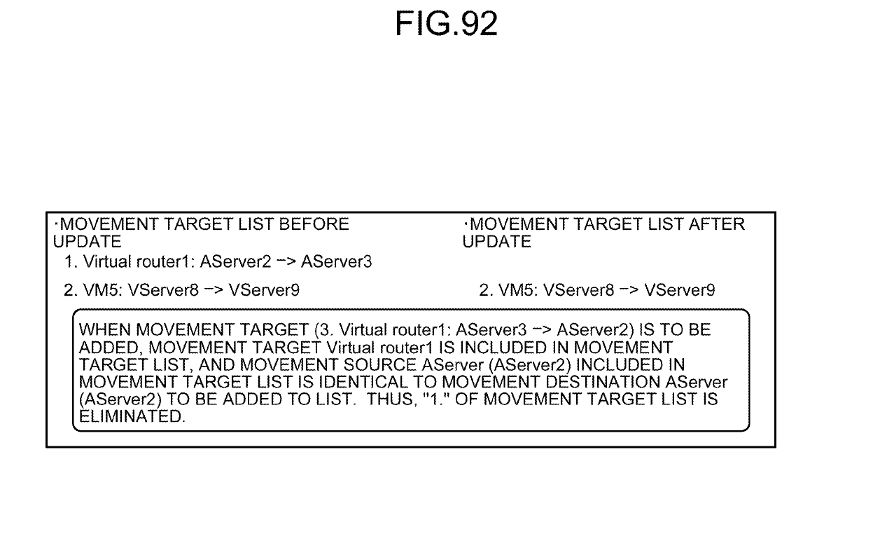

FIG. 92 is a diagram illustrating movement target lists before and after update in the second example. As illustrated in FIG. 92, in the movement target list before update, the first entry includes movement of a Virtual router1 from an AServer2 to an AServer3, and it is assumed that, as movement to be added, there is movement of the Virtual router1 from the AServer3 to the AServer2. Accordingly, in the movement target list after update, the first entry is eliminated.

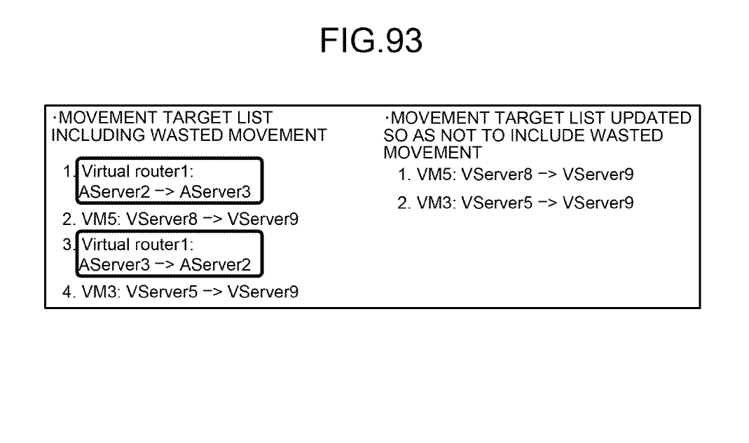

FIG. 93 is a diagram illustrating the results of avoiding inclusion of identical movement targets in a movement target list in the second example. As illustrated in FIG. 93, in a movement target list including wasted movement, the first entry includes movement of a Virtual router1 from an AServer2 to an AServer3, and the third entry includes movement of the Virtual router1 from the AServer3 to the AServer2. On the other hand, in a movement target list updated so as not to include wasted movement, these two entries are not included.

As such, by the control unit 1101 updating a movement target list so as not to include identical movement targets, the resource controller 1000 can suppress an increase in the load on Servers associated with wasted movement.

According to one aspect, network load can be effectively leveled out.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system including a plurality of information processing apparatuses connected to each other through a plurality of switch apparatuses, the information processing system comprising:
a control apparatus connected to any one of the plurality of switch apparatuses, wherein
the control apparatus includes:
a storage unit that stores an entry where virtual object identification information, movement source apparatus identification information, and movement destination apparatus identification information are associated with each other, the virtual object identification information identifying a virtual object that is a movement target and operates on any one of the plurality of information processing apparatuses, the movement source apparatus identification information identifying an information processing apparatus that is a movement source among the plurality of information processing apparatuses, and the movement destination apparatus identification information identifying an information processing apparatus that is a movement destination among the plurality of information processing apparatuses; and
a movement information generating unit that allows the storage unit to store a target entry when it is determined, based on a predetermined evaluation value of an amount of communication between a first information processing apparatus and a second information processing apparatus among the plurality of information processing apparatuses, that a virtual object operating on a third information processing apparatus is moved to a fourth information processing apparatus, and that the virtual object operating on the fourth information processing apparatus is moved to a fifth information processing apparatus, the target entry having virtual object identification information, movement source apparatus identification information, and movement destination apparatus identification information associated with each other, the virtual object identification information identifying the virtual object, the movement source apparatus identification information identifying the third information processing apparatus, and the movement destination apparatus identification information identifying the fifth information processing apparatus.

2. The information processing system according to claim 1, wherein the movement information generating unit eliminates, from the storage unit, an entry where virtual object identification information identifying the virtual object, movement source apparatus identification information identifying the third information processing apparatus, and movement destination apparatus identification information identifying the fourth information processing apparatus are associated with each other, and an entry where virtual object identification information identifying the virtual object, movement source apparatus identification information identifying the fourth information processing apparatus, and movement destination apparatus identification information identifying the fifth information processing apparatus are associated with each other, and allows the storage unit to store the target entry.

3. The information processing system according to claim 1, wherein, when the movement information generating unit adds to the storage unit an entry where virtual object identification information identifying the virtual object, movement source apparatus identification information identifying the fourth information processing apparatus, and movement destination apparatus identification information identifying the fifth information processing apparatus are associated with each other, the movement information generating unit eliminates, from the storage unit, an entry where virtual object identification information identifying the virtual object, movement source apparatus identification information identifying the third information processing apparatus, and movement destination apparatus identification information identifying the fourth information processing apparatus are associated with each other, and allows the storage unit to store the target entry.

4. A control method for an information processing system including a plurality of information processing apparatuses connected to each other through a plurality of switch apparatuses, the control method comprising:
determining whether there is redundant movement where a virtual object operating on a third information processing apparatus is moved to a fourth information processing apparatus, and furthermore, the virtual object operating on the fourth information processing apparatus is moved to a fifth information processing apparatus, based on a predetermined evaluation value of an amount of communication between a first information processing apparatus and a second information processing apparatus among the plurality of information processing apparatuses; and
creating, when there is the redundant movement, an entry where virtual object identification information, movement source apparatus identification information, and movement destination apparatus identification information are associated with each other, as an entry of movement information of the virtual object, the virtual object identification information identifying the virtual object, the movement source apparatus identification information identifying the third information processing apparatus, and the movement destination apparatus identification information identifying the fifth information processing apparatus.

5. A computer-readable recording medium having stored therein a program that causes a computer to execute a process for an information processing system including a plurality of information processing apparatuses connected to each other through a plurality of switch apparatuses, the process comprising:
determining whether there is redundant movement where a virtual object operating on a third information processing apparatus is moved to a fourth information processing apparatus, and furthermore, the virtual object operating on the fourth information processing apparatus is moved to a fifth information processing apparatus, based on a predetermined evaluation value of an amount of communication between a first information processing apparatus and a second information processing apparatus among the plurality of information processing apparatuses; and
creating, when there is the redundant movement, an entry where virtual object identification information, movement source apparatus identification information, and movement destination apparatus identification information are associated with each other, as an entry of movement information of the virtual object, the virtual object identification information identifying the virtual object, the movement source apparatus identification information identifying the third information processing apparatus, and the movement destination apparatus identification information identifying the fifth information processing apparatus.
